(19) United States
(12) Patent Application Publication
(10) Pub. No.: US 2026/0222970 A1
(43) Pub. Date: Jul. 30, 2026

(54) STATUS INFORMATION FOR IDENTIFIERS RELATED TO ARTIFICIAL INTELLIGENCE OR MACHINE LEARNING

(71) Applicant: QUALCOMM Incorporated, San Diego, CA (US)

(72) Inventors: Mohammed Ali Mohammed HIRZALLAH, San Diego, CA (US); Marwen ZORGUI, San Diego, CA (US)

(21) Appl. No.: 19/040,695

(22) Filed: Jan. 29, 2025

(51) Int. Cl. H04W 48/08; H04W 64/00

(52) U.S. Cl. CPC H04W 48/08; H04W 64/00

(57) ABSTRACT

Methods, systems, and devices for wireless communications are described. A wireless device may obtain, from a network entity, status information corresponding to one or more identifiers that are associated with one or more network settings. The one or more network settings may relate to communication of reference signaling for an artificial intelligence or machine learning (AI/ML)-based positioning or sensing procedure or measurement of reference signaling for an AI/ML-based positioning or sensing procedure. The wireless device may perform an operation to control the AI/ML-based positioning or sensing procedure based on the status information corresponding to the one or more identifiers. The wireless device and the network entity may communicate based on the status information corresponding to the one or more identifiers and the AI/ML-based positioning or sensing procedure control operation.

### FIELD OF TECHNOLOGY

The following relates to wireless communications, including status information for identifiers related to artificial intelligence or machine learning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include obtaining, from a network entity, status information corresponding to one or more identifiers that are associated with one or more network settings, where the one or more network settings relate to communication of reference signaling for an artificial intelligence or machine learning (AI/ML)-based positioning or sensing procedure or measurement of reference signaling for an AI/ML-based positioning or sensing procedure and performing an operation to control the AI/ML-based positioning or sensing procedure based on the status information corresponding to the one or more identifiers.

A wireless device for wireless communications is described. The wireless device may include one or more memories storing processor executable code, and one or more processors coupled with the one or more memories. The one or more processors may individually or collectively be operable to execute the code to cause the wireless device to obtain, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and perform an operation to control the AI/ML-based positioning or sensing procedure based on the status information corresponding to the one or more identifiers.

Another wireless device for wireless communications is described. The wireless device may include means for obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and means for performing an operation to control the AI/ML-based positioning or sensing procedure based on the status information corresponding to the one or more identifiers.

A non-transitory computer-readable medium storing code for wireless communications is described. The code may include instructions executable by one or more processors to obtain, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and perform an operation to control the AI/ML-based positioning or sensing procedure based on the status information corresponding to the one or more identifiers.

Some examples of the method, wireless devices, and non-transitory computer-readable medium described herein may further include operations, features, means, or instructions for outputting, to the network entity, a request for the status information corresponding to the one or more identifiers that may be associated with the one or more network settings, where the status information may be obtained based on the request.

Some examples of the method, wireless devices, and non-transitory computer-readable medium described herein may further include operations, features, means, or instructions for outputting, to the network entity, a request to confirm the status information corresponding to the one or more identifiers that may be associated with the one or more network settings, where the operation to control the AI/ML-based positioning or sensing procedure may be based on the request.

In some examples of the method, wireless devices, and non-transitory computer-readable medium described herein, obtaining the status information may include operations, features, means, or instructions for obtaining, from the network entity, the status information based on a request from the wireless device, via a position protocol message, via a sensing protocol message, or a combination thereof.

Some examples of the method, wireless devices, and non-transitory computer-readable medium described herein may further include operations, features, means, or instructions for obtaining, from the network entity, an indication of a change to the status information corresponding to the one or more identifiers that may be associated with the one or more network settings.

In some examples of the method, wireless devices, and non-transitory computer-readable medium described herein, the indication of the change to the status information includes an indication of a change from an active status, a pause status, an inactive status, a canceled status, an aborted status, or any combination thereof, to a different status.

Some examples of the method, wireless devices, and non-transitory computer-readable medium described herein may further include operations, features, means, or instructions for obtaining, from the network entity, an indication of a change to at least one identifier of the one or more identifiers that may be associated with the one or more network settings.

In some examples of the method, wireless devices, and non-transitory computer-readable medium described herein, the change to the at least one identifier includes an update to the at least one identifier, a replacement to the at least one identifier, or a combination thereof.

In some examples of the method, wireless devices, and non-transitory computer-readable medium described herein, obtaining the status information may include operations, features, means, or instructions for obtaining, from the network entity, one or more timing characteristics corresponding to the one or more identifiers that may be associated with the one or more network settings, where the status information includes the one or more timing characteristics.

In some examples of the method, wireless devices, and non-transitory computer-readable medium described herein, the one or more timing characteristics of a respective identifier includes an indication of a status timer, a status start time, a status stop time, a status start date, a status stop date, or any combination thereof.

In some examples of the method, wireless devices, and non-transitory computer-readable medium described herein, obtaining the status information may include operations, features, means, or instructions for obtaining, from the network entity, one or more status characteristics corresponding to the one or more identifiers that may be associated with the one or more network settings, where the status information includes the one or more status characteristics, and where the one or more status characteristics include a valid status, an invalid status, an active status, a pause status, an inactive status, an expired status, an aborted status, a canceled status, or any combination thereof.

Some examples of the method, wireless devices, and non-transitory computer-readable medium described herein may further include operations, features, means, or instructions for outputting, to the network entity and in response to an expiration of a timing validity timer of at least one identifier of the one or more identifiers, a request to confirm the status information of the at least one identifier.

Some examples of the method, wireless devices, and non-transitory computer-readable medium described herein may further include operations, features, means, or instructions for determining that the status information of a respective identifier of the one or more identifiers indicates that the respective identifier may be valid based on a status characteristic of the respective identifier, a timing characteristic of the respective identifier, or an absence of an indication from the network entity associated with the status information of the respective identifier.

Some examples of the method, wireless devices, and non-transitory computer-readable medium described herein may further include operations, features, means, or instructions for outputting, to the network entity, a request for the network entity to change the status information of a respective identifier of the one or more identifiers corresponding to the one or more identifiers that may be associated with the one or more network settings.

Some examples of the method, wireless devices, and non-transitory computer-readable medium described herein may further include operations, features, means, or instructions for outputting, to the network entity, a capability message indicating a capability of the wireless device to obtain the status information corresponding to the one or more identifiers that may be associated with the one or more network settings, where the status information may be obtained based on output of the capability message.

In some examples of the method, wireless devices, and non-transitory computer-readable medium described herein, the operation to control the AI/ML-based positioning or sensing procedure includes an activation of an AI/ML model, a selection of an AI/ML model, switching an AI/ML model, a deactivation of an AI/ML model, switching to a non-AI/ML-based positioning or sensing procedure, or any combination thereof based on the status information corresponding to the one or more identifiers.

In some examples of the method, wireless devices, and non-transitory computer-readable medium described herein, the status information of a first identifier of the one or more identifiers may be based on the status information of a second identifier of the one or more identifiers based on a relation between the first identifier and the second identifier.

A method for wireless communications by a network entity is described. The method may include outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and communicating with the wireless device based on the one or more network settings.

A network entity for wireless communications is described. The network entity may include one or more memories storing processor executable code, and one or more processors coupled with the one or more memories. The one or more processors may individually or collectively be operable to execute the code to cause the network entity to output, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and communicate with the wireless device based on the one or more network settings.

Another network entity for wireless communications is described. The network entity may include means for outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and means for communicating with the wireless device based on the one or more network settings.

A non-transitory computer-readable medium storing code for wireless communications is described. The code may include instructions executable by one or more processors to output, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure and communicate with the wireless device based on the one or more network settings.

Some examples of the method, network entities, and non-transitory computer-readable medium described herein may further include operations, features, means, or instructions for obtaining, from the wireless device, a request for the status information corresponding to the one or more identifiers that may be associated with the one or more network settings, where the status information may be output based on the request.

Some examples of the method, network entities, and non-transitory computer-readable medium described herein may further include operations, features, means, or instructions for obtaining, from the wireless device, a request to confirm the status information corresponding to the one or more identifiers that may be associated with the one or more network settings.

In some examples of the method, network entities, and non-transitory computer-readable medium described herein, outputting the status information may include operations, features, means, or instructions for outputting, to the wireless device, the status information based on a request from the wireless device, via a position protocol message, via a sensing protocol message, or a combination thereof.

Some examples of the method, network entities, and non-transitory computer-readable medium described herein may further include operations, features, means, or instructions for outputting, to the wireless device, an indication of a change to the status information corresponding to the one or more identifiers that may be associated with the one or more network settings.

In some examples of the method, network entities, and non-transitory computer-readable medium described herein, the indication of the change to the status information includes an indication of a change from an active status, a pause status, an inactive status, a canceled status, an aborted status, or any combination thereof, to a different status.

Some examples of the method, network entities, and non-transitory computer-readable medium described herein may further include operations, features, means, or instructions for outputting, to the wireless device, an indication of a change to at least one identifier of the one or more identifiers that may be associated with the one or more network settings.

In some examples of the method, network entities, and non-transitory computer-readable medium described herein, the change to the at least one identifier includes an update to the at least one identifier, a replacement to the at least one identifier, or a combination thereof.

In some examples of the method, network entities, and non-transitory computer-readable medium described herein, outputting the status information may include operations, features, means, or instructions for outputting, to the wireless device, one or more timing characteristics corresponding to the one or more identifiers that may be associated with the one or more network settings, where the status information includes the one or more timing characteristics.

In some examples of the method, network entities, and non-transitory computer-readable medium described herein, the one or more timing characteristics of a respective identifier includes an indication of a status timer, a status start time, a status stop time, a status start date, a status stop date, or any combination thereof.

In some examples of the method, network entities, and non-transitory computer-readable medium described herein, outputting the status information may include operations, features, means, or instructions for outputting, to the wireless device, one or more status characteristics corresponding to the one or more identifiers that may be associated with the one or more network settings, where the status information includes the one or more status characteristics, and where the one or more status characteristics include a valid status, an invalid status, an active status, a pause status, an inactive status, an expired status, an aborted status, a canceled status, or any combination thereof.

Some examples of the method, network entities, and non-transitory computer-readable medium described herein may further include operations, features, means, or instructions for obtaining, from the wireless device and in response to an expiration of a timing validity timer of at least one identifier of the one or more identifiers, a request to confirm the status information of the at least one identifier.

Some examples of the method, network entities, and non-transitory computer-readable medium described herein may further include operations, features, means, or instructions for obtaining, from the wireless device, a request for the network entity to change the status information of a respective identifier of the one or more identifiers corresponding to the one or more identifiers that may be associated with the one or more network settings.

Some examples of the method, network entities, and non-transitory computer-readable medium described herein may further include operations, features, means, or instructions for obtaining, from the wireless device, a capability message indicating a capability of the wireless device to obtain the status information corresponding to the one or more identifiers that may be associated with the one or more network settings, where output of the status information may be based on obtaining the capability message.

In some examples of the method, network entities, and non-transitory computer-readable medium described herein, the status information of a first identifier of the one or more identifiers may be based on the status information of a second identifier of the one or more identifiers based on a relation between the first identifier and the second identifier.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports status information for identifiers related to artificial intelligence or machine learning (AI/ML) in accordance with one or more aspects of the present disclosure.

FIG. 2 shows an example of a wireless network structure that supports status information for identifiers related to AI/ML in accordance with one or more aspects of the present disclosure.

FIG. 3 shows an example of a network architecture that supports status information for identifiers related to AI/ML in accordance with one or more aspects of the present disclosure.

FIGS. 4 and 5 show examples of wireless communications systems that support status information for identifiers related to AI/ML in accordance with one or more aspects of the present disclosure.

FIG. 6 shows an example of a process flow that supports status information for identifiers related to AI/ML in accordance with one or more aspects of the present disclosure.

FIGS. 7 and 8 show block diagrams of devices that support status information for identifiers related to AI/ML in accordance with one or more aspects of the present disclosure.

FIG. 9 shows a block diagram of a communications manager that supports status information for identifiers related to AI/ML in accordance with one or more aspects of the present disclosure.

FIG. 10 shows a diagram of a system including a device that supports status information for identifiers related to AI/ML in accordance with one or more aspects of the present disclosure.

FIGS. 11 and 12 show block diagrams of devices that support status information for identifiers related to AI/ML in accordance with one or more aspects of the present disclosure.

FIG. 13 shows a block diagram of a communications manager that supports status information for identifiers related to AI/ML in accordance with one or more aspects of the present disclosure.

FIG. 14 shows a diagram of a system including a device that supports status information for identifiers related to AI/ML in accordance with one or more aspects of the present disclosure.

FIGS. 15 through 18 show flowcharts illustrating methods that support status information for identifiers related to AI/ML in accordance with one or more aspects of the present disclosure.

FIG. 19 shows examples of wireless communications systems that supports status information for identifiers related to AI/ML in accordance with one or more aspects of the present disclosure.

FIG. 20 shows an example of a node diagram that supports status information for identifiers related to AI/ML in accordance with one or more aspects of the present disclosure.

FIGS. 21A and 21B show examples of block diagrams that supports status information for identifiers related to AI/ML in accordance with one or more aspects of the present disclosure.

FIG. 22 shows examples of block diagrams that supports status information for identifiers related to AI/ML in accordance with one or more aspects of the present disclosure.

FIG. 23 shows an example of sensing modes that supports status information for identifiers related to AI/ML in accordance with one or more aspects of the present disclosure.

### DETAILED DESCRIPTION

In some examples, a wireless communications system may perform artificial intelligence or machine learning (AI/ML)-based positioning or sensing procedures. AI/ML-based positioning or sensing may enhance positioning or sensing accuracy in non-line-of-sight (NLOS) conditions. In some examples, a network entity (e.g., one or more network nodes, location management functions (LMFs), other network entities, or a combination thereof) may generate identifiers (e.g., associated identifiers) that are associated with or correspond to one or more network settings without explicitly indicating the values of the network settings. To allow a wireless device (e.g., a user equipment (UE)) to be in sync with the network entity (e.g., to operate in correspondence with current network settings), the wireless device may receive an indication of the associated identifiers rather than the explicit values of the network settings. In some cases, a network entity may change one or more network settings that have an associated identifier without providing any indication or update to a wireless device indicating that a change to the one or more network settings corresponding to an associated identifier has occurred, thus causing a lack of correspondence between the associated identifier and the network settings at the wireless device.

In accordance with some of the techniques described herein, a network entity may signal an indication of a status, timing validity, or maintenance of associated identifiers to a wireless device when the network entity changes the values or parameters of one or more network settings. For example, after receiving an indication of a set of associated identifiers, a wireless device may receive an indication of a change to a status or timing characteristic of an associated identifier. In response, the wireless device may perform one or more actions (e.g., life cycle management (LCM) actions among others) based on the change. For example, if an associated identifier is indicated as invalid, the wireless device may deactivate an AI/ML model or select a different AI/ML model to switch to for the AI/ML-based positioning or sensing procedures. In some examples, a wireless device may communicate a request for the status characteristics, timing characteristics, or both of an associated identifier. In some aspects, based on a monitoring outcome, a wireless devices may request or recommend that the network entity change the validity or timing characteristics of an associated identifier. Thus, in accordance with some of the techniques of the present disclosure, a wireless device and a network may be able to communicate about the condition of associated identifiers to ensure a correspondence or alignment between one or more network settings at the network entity and one or more AI/ML models at the wireless device.

Aspects of the disclosure are initially described in the context of wireless communications systems. Aspects of the disclosure are also described in the context of a wireless network structure. Aspects of the disclosure are further described in the context of a network architecture. Aspects of the disclosure are additionally described in the context of process flows. Aspects of the disclosure are further illustrated by and described with reference to apparatus diagrams, system diagrams, and flowcharts that relate to status information for identifiers related to AI/ML.

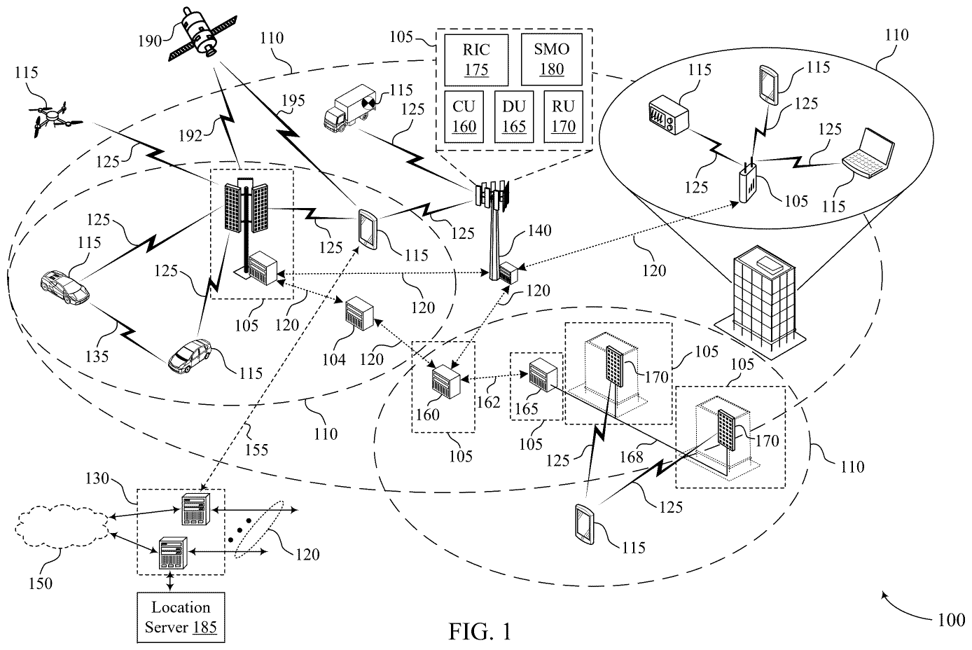

FIG. 1 shows an example of a wireless communications system 100 that supports status information for identifiers related to AI/ML in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a network entity, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or have different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be another UE 115. In another aspect of this example, the first node may be a UE 115, the second node may be a network node 105, and the third node may be another network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via wired or wireless backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point (AP), a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network entities (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1 interface, F1-c interface, or F1-u, among other examples), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support testing as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network entities, such as one or more of the network nodes 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network node 105 to a UE 115, uplink transmissions (e.g., return link transmissions) from a UE 115 to a network node 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network nodes 105, the UEs 115, or both) may have hardware configurations that support communications using a particular carrier bandwidth or may be configurable to support communications using one of a set of carrier bandwidths. In some examples, the wireless communications system 100 may include network nodes 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network entities (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may support synchronous or asynchronous operation. For synchronous operation, network nodes 105 (e.g., base stations 140) may have similar frame timings, and transmissions from different network entities (e.g., different ones of the network nodes 105) may be approximately aligned in time. For asynchronous operation, network nodes 105 may have different frame timings, and transmissions from different network entities (e.g., different ones of network nodes 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network entities (e.g., network nodes 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may include an location server 185 (e.g., LMF). The location server 185 may provide positioning, location, or tracking functions. For instance, the location server 185 may participate in one or more positioning procedures to determine a location of (e.g., coordinates of, relative distance(s) to, or an address of) one or more of the UEs 115. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AOD), multi-round-trip time (Multi-RTT), New Radio enhanced cell identifier (NR E-CID), uplink time difference of arrival (UL-TDOA), and uplink angle of arrival (UL-AOA), among other examples. Some examples of the positioning procedures may be managed by, assisted by, or performed with the location server 185. For instance, measurements associated with reference signaling may be provided to the location server 185, which may estimate a location of a UE 115 based on the measurements. In some aspects, the location server 185 may track or store location information corresponding to one or more UEs 115. Some examples of the positioning procedures may be performed without the location server 185.

The location server 185 may be included in the core network 130 or may be separate from the core network 130. In some examples, a location server 185 may be a standalone device or may be included in (e.g., integrated with) a network node 105, a base station 140, a UE 115, a satellite 190, a server, or another device. For instance, the location server 185 may be (or may be included in) a secure user plane location (SUPL) location platform (SLP) device, a third-party server, or another device. The location server 185 may generally refer to a positioning device, a location device, a computing device, or a server, among other examples.

A UE 115 may communicate with the location server 185 directly or indirectly. For example, a UE 115 may communicate with the location server 185 via a network node 105 that is serving the UE 115 and via the core network 130. Additionally, or alternatively, a UE 115 may communicate with the location server 185 through another path (e.g., via an application server (not shown)) or via another network (e.g., via a WLAN AP), among other examples. Communication between a UE 115 and the location server 185 may be represented via an indirect connection (e.g., through a communication link 125, a network node 105, a communication link 155, a backhaul communication link 120, or the core network 130) or as a direct connection, with one or more intervening nodes (if any) omitted for concision or convenience.

A satellite 190 may be an aerial or space vehicle with signaling capability. In some examples, the wireless communications system 100 may include or communicate with one or more satellites 190. The satellite(s) 190 may be included in one or more satellite positioning systems (e.g., GNSS(s)). A satellite positioning system may include any combination of one or more global or regional navigation satellites associated with one or more satellite positioning systems (e.g., global positioning system (GPS), global navigation satellite system (GLONASS), BeiDou navigation satellite system (BDS), or Galileo, among other examples). A satellite positioning system may include satellites 190 or other transmitters positioned to enable receivers (e.g., UEs 115) to determine a location on or above the Earth based on signals (e.g., the signals 195) received from the satellites 190. For instance, each satellite 190 may transmit a signal 195 marked with a repeating pseudo-random noise (PN) code of a set quantity of chips. In some cases, one or more transmitters located on ground-based control stations, network nodes 105, or UEs 115 may transmit signals for enabling a UE 115 to determine a location.

A UE 115 may include one or more receivers designed to receive the signal(s) 195 from the satellite(s) 190 for determining location information (e.g., a geographic location of the UE 115). For instance, the UE 115 may receive one or more signals 195 from the satellite(s) 190, which may be utilized to determine a location of the UE 115.

In a satellite positioning system, the use of signals 195 may be augmented with one or more satellite-based augmentation systems (SBAS) that may be associated with or enabled for use with one or more global or regional navigation satellite systems. An SBAS may provide integrity information, differential corrections, or other information for use in conjunction with a satellite positioning system. An SBAS may include one or more augmentation systems, such as the Wide Area Augmentation System (WAAS), the European Geostationary Navigation Overlay Service (EGNOS), the Multi-functional Satellite Augmentation System (MSAS), or the GPS Aided Geo Augmented Navigation (GAGAN) system, among other examples.

In some aspects, the satellite(s) 190 may be included in one or more non-terrestrial networks (NTNs). In an NTN, a satellite 190 may communicate with one or more devices (e.g., network entities, ground stations, NTN gateways, or gateways) located on or above the Earth. For example, the satellite 190 may send or receive one or more communications 192 with a network node 105. In some aspects, the communication(s) 192 may include one or more signals relayed to or from a UE 115. Additionally, or alternatively, the satellite 190 may communicate with another terrestrial device that is connected to one or more elements of the wireless communications system 100. For instance, the satellite 190 may communicate with a ground station or NTN gateway, which may provide access to the wireless communications system 100 or one or more other entities (e.g., Internet web servers or one or more other user devices) external to the wireless communications system 100. In some examples, a UE 115 may receive communication signals 195 from the satellite 190 instead of, or in addition to, communication signals from a terrestrial network entity.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize licensed or unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network node 105 or a core network 130 supporting radio bearers for user plane data. A PHY layer may map transport channels to physical channels.

The UEs 115 and the network nodes 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

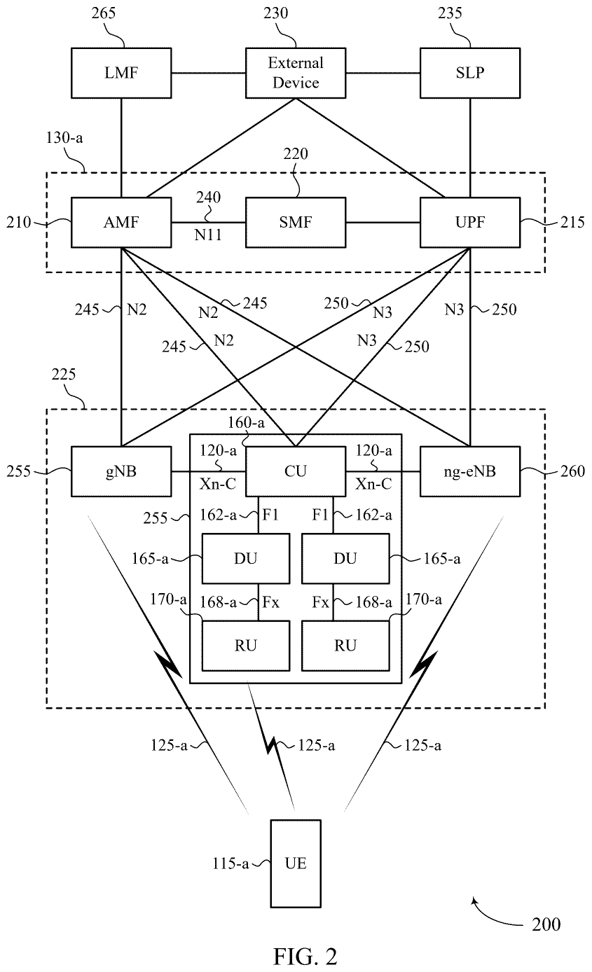

In some examples of the wireless communications system 100, wireless devices (e.g., the UE 115) may perform AI/ML-based positioning or sensing procedures and the wireless devices may use one or more associated identifiers to adapt or change AI/ML models based on network settings (e.g., network conditions). In accordance with some of the techniques of the present disclosure, a network entity (e.g., a location server 185 or a network node 105) may signal an indication of a status, timing validity, or maintenance of associated identifiers to a wireless device when the network entity changes the values or parameters of one or more network settings. For example, after receiving an indication of a set of associated identifiers, a wireless device may receive an indication of a change to a status or timing characteristic of an associated identifier. In another example, a wireless device may communicate a request for the status characteristics, timing characteristics, or both of an associated identifier. In some aspects, based on a monitoring outcome, a wireless devices may also request or recommend that the network entity change the validity or timing characteristics of an associated identifier. Thus, in accordance with some of the techniques of the present disclosure, a wireless device and a network entity may be able to communicate about the condition of associated identifiers to ensure a correspondence or alignment between one or more network settings at the network entity and one or more AI/ML at the wireless device. Further descriptions of the techniques of the present disclosure enabling wireless devices to obtain (e.g., receive) status information corresponding to one or more identifiers that are associated with one or more network settings may be described elsewhere herein, such as with reference to FIGS. 2 through 8.

FIG. 2 shows an example of a wireless network structure 200 that supports status information for identifiers related to AI/ML in accordance with one or more aspects of the present disclosure. The wireless network structure 200 may include a core network 130-a, a RAN 225, a UE 115-a, an LMF 265, an external device 230 (e.g., third-party device or server), or an SLP 235. In some examples, the wireless network structure 200 may be included in the wireless communications system 100 described with reference to FIG. 1. The core network 130-a may be an example of the core network 130, the UE 115-a may be an example of the UEs 115, or the LMF 265 may be an example of the location server 185, as described with reference to FIG. 1.

The core network 130-a may provide one or more control plane (C-plane) functions (e.g., UE registration, authentication, network access, or gateway selection, among other examples) or one or more user plane (U-plane) functions (e.g., UE gateway function, data network access, or IP routing, among other examples). One or more of the functions of the core network 130-a may be implemented in one or more devices (e.g., one or more electronic devices, computing devices, servers, among other examples) in hardware (e.g., circuitry) or a combination of hardware and instructions (e.g., a processor with instructions). The core network 130-a may be an EPC, 5GC, or a Next Generation Core (NGC), among other examples.

The core network 130-a may provide an AMF 210, a session management function (SMF) 220, or a user plane function (UPF) 215. The AMF 210 may provide one or more C-plane functions, such as registration management, connection management, reachability management, mobility management, lawful interception, transport for session management (SM) messages between one or more UEs 115-a and the SMF 220, transparent proxy services for routing SM messages, access authentication and access authorization, transport for short message service (SMS) messages between the UE 115-a and the short message service function (SMSF), or security anchor functionality (SEAF), among other examples. In some aspects, the AMF 210 may interact with an authentication server function (AUSF) and the UE 115-a, and may receive an intermediate key established as a result of a UE 115-a authentication process. In a case of authentication based on a universal mobile telecommunications system (UMTS) subscriber identity module (USIM), the AMF 210 may retrieve security information from the AUSF. In some examples, the AMF 210 may provide a security context management (SCM) function. The SCM function may receive a key from the SEAF that may be utilized to derive access-network specific keys. The AMF 210 may provide location services management for regulatory services, transport for location services messages between the UE 115-a and an LMF 265, transport for location services messages between the RAN 225 and the LMF 265, evolved packet system (EPS) bearer identifier allocation for interworking with the EPS, or UE 115-a mobility event notification. In some approaches, the AMF 210 may support one or more functionalities for Third Generation Partnership Project (3GPP) access networks or non-3GPP access networks.

The UPF 215 may provide one or more U-plane functions, such as acting as an anchor point for intra/inter-RAT mobility, acting as an external protocol data unit (PDU) session point of interconnection to a data network, providing packet routing and forwarding, packet inspection, user plane policy rule enforcement (e.g., gating, redirection, or traffic steering), user plane collection (e.g., interception), traffic usage reporting, quality of service (QOS) handling for the U-plane (e.g., uplink or downlink rate enforcement, reflective QoS marking in the downlink), uplink traffic verification (e.g., service data flow (SDF) to QoS flow mapping), transport level packet marking in the uplink or downlink, downlink packet buffering, downlink data notification triggering, or sending or forwarding one or more indications of an end of a transmission (e.g., “end markers”) to a source RAN node, among other examples. In some examples, the UPF 215 may support the transfer of location services messages over a U-plane between the UE 115-a and another device (e.g., the SLP 235 or the external device 230.

The SMF 220 may provide one or more functions, such as session management, UE IP address allocation and management, selection and control of user plane functions, configuration of traffic steering at the UPF 215 to route traffic to a destination, control (e.g., partial control) of policy enforcement or QoS, or downlink data notification. In some aspects, the SMF 220 may communicate with the AMF 210 over an N11 interface 240.

The RAN 225 may include one or more gNBs 255 or one or more ng-eNBs 260. The gNB(s) 255 or the ng-eNB(s) 260 may be examples of the network nodes 105 described with reference to FIG. 1. For instance, a next generation RAN (NG-RAN) may include one or more gNBs 255, or other examples of the RAN 225 may include one or more ng-eNBs 260 or gNBs 255.

The core network 130-a may communicate with the RAN 225 via a C-plane interface 245 (e.g., NG-C or N2 interface) or a U-plane interface 250 (e.g., NG-U or N3 interface). The C-plane interface 245 or the U-plane interface 250 may connect the gNB 255 or the ng-eNB 260 to the core network 130-a (e.g., to one or more control plane functions or one or more user plane functions). For instance, the C-plane interface 245 may connect the AMF 210 to one or more gNBs 255 or ng-eNBs 260 in the RAN 225, or the U-plane interface 250 may connect the UPF 215 to one or more gNBs 255 or ng-eNBs 260 in the RAN 225. The gNB(s) 255 or ng-eNB(s) 260 of the RAN 225 may communicate with each other via one or more backhaul communication links 120-a (e.g., Xn-C interface). The backhaul communication link(s) 120-a may be examples of the backhaul communication links 120 described with reference to FIG. 1. One or more of the gNBs 255 or ng-eNBs 260 may communicate with one or more UEs 115-a over one or more communication links 125-a (e.g., the Uu interface). The communication link(s) 125-a may be examples of the communication links 125 described with reference to FIG. 1.

The LMF 265 may communicate with the core network 130-a to provide location functionality (e.g., to participate in one or more positioning procedures) for the UE(s) 115-a. The LMF 265 may be an example of the location server 185 described with reference to FIG. 1. The LMF 265 may be implemented as one or more devices (e.g., one or more servers, such as physically separate servers, one or more instruction sets on a single server, or instruction sets distributed across multiple physical servers, among other examples). The LMF 265 may support one or more location services for one or more UEs 115-a that may connect to the LMF 265 via the RAN 225, via the core network 130-a, or via another connection (e.g., the Internet). In some examples, the LMF 265 may communicate with a UE 115-a or another device via a C-plane connection (e.g., using one or more interfaces or protocols for signaling control information, or separate from voice or payload data). In some aspects, the LMF 265 may be integrated into a component of the core network 130-a or may be external to the core network 130-a (e.g., on an external device 230, such as an original equipment manufacturer (OEM) server or other server).

In some examples, the SLP 235 may provide location functionality (e.g., may participate in one or more positioning procedures) for the UE(s) 115-a. The SLP 235 may be an example of the location server 185 described with reference to FIG. 1. The SLP 235 may be implemented as one or more devices (e.g., one or more servers, such as physically separate servers, one or more instruction sets on a single server, or instruction sets distributed across multiple physical servers, among other examples). The SLP 235 may support one or more location services for one or more UEs 115-a that may connect to the SLP 235 via the RAN 225, via the core network 130-a, or via another connection (e.g., the Internet). In some examples, the SLP 235 may communicate with a UE 115-a or another device via a U-plane connection (e.g., using one or more interfaces or protocols for signaling voice or payload data, such as a transmission control protocol (TCP) or IP).

In some examples, the external device 230 may communicate with the LMF 265, the SLP 235, the core network 130-a (e.g., via the AMF 210 or the UPF 215), the RAN 225, or the UE 115-a to obtain location information (e.g., a location estimate) for the UE 115-a. The external device 230 may be referred to as a location services (LCS) client or an external client. The external device 230 may be implemented as one or more devices (e.g., one or more servers, such as physically separate servers, one or more instruction sets on a single server, or instruction sets distributed across multiple physical servers, among other examples). The external device 230 may support one or more location services for one or more UEs 115-a that may connect to the external device 230 via the RAN 225, via the core network 130-a, or via another connection (e.g., the Internet).

In some approaches, the functionality of a gNB 255 may be divided between a CU 160-a, one or more DUs 165-a, or one or more RUs 170-a. The CU 160-a may be an example of the CU 160 described with reference to FIG. 1, the one or more DUs 165-a may be examples of the DU 165 described with reference to FIG. 1, or the one or more RUs 170-a may be examples of the RU 170 described with reference to FIG. 1. In some examples, the CU 160-a may provide one or more functions, such as transferring user data, mobility control, radio access network sharing, positioning, session management, or others, except for one or more functions allocated exclusively to the DU(s) 165-a. A DU 165-a may support one or more cells. The DUs 165-a may communicate with the CU 160-a via midhaul communication links 162-a (e.g., via the F1 interface). The midhaul communication links 162-a may be examples of the midhaul communication links 162 described with reference to FIG. 1. The RUs 170-a may perform one or more functions such as power amplification, signal transmission, or signal reception. The RUs 170-a may communicate with the DUs 165-a via fronthaul communication links 168-a (e.g., via the Fx interface). The fronthaul communication links 168-a may be examples of the fronthaul communication links 168 described with reference to FIG. 1. The UE 115-a may communicate with the gNB 255, RU 170-a, or ng-eNB 260 a via communication links 125-a. The communication links 125-a may be examples of the communication links 125 described with reference to FIG. 1. The UE 115-a may communicate with the CU 160-a via the RRC, SDAP, and PDCP layers, with a DU 165-a via the RLC and MAC layers, or with an RU 170-a via the PHY layer.

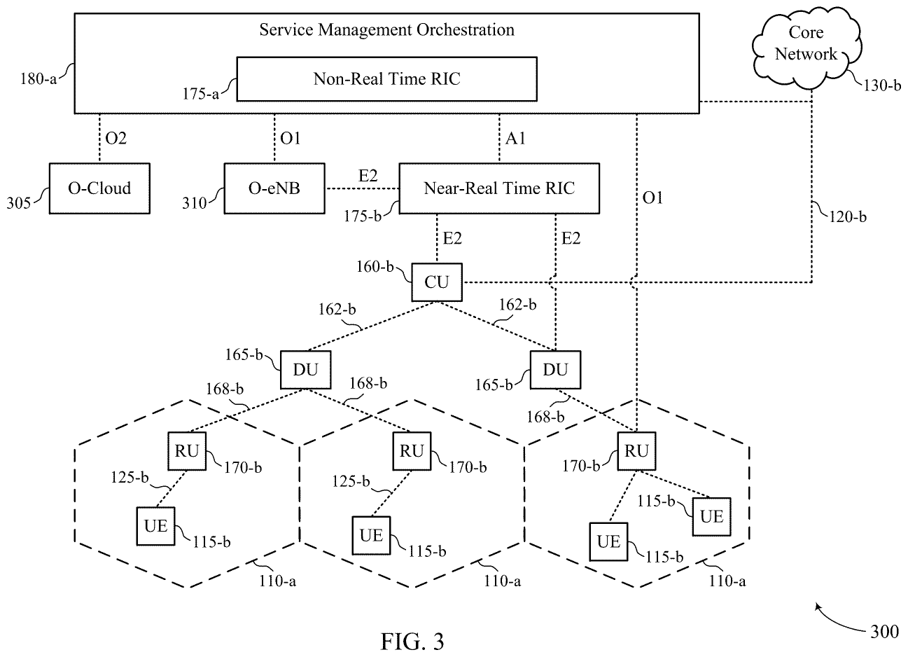

In some examples of the wireless network structure 200, one or more wireless devices (e.g., the UE 115-a) may perform AI/ML-based positioning or sensing procedures. The wireless devices may use one or more associated identifiers to adapt or change AI/ML models based on network conditions at a network entity (e.g., an LMF 265, a network node 105, or any combination thereof). In accordance with some of the techniques of the present disclosure, a network entity may signal an indication of a status, timing validity, or maintenance of associated identifiers to a wireless device when the network entity changes the values or parameters of one or more network settings. For example, after receiving an indication of a set of associated identifiers, a wireless device may receive an indication of a change to a status or timing characteristic of an associated identifier. In another example, a wireless device may communicate a request for the status characteristics, timing characteristics, or both of an associated identifier. In some aspects, based on a monitoring outcome, a wireless devices may also request or recommend that the network entity change the validity or timing characteristics of an associated identifier. Thus, in accordance with some of the techniques of the present disclosure, a wireless device and a network entity may be able to communicate about the condition of associated identifiers to ensure a correspondence or alignment between one or more network settings at the network entity and one or more AI/ML models at the wireless device. Further descriptions of the techniques of the present disclosure enabling wireless devices to obtain (e.g., receive) status information corresponding to one or more identifiers that are associated with one or more network settings may be described elsewhere herein, such as with reference to FIGS. 3 through 8.

FIG. 3 shows an example of a network architecture 300 (e.g., a disaggregated base station architecture, a disaggregated RAN architecture) that supports status information for identifiers related to AI/ML in accordance with one or more aspects of the present disclosure. The network architecture 300 may illustrate an example for implementing one or more aspects of the wireless communications system 100. The network architecture 300 may include one or more CUs 160-b that may communicate directly with a core network 130-b via a backhaul communication link 120-b, or indirectly with the core network 130-b through one or more disaggregated network nodes 105 (e.g., a Near-RT RIC 175-b via an E2 link, or a Non-RT RIC 175-a associated with an SMO 180-a (e.g., an SMO Framework), or both). A CU 160-b may communicate with one or more DUs 165-b via respective midhaul communication links 162-b (e.g., an F1 interface). The DUs 165-b may communicate with one or more RUs 170-b via respective fronthaul communication links 168-b. The RUs 170-b may be associated with respective coverage areas 110-a and may communicate with UEs 115-b via one or more communication links 125-b. In some implementations, a UE 115-b may be simultaneously served by multiple RUs 170-b.

Each of the network nodes 105 of the network architecture 300 (e.g., CUs 160-b, DUs 165-b, RUs 170-b, Non-RT RICs 175-a, Near-RT RICs 175-b, SMOs 180-a, Open Clouds (O-Clouds) 305, Open eNBs (O-eNBs) 310) may include one or more interfaces or may be coupled with one or more interfaces configured to receive or transmit signals (e.g., data, information) via a wired or wireless transmission medium. Each network node 105, or an associated processor (e.g., controller) providing instructions to an interface of the network node 105, may be configured to communicate with one or more of the other network nodes 105 via the transmission medium. For example, the network nodes 105 may include a wired interface configured to receive or transmit signals over a wired transmission medium to one or more of the other network nodes 105. Additionally, or alternatively, the network nodes 105 may include a wireless interface, which may include a receiver, a transmitter, or transceiver (e.g., an RF transceiver) configured to receive or transmit signals, or both, over a wireless transmission medium to one or more of the other network nodes 105.

In some examples, a CU 160-b may host one or more higher layer control functions. Such control functions may include RRC, PDCP, SDAP, or the like. Each control function may be implemented with an interface configured to communicate signals with other control functions hosted by the CU 160-b. A CU 160-b may be configured to handle user plane functionality (e.g., CU-UP), control plane functionality (e.g., CU-CP), or a combination thereof. In some examples, a CU 160-b may be logically split into one or more CU-UP units and one or more CU-CP units. A CU-UP unit may communicate bidirectionally with the CU-CP unit via an interface, such as an E1 interface when implemented in an O-RAN configuration. A CU 160-b may be implemented to communicate with a DU 165-b, as necessary, for network control and signaling.

A DU 165-b may correspond to a logical unit that includes one or more functions (e.g., base station functions, RAN functions) to control the operation of one or more RUs 170-b. In some examples, a DU 165-b may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-b may further host one or more low PHY layers. Each layer may be implemented with an interface configured to communicate signals with other layers hosted by the DU 165-b, or with control functions hosted by a CU 160-b.

In some examples, lower-layer functionality may be implemented by one or more RUs 170-b. For example, an RU 170-b, controlled by a DU 165-b, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-b may be implemented to handle over the air (OTA) communication with one or more UEs 115-b. In some implementations, real-time and non-real-time aspects of control and user plane communication with the RU(s) 170-b may be controlled by the corresponding DU 165-b. In some examples, such a configuration may enable a DU 165-b and a CU 160-b to be implemented in a cloud-based RAN architecture, such as a vRAN architecture.

The SMO 180-a may be configured to support RAN deployment and provisioning of non-virtualized and virtualized network nodes 105. For non-virtualized network nodes 105, the SMO 180-a may be configured to support the deployment of dedicated physical resources for RAN coverage requirements which may be managed via an operations and maintenance interface (e.g., an O1 interface). For virtualized network nodes 105, the SMO 180-a may be configured to interact with a cloud computing platform (e.g., an O-Cloud 305) to perform network node life cycle management (e.g., to instantiate virtualized network nodes 105) via a cloud computing platform interface (e.g., an O2 interface). Such virtualized network nodes 105 can include, but are not limited to, CUs 160-b, DUs 165-b, RUs 170-b, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-b via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, artificial intelligence (AI) or machine learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-b, one or more DUs 165-b, or both, as well as an O-eNB 310, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

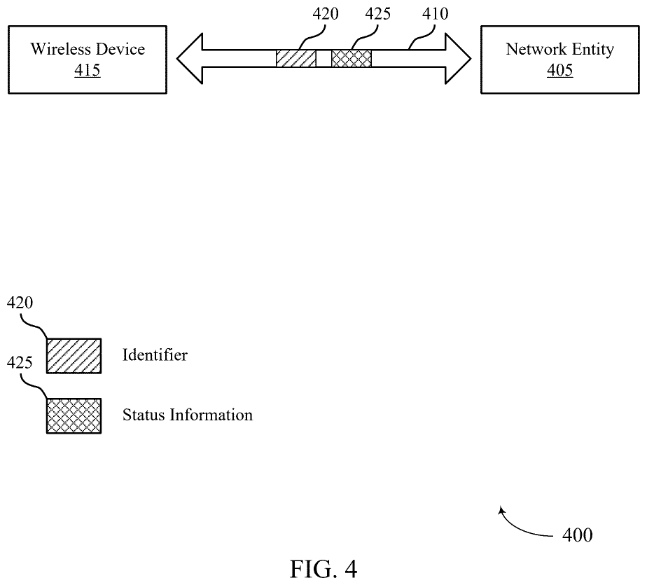

In some examples of the wireless network architecture 300, one or more wireless devices (e.g., the UE 115-a) may perform AI/ML-based positioning or sensing procedures. The wireless devices may use one or more associated identifiers to adapt or change AI/ML models based on network conditions at a network entity (e.g., an LMF, a sensing management function (SnMF), a network node, a CU 160-b, a DU 165-b, an RU 170-b, or a combination thereof). In accordance with some of the techniques of the present disclosure, a network entity may signal an indication of a status, timing validity, or maintenance of associated identifiers to a wireless device when the network entity changes the values or parameters of one or more network settings. For example, after receiving an indication of a set of associated identifiers, a wireless device may receive an indication of a change to a status or timing characteristic of an associated identifier. In another example, a wireless device may communicate a request for the status characteristics, timing characteristics, or both of an associated identifier. In some aspects, based on a monitoring outcome, a wireless devices may also request or recommend that the network entity change the validity or timing characteristics of an associated identifier. Thus, in accordance with some of the techniques of the present disclosure, a wireless device and a network entity may be able to communicate about the condition of associated identifiers to ensure a correspondence or alignment between one or more network settings at the network entity and one or more AI/ML models at the wireless device. Further descriptions of the techniques of the present disclosure enabling wireless devices to obtain (e.g., receive) status information corresponding to one or more identifiers that are associated with one or more network settings may be described elsewhere herein, such as with reference to FIGS. 4 through 8.

FIG. 4 shows an example of a wireless communications system 400 that supports status information for identifiers related to AI/ML in accordance with one or more aspects of the present disclosure. The wireless communications system 400 may implement aspects of or may be implemented by aspects of the wireless communications system 100. For example, the wireless communications system 400 includes a wireless device 415, which may be an example of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, or a UE 115-b, RU 170-b, DU 165-b, or CU 160-b described with reference to FIG. 3. The wireless communications system 400 also includes a network entity 405, which may be an example of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, an RU 170-b, DU 165-b, or CU 160-b described with reference to FIG. 3, an SnMF, or another device.

The wireless device 415 may communicate with the network entity 405 using a communication link 410, which may be an example of a communication link 125, a backhaul communication link 120, or a communication link 155 described with reference to FIG. 1, a communication link 125-a, a backhaul communication link 120-a, a C-plane interface 245, or a U-plane interface 250 described with reference to FIG. 2, a communication link 125-b or a backhaul communication link 120-b described with reference to FIG. 3, or another link. The communication link 410 may include a uni-directional or bi-directional link that enables uplink or downlink network communications. For example, the wireless device 415 may transmit one or more uplink transmissions, such as uplink control signals or uplink data signals, to the network entity 405 using the communication link 410, or the network entity 405 may transmit one or more downlink transmissions, such as downlink control signals or downlink data signals, to the wireless device 415 using the communication link 410.

In some approaches, the wireless device 415 or the network entity 405 may communicate (e.g., output, transmit, obtain, or receive) an indication of one or more identifiers 420. In some approaches, the indication may be communicated via control information (e.g., uplink control information (UCI), downlink control information (DCI)), an RRC message, a medium access control-control element (MAC-CE) message, LTE positioning protocol (LPP) signaling, or NR positioning protocol A (NRPPa) signaling, among other examples.

Each of the one or more identifiers 420 may be associated with one or more network settings of a network node (e.g., base station, gNB, TRP, or positioning reference unit (PRU)). For instance, an identifier 420 may represent or correspond to one or more network settings. A network setting may be a parameter or a condition of operation for a network entity 405 or network node. In some examples, the network entity 405 (e.g., included in a core network) and a network node (e.g., included in a radio access network) may be included in a network. For instance, a network node may apply one or more network settings for communicating with the wireless device 415. The network node may be associated with the network entity 405. For instance, the network node may be a base station (e.g., gNB) that relays communications (e.g., signal(s) or information) between the wireless device 415 and the network entity 405. Additionally, or alternatively, the network node may transmit one or more reference signals to the wireless device 415, which the wireless device 415 may utilize to perform an AI/ML-based positioning or sensing procedure. In some examples, the network node and the network entity 405 may communicate (e.g., output, transmit, obtain, or receive between each other) information indicating the one or more network settings.

In some approaches, the network entity 405 may include (e.g., store) a mapping, database, table (e.g., look-up table), list, array, index, tree, or other data structure indicating the association between the one or more of the identifiers 420 and the one or more network settings (e.g., values or parameters of the network setting(s)). In some approaches, the one or more identifiers 420 may not indicate actual quantities or values of the network setting(s).

Some examples of the one or more network settings may include, and may not be limited to, information indicating a location of a TRP (or PRS) or an antenna reference point (ARP), an uncertainty of a location of a TRP or an ARP, an integrity of a location of a TRP or an ARP, a beam shape (of a TRP or PRS, for instance), a beam angle (e.g., pointing angle) (of a TRP or PRS, for instance), an average or confidence of a beam angle (e.g., pointing angle) (of a TRP or PRS, for instance), a range of a beam angle, an integrity of beam information, TRP beam antenna information, a transmit power (e.g., a PRS transmit power), a power integrity, a relative time difference between TRPs, an integrity of a relative time difference between TRPs, a transmit timing error (for a network node, TRP, or group of TRPs, for instance), an integrity of timing error, integrity information, an identifier of a group of network nodes (for network nodes or TRPs, for instance), an LOS or NLOS state (e.g., TRP expected LOS), PRU information, PRU calibration information, or calibration assistance information associated with a PRU, among other examples.

Some examples of network settings indicating a location of a TRP or ARP, or an integrity of a location of a TRP or ARP may include one or more of the following. An nr-TRP-LocationInfo field may provide location coordinates of one or more TRPs or location coordinates of antenna reference points for downlink PRS (DL-PRS) Resource Set(s) or DL-PRS Resources of the TRPs. A dl-PRS-ResourceSetARP-ErrorCorrelationTime field may specify a DL-PRS Resource Set ARP Error Correlation Time, which may be an upper bound of a correlation time of the DL-PRS Resource Set ARP error. A dl-PRS-ResourceARP-ErrorCorrelationTime field may specify a DL-PRS Resource ARP Error Correlation Time, which may be an upper bound of a correlation time of a DL-PRS Resource ARP error. A dl-PRS-ResourceSetARP or dl-PRS-ResourceSetARP-Cartesian field may provide an antenna reference point location of a DL-PRS Resource Set relative to a trp-Location or trp-LocationCartesian location. If none of dl-PRS-ResourceSetARP or dl-PRS-ResourceSetARP-Cartesian is present, an antenna reference point location of a DL-PRS Resource Set may coincide with the trp-Location or trp-LocationCartesian location. An nr-IntegrityDL-PRS-ResourceSetARP-LocationBounds field may provide a mean or standard deviation ARP of a location error bound of a DL-PRS Resource Set of an overbounding model that bounds the antenna reference point location error of a DL-PRS Resource Set. The nr-IntegrityDL-PRS-ResourceSetARP-LocationBounds field may include one or more sub-fields units, including a meanLocationErrorBound or stdDevLocationErrorBound associated with an nr-IntegrityTRP-LocationBounds field. A dl-PRS-Resource-ARP-List field may provide antenna reference point location(s) of a DL-PRS Resource(s) associated with a Resource Set of a TRP together with integrity information. If the dl-PRS-Resource-ARP-List field is absent, the antenna reference point location(s) of the DL-PRS Resources may coincide with the dl-PRS-ResourceSetARP location or dl-PRS-ResourceSetARP-Cartesian. The dl-PRS-Resource-ARP-List field may include one or more sub-fields. A dl-PRS-Resource-ARP-location or dl-PRS-Resource-ARP-locationCartesian field may provide an antenna reference point location of a DL-PRS Resource associated with a DL-PRS Resource Set of a TRP relative to a dl-PRS-ResourceSetARP or dl-PRS-ResourceSetARP-Cartesian location. If none of dl-PRS-Resource-ARP-location or dl-PRS-Resource-ARP-locationCartesian is present, the antenna reference point location of a DL-PRS Resource may coincide with a dl-PRS-ResourceSetARP location or dl-PRS-Resource-ARP-locationCartesian. An nr-IntegrityDL-PRS-ResourceARP-LocationBounds field may provide a mean or a standard deviation ARP of a location error bound of the DL-PRS Resources of an overbounding model that bounds an antenna reference point location error of a DL-PRS Resource. The nr-IntegrityDL-PRS-ResourceARP-LocationBounds field may include one or more sub-fields units, such as meanLocationErrorBound or stdDevLocationErrorBound, as associated with an nr-IntegrityTRP-LocationBounds field.

Some examples network settings of a transmit power or power integrity (e.g., of a PRS) may include one or more of the following. A beamPowerList field may provide a relative power between DL-PRS Resources for an angle given by azimuth and elevation. A first BeamPowerElement in a list may provide a peak power for an angle and may be defined as 0 decibels (dB) power (e.g., the first value may be set to ‘0’ by a location server). One or more remaining BeamPowerElements in the list may provide a relative DL-PRS Resource power relative to a first element in the list. An nr-dl-prs-RelativePower field, except for a first element in a beamPowerList, may provide a relative power of a DL-PRS Resource, relative to a first element in the beamPowerList. For the first element in beamPowerList, the nr-dl-prs-RelativePower field may provide a peak power for an angle normalized to 0 dB. The nr-dl-prs-RelativePower field may have a scale factor 1 dB, or a range of 0 to −30 dB. An nr-dl-prs-RelativePowerFine field may provide a relatively finer granularity for the nr-dl-prs-RelativePower. A total relative power of the DL-PRS Resource may be given by nr-dl-prs-RelativePower+nr-dl-prs-RelativePowerFine. The nr-dl-prs-RelativePowerFine may have a scale factor of 0.1 dB or a range 0 to −0.9 dB. For a first element in beamPowerList, the nr-dl-prs-RelativePowerFine field may not be utilized in some examples. An nr-IntegrityBeamPowerBounds field may specify a mean or a Standard Deviation beam power error bound for an overbounding model that bounds the beam power error. If the nr-IntegrityBeamPowerBounds field is absent, the nr-IntegrityBeamInfoBounds for an instance of the beamPowerList may be the same as nr-IntegrityBeamInfoBounds of a previous instance in the beamPowerList. If integrity bounds are provided, the nr-IntegrityBeamPowerBounds field may be included in a first instance of the beamPowerList. A meanBeamPower field may specify a Mean Beam Power Error bound, which may be a mean value for an overbounding model that bounds the beam power error of the DL-PRS Resources. The bound may be meanBeamPower+K*stdDevBeamPower or may be such that an associated probability to be exceeded may be lower than IR_{allocation} for ir-Minimum<IR_{allocation}<ir-Maximum, where K=normInv(IR_{allocation}/2) and ir-Minimum, where irMaximum may be provided in an IE NR-IntegrityServiceParameters. IR_{allocation} may be a fraction of a Target Integrity Risk that represents an integrity risk budget available. The meanBeamPower may have a scale factor of 0.1 dB or a range of 0-12.7 dB. A stdDevBeamPower field may specify a Standard Deviation Beam Power Error bound, which may be a standard deviation for an overbounding model that bounds the beam power error of DL-PRS Resources. The stdDevBeamPower field may have a scale factor of 0.1 degrees or a range 0-12.7 dB.

Examples of network settings of beam angles, shapes, or integrity (e.g., of a PRS), may include one or more of the following. An nr-TRP-BeamAntennaAngles field may provide a relative power between DL-PRS Resources per angle per TRP. If the nr-TRP-BeamAntennaAngles field is absent and the field associated-DL-PRS-ID is present, the nr-TRP-BeamAntennaAngles for a TRP may be obtained from nr-TRP-BeamAntennaAngles of an associated TRP. A dl-PRS-BeamInfoSet field may provide DL-PRS beam information for each DL-PRS Resource of a DL-PRS Resource Set associated with a TRP. If the dl-PRS-BeamInfoSet field is absent and a field associated-DL-PRS-ID is present, the dl-PRS-BeamInfoSet for a TRP may be obtained from a dl-PRS-BeamInfoSet of an associated TRP. A dl-PRS-Azimuth field may specify an azimuth angle of a boresight direction in which DL-PRS Resources associated with a DL-PRS Resource ID in the DL-PRS Resource Set may be transmitted. For a Global Coordinate System (GCS), an azimuth angle may be measured counter-clockwise from geographical North. For a Local Coordinate System (LCS), an azimuth angle may be measured counter-clockwise from an x-axis of the LCS. The dl-PRS-Azimuth may have a scale factor of 1 degree or a range of 0 to 359 degrees. A dl-PRS-Azimuth-fine field may provide a relatively finer granularity for the dl-PRS-Azimuth. A total azimuth angle of a boresight direction may be given by dl-PRS-Azimuth+dl-PRS-Azimuth-fine. The dl-PRS-Azimuth-fine field may have a scale factor of 0.1 degrees or a range 0 to 0.9 degrees. A dl-PRS-Elevation field may specify an elevation angle of a boresight direction in which DL-PRS Resources associated with a DL-PRS Resource ID in a DL-PRS Resource Set may be transmitted. For a Global Coordinate System (GCS), an elevation angle may be measured relative to zenith and positive to the horizontal direction (e.g., elevation of 0 degrees may point to zenith, or 90 degrees may point to a horizon). For an LCS, an elevation angle may be measured relative to a z-axis of the LCS (e.g., an elevation of 0 degrees may point to a z-axis, or 90 degrees may point to an x-y plane). The dl-PRS-Elevation field may have a scale factor of 1 degree or a range of 0 to 180 degrees. A dl-PRS-Elevation-fine field may provide a relatively finer granularity for the dl-PRS-Elevation. A total elevation angle of a boresight direction may be given by dl-PRS-Elevation+dl-PRS-Elevation-fine. The dl-PRS-Elevation-fine field may have a scale factor of 0.1 degrees or a range of 0 to 0.9 degrees. An nr-IntegrityBeamInfoBounds field may provide an overbounding model that bounds spatial direction information of DL-PRS Resources. If the nr-IntegrityBeamInfoBounds field is absent, an nr-IntegrityBeamInfoBounds for an instance of the DL-PRS-BeamInfoElement may be the same as the nr-IntegrityBeamInfoBounds of a previous instance of the DL-PRS-BeamInfoElement in DL-PRS-BeamInfoResourceSet. If integrity bounds are provided, the nr-IntegrityBeamInfoBounds field may be present (e.g., present at least) in a first instance of the DL-PRS-BeamInfoResourceSet. The nr-IntegrityBeamInfoBounds may include one or more sub-fields, such as a meanAzimuth, which field may specify a mean azimuth error bound, which may be a mean value for an overbounding model that bounds the azimuth angle error of the boresight direction in which DL-PRS Resources associated with a DL-PRS Resource ID in a DL-PRS Resource Set may be transmitted. A bound may be meanAzimuth+K*stdDevAzimuth of may be such that an associated probability to be exceeded may be lower than IR_{allocation} for ir-Minimum<IR_{allocation}<ir-Maximum, where K=normInv(IR_{allocation}/2) and ir-Minimum, ir-Maximum may be associated with an IE NR-IntegrityServiceParameters. IR_{allocation} may be a fraction of a Target Integrity Risk that represents an integrity risk budget available. The meanAzimuth field may have a scale factor of 0.1 degrees or a range of 0-25.5 degrees. Another example of a subfield may include a stdDevAzimuth field, which may specify a standard deviation azimuth error bound, which may be a standard deviation for an overbounding model that bounds the azimuth error of a boresight direction in which DL-PRS Resources associated with a DL-PRS Resource ID in a DL-PRS Resource Set may be transmitted. The stdDevAzimuth field may have a scale factor 0.1 degrees or a range of 0-25.5 degrees. Another example of a subfield may include a meanElevation field, which may specify a mean elevation error bound, which may be a mean value for an overbounding model that bounds the elevation angle error of a boresight direction in which DL-PRS Resources associated with a DL-PRS Resource ID in a DL-PRS Resource Set may be transmitted. A bound may be meanElevation+K*stdDevElevation or may be such that an associated probability to be exceeded may be lower than IR_{allocation} for ir-Minimum<IR_{allocation}<ir-Maximum, where K=normInv(IR_{allocation}/2) and ir-Minimum, ir-Maximum associated with an IE NR-IntegrityServiceParameters. IR_{allocation} may be a fraction of a Target Integrity Risk that represents an integrity risk budget available. The meanElevation field may have a scale factor of 0.1 degrees or a range of 0-25.5 degrees. Another example of a subfield may include a stdDevElevation field, which may specify a standard deviation elevation error bound, which may be the standard deviation for an overbounding model that bounds an elevation error of a boresight direction in which DL-PRS Resources associated with a DL-PRS Resource ID in a DL-PRS Resource Set may transmitted. The stdDevElevation field may have a scale factor of 0.1 degrees or a range of 0-25.5 degrees. A dl-PRS-BeamInfoErrorCorrelationTime field may specify a Beam Boresight Direction Angle Error Correlation Time, which may be an upper bound of a correlation time of a DL-PRS Resource angle error. A trp-BeamAntennaInfoErrorCorrelationTime field may specify a Mean Beam Power Error Correlation Time, which may be an upper bound of a correlation time of a mean beam power error.

Some examples of network settings of a relative time difference of TRPs or an integrity of relative time difference between TRPs may include one or more of the following. A referenceTRP-RTD-Info field may define a reference TRP for an RTD or may include one or more sub-fields, such as a dl-PRS-ID-Ref field, which may be used along with a DL-PRS Resource Set ID and a DL-PRS Resources ID to uniquely identify a DL-PRS Resource, or may be associated to a reference TRP. Another example of a sub-field may include an nr-PhysCellId-Ref field, which may specify a physical cell identity of a reference TRP. Another example of a sub-field may include an nr-CellGlobalId-Ref field, which may specify an NCGI, which may be a globally unique identity of a cell in NR, of a reference TRP. Another example of a sub-field may include an nr-ARFCN-Ref field, which may specify an NR-ARFCN of a TRP's CD-SSB corresponding to an nr-PhysCellID. Another example of a sub-field may include a refTime field, which may specify a reference time at which an rtd-InfoList may be valid. A systemFrameNumber choice may refer to an SFN of a reference TRP. Another example of a sub-field may include an rtd-RefQuality field, which may specify a quality of a timing of reference TRP, which may be used to determine one or more RTD values provided in rtd-InfoList. A subframeOffset field may specify a subframe boundary offset at a TRP antenna location between a reference TRP and a neighbor TRP in time units, where Δfₘₐₓ=480·10³ Hz. The offset may be counted from a beginning of a subframe #0 of a reference TRP to a beginning of a closest subsequent subframe of a neighbor TRP. The subframeOffset field may have a scale factor 1 Tc. An rtd-Quality field may specify a quality of an RTD. An nr-IntegrityRTD-InfoBounds field may specify an overbounding model that bounds an inter-TRP synchronization error between a reference TRP and another TRP. The nr-IntegrityRTD-InfoBounds field may include a sub-field, such as a resolution, which may be used in a meanRTD or a stdDevRTD. Enumerated values mdot1, m1, m10, or m30 may correspond to 0.1, 1, 10, or 30 meters, respectively. Another example of a sub-field may include a meanRTD field, which may specify a mean inter-TRP synchronization error bound, which may be a mean value for an overbounding model that bounds an inter-TRP synchronization error. The bound may be meanRTD+K*stdDevRTD, or may be such that an associated probability to be exceeded may be lower than an IR_{allocation} for ir-Minimum<IR_{allocation}<ir-Maximum, where K=normInv(IR_{allocation}/2) or ir-Minimum, ir-Maximum may be associated with an IE NR-IntegrityServiceParameters. IR_{allocation} may be a fraction of a Target Integrity Risk that represents an integrity risk budget available. Another example of a sub-field may include a stdDevRTD field, which may specify a standard deviation inter-TRP synchronization error bound, which may be a standard deviation for an overbounding model that bounds an inter-TRP synchronization error. An rtd-ErrorCorrelationTime field may specify an inter-TRP synchronization error Correlation Time, which may be an upper bound of a correlation time of an inter-TRP synchronization error.

Examples of network settings of timing error (e.g., TRP timing error groups), margins, or integrity of timing error may include one or more of a following. A dl-PRS-TEG-InfoSet field may specify a TRP Tx TEG ID associated with one or more transmissions of each DL-PRS Resource of a TRP. A dl-prs-trp-Tx-TEG-ID in a dl-PRS-TEG-InfoSet may be associated with an nr-DL-PRS-ResourceID of NR-DL-PRS-Info using a same structure and order. An nr-TRP-TxTEG-TimingErrorMargin field may specify a timing error margin value for one or more TRP Tx TEGs included in one NR-DL-PRS-TRP-TEG-InfoPerTRP.

Examples of network settings of integrity information may include one or more of the following. AN nr-IntegrityServiceParameters field may specify a range of Integrity Risk (IR) for which integrity assistance data are valid. An nr-IntegrityServiceAlert field may indicate whether corresponding assistance data may be used for integrity related applications.

Examples of network settings of an LOS or NLOS state (e.g., TRP expected LOS) may include one or more of the following. An NR-DL-PRS-ExpectedLOS-NLOS-Assistance field may be used by a location server to provide an expected likelihood of an LOS propagation path from a TRP to a target device, or for one or more DL-PRS Resources of a TRP to a target device.

Examples of network settings of PRU information or PRU calibration information may include one or more of a following. An nr-PRU-LocationInfo field may provide location coordinates of a PRU. An nr-PRU-DL-TDOA-MeasInfo field may specify a list of carrier phase measurement RSCPD together with other measurement information in a DL-TDOA by a PRU. An nr-PRU-DL-AoD-MeasInfo field may specify a list of other measurement information in DL-AOD by a PRU. An nr-PRU-RSCP-MeasInfo field may specify a list of carrier phase measurement RSCP measured by a PRU, together with DL-PRS RSRP, or DL-PRS RSRPP measurement(s) associated with one or more RSCP measurements. In some examples of the techniques described herein, an identifier 420 that is associated with one or more network settings may not uniquely identify an AI/ML model or may not be an AI/ML model identifier (e.g., may not be an identifier 420 that is specific to one AI/ML model).

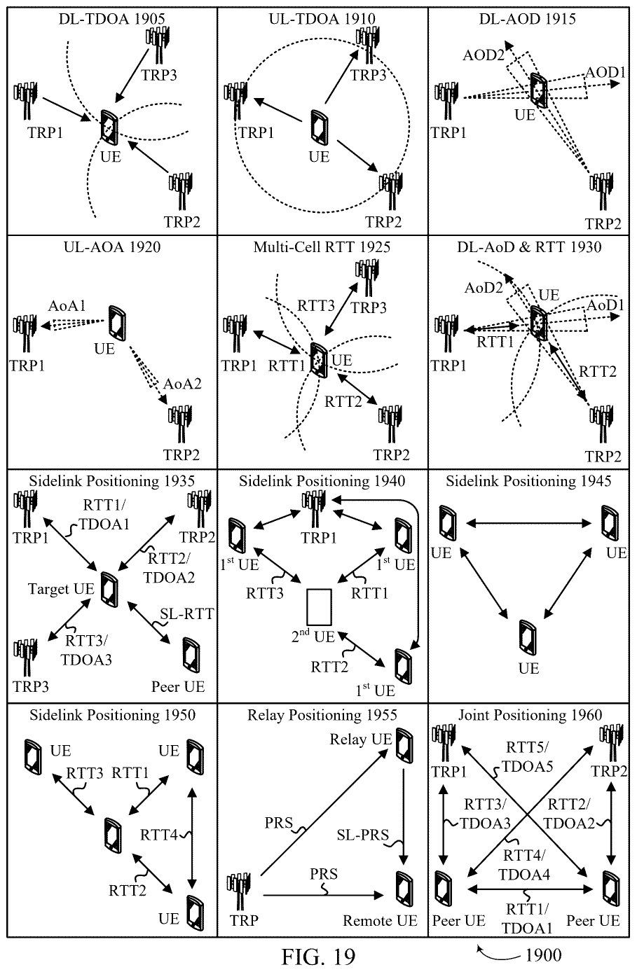

In some examples, the one or more network settings may relate to the communication of reference signaling used in association with the AI/ML-based positioning procedure or may relate to the measurement of reference signaling used in association with the AI/ML-based positioning procedure. A positioning procedure may be one or more operations for estimating a location of a device (e.g., the wireless device 415 or a UE). For instance, a positioning procedure may include one or more operations of A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, or UL-AOA positioning, among other examples. Position information may include an estimated position (e.g., estimated location) or one or more measurements associated with a positioning procedure (e.g., AI/ML-based positioning procedure or non-AI/ML-based positioning procedure). For instance, position information may include a position or measurement determined based on one or more positioning procedures, such as A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, or UL-A positioning, among other examples. Examples of positioning procedures are described with reference to FIG. 19.

As used herein, the term “AI/ML-based positioning or sensing procedure” may refer to a positioning procedure or a sensing procedure performed with an AI model or ML model. An “AI/ML-based positioning or sensing procedure” may refer to direct AI/ML (D-AI/ML) positioning or assisted AI/ML positioning (A-AI/ML). An “AI/ML model” for positioning may refer generally to a physical AI/ML model, a logical AI/ML model, an AI/ML function, AI/ML functionality, or an AI/ML method, among other examples. The term “non-AI/ML-based positioning or sensing procedure” may refer to a positioning procedure or a sensing procedure performed without an AI model or ML model. AI/ML-based positioning or sensing procedures may enhance positioning or sensing accuracy.

A non-AI/ML-based positioning or sensing procedure may include one or more positioning or sensing procedures where an AI/ML technique is not utilized to determine (e.g., infer or predict) a location or measurement. For instance, A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, UL-AOA positioning, or other positioning performed without the use of an AI/ML technique or model may be examples of a non-AI/ML-based positioning procedure.

An AI/ML-based positioning or sensing procedure may include one or more positioning or sensing procedures where one or more AI/ML techniques (e.g., AI/ML model(s) or AI/ML function(s)) are utilized to determine (e.g., infer or predict) a position or measurement. In some examples, an AI model may be utilized to perform one or more operations of a positioning procedure (e.g., to infer or predict a measurement, value, quantity, or location). For instance, A-GNSS positioning, OTDOA positioning, E-CID positioning, sensor-based positioning, WLAN-based positioning, Bluetooth-based positioning, TBS positioning, DL-TDOA positioning, DL-AOD positioning, Multi-RTT positioning, NR E-CID positioning, UL-TDOA positioning, UL-AOA positioning, or other positioning performed with the use of an AI/ML technique(s) or model(s) may be examples of an AI/ML-based positioning or sensing procedure. For instance, an AI model may be trained to model one or more operations of a positioning procedure. When the AI model is executed, for instance, a position or one or more measurements may be generated (e.g., inferred or predicted) without directly performing the one or more operations of the positioning procedure.

A position may be information or data indicating a point, area, or region where an object (e.g., the wireless device 415) is located. A location may be expressed as coordinates (e.g., latitude, longitude, or altitude of a geographic coordinate system (GCS), universal transverse Mercator (UTM) coordinates, state plane coordinate system (SPCS) coordinates, or Earth-centered Earth-fixed (ECEF) coordinates, among other examples), an address, or a location relative to another location, among other examples.

A measurement may be measured, generated, calculated, inferred, or predicted based on one or more samples, data, information, or characteristics of a reference signal. Examples of measurements may include signal strength, reference signal received power (RSRP), reference signal received path power (RSRPP), received signal strength indicator (RSSI), reference signal received quality (RSRQ), signal-to-interference plus noise ratio (SINR), SNR, channel frequency response (CFR), channel impulse response (CIR), power delay profile (PDP), delay profile (DP), channel quality indicator (CQI), CSI, line-of-sight (LOS) indicator, time of arrival (TOA), angle of arrival (AOA), angle of departure (AOD), round-trip time (RTT), reference signal time difference (RSTD), time difference of arrival (TDOA), reference signal carrier phase (RSCP), reference signal carrier phase difference (RSCPD), or reception-to-transmission (Rx-Tx) time difference, among other examples. In some examples, a measurement may be data or an indicator that indicates one or more of the aforementioned values.

In some examples, a network node may output (e.g., transmit), or the wireless device 415 may obtain (e.g., receive), a reference signal. In some examples, the network node may be a PRU. The reference signal may be a signal (e.g., electromagnetic signal, RF signal) with one or more established characteristics (e.g., signaling pattern, strength, amplitude, magnitude, frequency, timing, modulation, phase, or data, among other examples). For instance, the wireless device 415 or the network entity 405 may store information indicating one or more of the characteristics of the reference signal, which may allow for comparison of one or more stored characteristics and one or more characteristics of the received reference signal. The reference signal (e.g., the comparison) may enable channel estimation (e.g., channel attenuation, phase, frequency shift, or Doppler effects, among other examples), positioning, or tracking. Examples of the reference signal may include a reference signal of a synchronization signal block (SSB), a CSI-RS, a positioning reference signal (PRS), a sounding reference signal (SRS), a demodulation reference signal (DMRS), or a tracking reference signal (TRS), among other examples.

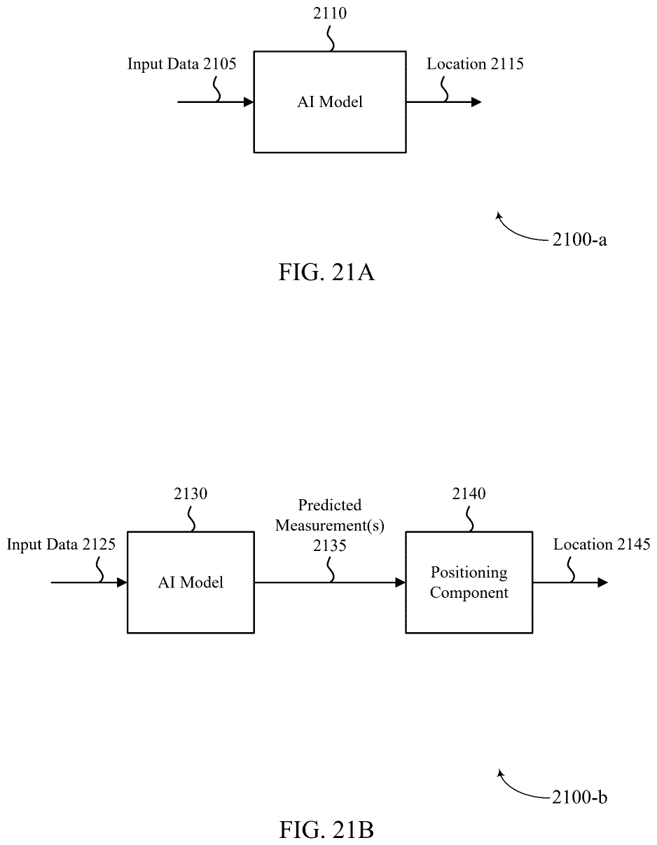

The measurement(s) may be processed to generate input (e.g., input data) to an AI/ML model, to generate training data (e.g., a training dataset), or may be utilized by an AI/ML model to generate a predicted position or other measurements. As used herein, the term “predict,” and variations thereof, may refer to a determination corresponding to a past, current, or future event. Examples of input data, predicted measurements, and positions (e.g., locations) are provided with reference to FIG. 21A and FIG. 21B. In some aspects, an indication of one or more measurements or positions (e.g., one or more predicted measurements or positions) may be communicated with (e.g., transmitted to or received from) the wireless device 415 or the network entity 405. For example, the wireless device 415 may output (e.g., transmit) or the network entity 405 may obtain (e.g., receive) an indication of one or more predicted measurements or positions based on the one or more processing operations associated with AI/ML.

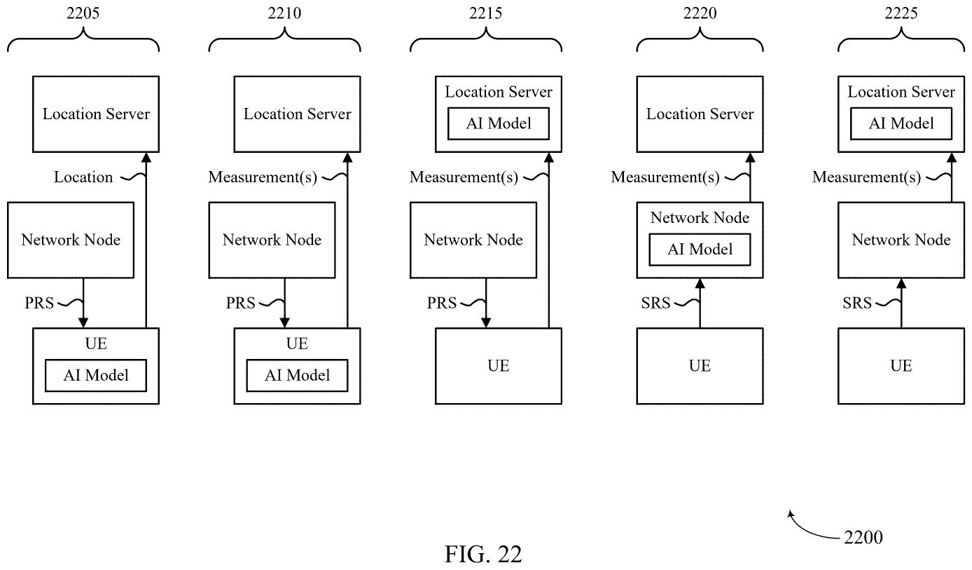

In some examples, one or more AI/ML models may be stored or processed on the wireless device 415 (e.g., a UE or a network node) or on the network entity 405 (e.g., a network node or a location server). Examples of locations where an AI/ML model may be stored or processed are provided with reference to FIG. 22. One or more of the techniques described herein may be utilized to control (e.g., activate, deactivate, select, switch, transition to, or transition from) one or more AI/ML models.

One or more AI/ML-based positioning procedures (e.g., AI/ML model(s) or AI/ML function(s), among other examples) may correspond to an identifier of one or more identifiers 420. An identifier 420 may be a value, code, signal, index, or other information. For instance, the wireless device 415 may include (e.g., store) a mapping, database, table (e.g., look-up table), list, array, index, tree, or other data structure indicating the correspondence between one or more of the identifiers 420 and one or more of the AI/ML-based positioning procedures.

In some aspects, the one or more network settings may impact reference signaling or AI/ML-based positioning or sensing procedure performance. For instance, one or more network settings may affect the accuracy, reliability, correspondence, or alignment between AI/ML training and prediction (e.g., inference). In some examples, an AI/ML model may be trained in correspondence with one or more network settings. If the one or more network settings change, AI/ML model performance may be reduced. Because the one or more network settings may impact reference signaling or AI/ML-based positioning procedure performance, it may be helpful to maintain a correspondence between an AI/ML-based positioning procedure and the network setting(s) utilized during training of the AI/ML-based positioning procedure (e.g., AI/ML model or function). The one or more identifiers 420 described herein may be utilized to establish a correspondence with one or more AI/ML-based positioning procedures, or to control one or more AI/ML-based positioning procedures (e.g., perform LCM) to maintain a correspondence between one or more AI/ML-based positioning procedures and network settings, while avoiding an explicit indication of the network setting(s).

Table (1) provides some more specific examples of network settings (which may impact a correspondence or alignment between training and prediction) with corresponding information elements (IEs).

TABLE 1

| | |
|---|---|
| Network Settings | IE |
| TRP/ARP location information | NR-TRP-LocationInfo-r16 |
| PRS/Beam angle or transmit power | NR-DL-PRS-BeamInfo-r16, nr-TRP- |
| | BeamAntennaInfo, |
| TRP relative time difference | NR-RTD-Info-r16 |
| TRP TX timing error | NR-DL-PRS-TRP-TEG-Info |
| TRP LOS/NLOS state | NR-DL-PRS-ExpectedLOS-NLOS- |
| | AssistancePerTRP-r17 |
| PRU-based calibration assistance | NR-PRU-DL-Info-r18 |

As described herein, the network entity 405 (e.g., location server or LMF) may provide (e.g., configure) the wireless device 415 with one or more identifiers 420 associated with one or more network settings. In some approaches, one or more identifiers 420 may be communicated (e.g., output, transmitted, obtained, or received) via signaling associated with an assistance data provision procedure or via a broadcast of assistance data. For example, signaling for providing the identifier(s) may be part of a “provide assistance data” procedure. Additionally, or alternatively, signaling for providing the identifier(s) 420 may be part of a broadcast of assistance data signaling. For instance, the identifier(s) 420 may be communicated via a positioning system information block (SIB).

In some examples, one or more identifiers 420 may be provided in a message of assistance data as a candidate identifier for use with the AI/ML-based positioning procedure. In an assistance data message, for instance, the network entity 405 (e.g., LMF) may provide a list of potential identifiers 420 (e.g., one or more identifiers 420 for which a correspondence may be established with one or more AI/ML-based positioning procedures).

In some approaches, the one or more identifiers 420 may be provided in a message of assistance data that indicates one or more areas for which the one or more identifiers 420 are valid. In an assistance data message, for example, the network entity 405 (e.g., LMF) may provide information indicating one or more area validities for one or more identifiers 420. In some aspects, the area or area validity may be indicated as (or correspond to) a training area, validity area, prediction area (e.g., inference area), or data collection area, among other examples.

In some examples, network settings may be referred to as conditions, which may be divided into two categories: network-side additional conditions or wireless device-side additional conditions. For an AI/ML-enabled feature, additional conditions may refer to one or more aspects for the training of the model (but which may not be a part of wireless device 415 capability for the AI/ML-enabled feature).

For prediction for wireless device-side models, to ensure correspondence or alignment between training and prediction regarding one or more network-side additional conditions, one or more of the following options may be utilized: model identification to achieve alignment on the network-side additional condition between network-side and wireless device-side, model training at the network and transfer to wireless device 415, where the model has been trained under the additional condition, information or indication on network-side additional conditions provided to the wireless device 415, correspondence or alignment assisted by monitoring (by the wireless device 415 or network, the performance of wireless device-side candidate models or functionalities to select a model or functionality.

One or more options may be utilized for model identification. In a first option, model identification with data collection related configuration(s) or indication(s) may be performed. In a second option, model identification may be performed with dataset transfer. In a third option, model identification may be performed in a model transfer from network to the wireless device 415. In a fourth option, model identification may be carried out via standardization of reference models (for CSI compression). In a fifth option, model identification may be performed via model monitoring.

In the first option, (e.g., model identification with data collection related configuration(s) or indication(s)) one or more of the following aspects may be utilized. A relationship between a model identifier and data collection related configuration(s) or indication(s) may be utilized. Information transmitted from the network to the wireless device 415 may be utilized. Information transmitted from the wireless device 415 to the network may be utilized.

In some approaches, wireless device-sided AI/ML model(s) may be developed (e.g., trained or updated) at the wireless device 415. One or more of the following aspects may be utilized in some examples. For data collection, the network signals a data collection related configuration(s) and an associated identifier(s). As used herein, an associated identifier may refer to an identifier 420 associated with one or more network settings. The associated identifiers may be utilized in relation with network-sided additional conditions. The wireless device 415 may collect the data corresponding to the associated identifier(s). One or more AI/ML models may be developed (e.g., trained or updated) at the wireless device 415 side based on the collected data corresponding to the associated identifier(s).

The wireless device 415 may (to facilitate AI/ML model inference or prediction) report information of the one or more AI/ML models corresponding to the associated identifiers to the network. A model identifier may be determined or assigned for each AI/ML model. In some examples, the reported information may indicate a relationship between the model identifier(s) and the associated identifier(s), how the model identifier(s) are determined or assigned (e.g., the network assigns the model identifier, the wireless device 415 assigns or reports the model identifier, or the associated identifier(s) may be assumed as a model identifier(s) (where a model identifier for each AI/ML model may not be determined or utilized), or the model identifier is determined via one or more rules. One or more of these procedures may be utilized with interaction of associated identifiers between the wireless device 415 and network for resolving the correspondence issue without model identification. Regarding the associated identifier, the wireless device 415 may assume that network-side additional conditions with the same associated identifier may be utilized (e.g., are reliable) at least within one or more cells in some approaches.

From a network perspective, for a wireless device part of a two-sided model may be utilized in the following example of model identification. A dataset may be transferred from the network or network-side to the wireless device 415 or wireless device-side via signaling. A wireless device part of the two-sided model(s) may be developed based on the dataset. The wireless device may report information of the wireless device part of the two-sided model(s) corresponding to the dataset to the network. A model may be trained on the network side or on the wireless device 415 side first.

In some approaches, the associated identifier may be utilized for training or prediction correspondence or alignment for an AI/ML one or more beam management use cases. For instance, an associated identifier may be utilized to ensure correspondence or alignment for network-side additional condition(s) across training and prediction for a wireless device-sided model for beam management cases, where the network-side additional condition may impact the training and prediction correspondence for multiple (e.g., different) sets of beams. In some examples, the associated identifier may be communicated within a CSI framework or outside of the CSI framework. In some approaches, the associated identifier may be utilized to control an AI/ML-based positioning procedure based on performance monitoring.

In some approaches, the associated identifier may be utilized to ensure a correspondence or alignment for training and prediction for AI/ML-based positioning. For AI/ML based positioning Case 1 and Case 2a, for instance, the associated identifier may be utilized to coordinate network-side additional condition(s) (e.g., network settings) to ensure the correspondence or alignment between training and prediction. In some cases, network-side additional conditions with the same associated identifier may be utilized within a cell, a TRP, or an area.

In some approaches, network settings may be mapped to an associated identifier, and the network entity 405 (e.g., LMF) may indicate one or more identifiers 420 to the wireless device 415 (e.g., UE) for checking on an AI/ML model at the wireless device 415 (where the network maintains a correspondence between identifiers and corresponding network settings, for instance). In some aspects, as described herein, the network entity 405 may change one or more network settings (e.g., TRP relative time difference, TRP/PRS transmission power, TRP/PRS beam shape, among others) without transmitting an explicit indication of the values or ranges of the one or more network settings to the wireless device 415 (to avoid disclosing proprietary information, for instance), which can result in a lack of correspondence or alignment of an AI/ML model at the wireless device 415. Further, while the network entity 405 may map one or more network settings to identifiers 420 (e.g., associated identifiers) for the wireless device 415, the values or ranges of the one or more network settings may change over time making an identifier 420 invalid or expired. In such cases, the network entity 405 may timely update the wireless device 415 about the status, timing validity, or maintenance of the identifier 420 when the corresponding network settings change.

In accordance with some of the techniques of the present disclosure, the wireless device 415 may obtain (e.g., receive), from the network entity 405, status information 425 corresponding to one or more identifiers 420 that are associated with one or more network settings. The one or more network settings may relate to communication of reference signaling for AI/ML-based positioning or sensing procedures or measurement of reference signaling for AI/ML-based positioning or sensing procedures. Some of the techniques of the present disclosure may describe signaling between the wireless device 415 and the network entity 405 (e.g., a network node 105 or LMF) to indicate status or timing validity for associated identifiers corresponding to one or more network settings. In some cases, the one or more network settings for AI/ML positioning may correspond to conditions or additional conditions related to information related to one or one or more network nodes (e.g., gNB(s) or TRP(s), among other examples), reference signal transmission at the network node side (e.g., gNB or TRP side), network node (e.g., gNB or TRP) transmission settings, or PRU calibration information, among other examples.

In some examples, the wireless device 415 may output (e.g., transmit) a request, to the network entity 405, for the status information 425 (e.g., status or timing characteristics) that corresponds to the one or more identifiers 420 (e.g., associated identifiers) that are associated with one or more network settings (e.g., that correspond to AI/ML positioning network conditions or conditions at the network entity 405). Further, the wireless device 415 may obtain (e.g., receive) the status information 425 based on the request. In another example, the wireless device 415 may output, to the network entity 405, a request to confirm the status information 425 corresponding to the one or more identifiers 420 that are associated with the one or more network settings. For example, in accordance with some of the techniques of the present disclosure, the wireless device 415 may be configured to reconfirm (e.g., with the network entity 405 which may be a network node 105 or an LMF) the validity of one or more associated identifiers that correspond to AI/ML positioning network conditions. Additionally, or alternatively, the wireless device 415 may obtain the status information 425 from the network entity 405 based on the request from the wireless device 415, via a positioning protocol message, or a combination thereof. For example, the wireless device 415 may receive indications from an LMF related to status and timing characteristics of one or more associated identifiers that correspond to AI/ML positioning network conditions. In some cases, the wireless device 415 may receive the indications based on a request from the wireless device 415 to the LMF or the indications (e.g., signaling) can be part of LPP signaling.

The wireless device 415 may also obtain (e.g., receive), from the network entity 405, an indication of a change to the status information 425 corresponding to the one or more identifiers 420 that are associated with the one or more network settings. For example, the wireless device 415 may receive signaling from an LMF that indicates one or more changes related to status or timing characteristics of one or more associated identifiers that correspond to AI/ML positioning network conditions. In some cases, the signaling may be part of LPP signaling. In some aspects, the indication of the change to the status information 425 may include an indication of a change from an active status, a pause status, an inactive status, a canceled status, an aborted status, or any combination thereof, to a different status. For example, the status information 425 of an identifier 420 may indicate a change from an active status to a pause status, a change from an active status to an inactive status, a change from an active status to a canceled or aborted status, among others.

Additionally, or alternatively, the wireless device 415 may obtain (e.g., receive), from the network entity 405, an indication of a change to at least one identifier 420 of the one or more identifiers 420 that are associated with the one or more network settings. In some cases, the change to the at least one identifier 420 may include an update to the at least one identifier 420, a replacement of the at least one identifier 420, or a combination thereof. That is, the wireless device 415 may receive signaling (e.g., the status information 425) from an LMF indicating changes related to replacing or updating the identifier 420 of an associated identifier that corresponds to AI/ML positioning network conditions. For example, the status information 425 may indicate a replacement of a first identifier 420 (e.g., identifier X) that is associated with a network condition or setting with a second identifier (e.g., identifier Y). In some aspects, the wireless device 415 may obtain the signaling via a positioning protocol procedure (e.g., via an LPP).

In some examples, obtaining (e.g., receiving) the status information 425 may include the wireless device 415 obtaining, from the network entity 405, one or more timing characteristics corresponding to the one or more identifiers 420 that are associated with the one or more network settings. In such examples, the status information 425 may include the one or more timing characteristics. In some cases, the one or more timing characteristics of a respective identifier 420 may include an indication of a status timer (e.g., a validity timer), a status start time, a status stop time, a status start date, a status stop date, or any combination thereof. Additionally, or alternatively, the one or more timing characteristics may include one or more indications of an active expiration timer, an active time period (e.g., a start/stop time for activity), an active date period (e.g., a start/stop data for activity), or any combination thereof. The one or more timing characteristics may additionally, or alternatively, include one or more indications of a pause expiration timer, a pause time period (e.g., a start/stop time for pause), a pause date period (e.g., a start/stop date for pause), or any combination thereof. The one or more timing characteristics may additionally, or alternatively, include one or more indications of an inactive expiration timer, an inactive time period (e.g., a start/stop time for inactivity), am inactive date period (e.g., a start/stop date for inactivity), or any combination thereof. The one or more timing characteristics may additionally, or alternatively, include one or more indications of an expiration timer, an expiration time stamp, an abortion/cancellation time stamp, or any combination thereof. In some aspects, a pause state may be an example of an intermediate state between active and inactive. For example, a pause to an associated identifier may indicate that the associated identifier may be inactive for a period (e.g., a relatively short period) of time but may be resumed within a period (e.g., resumed soon) to be active.

In some examples, obtaining (e.g., receiving) the status information 425 may include the wireless device 415 obtaining, from the network entity 405, one or more status characteristics that correspond to the one or more identifiers 420 that are associated with the one or more network settings. The status information 425 may include the one or more status characteristics. For example, the one or more status characteristics may include a valid status, an invalid status, an active status, a paused status, an inactive status, an expired status, an aborted status, a canceled status, or any combination thereof. The term “valid” may refer to an associated identifier and the corresponding network conditions or settings being valid. The term “active” may refer to an associated identifier and the corresponding network conditions or settings being active. The term “paused” may refer to an associated identifier and the corresponding network conditions or settings not currently being active but to be resumed (e.g., resumed relatively soon). The term “inactive” may refer to an associated identifier that is not active but that may be activated or reconsidered. The term “expired” may refer to a corresponding timer or timing validity of an associated identifier being outdated. In some approaches, an associated identifier with outdated status may be utilized based on verification or confirmation of the associated identifier (e.g., and the corresponding network conditions or settings). The term “aborted” or “canceled” may refer to an associated identifier being canceled (e.g., affirmatively canceled by the wireless device 415, the network entity 405, or both).

In some cases, the wireless device 415 may determine that the status information 425 of a respective identifier 420 of the one or more identifiers 420 indicates that the respective identifier is valid based on a status characteristic of the respective identifier 420, a timing characteristic of the respective identifier 420, an absence of an indication from the network entity 405 associated with the status information 425 of the respective identifier 420, or any combination thereof. For example, the wireless device 415 may determine that an associated identifier that corresponds to AI/ML positioning network conditions is valid as long as the status of the associated identifier is valid, the timing validity of the associated identifier is unexpired, or a combination thereof. Additionally, or alternatively, if the wireless device 415 is not provided with a validity timing indication for an associated identifier, the wireless device 415 may determine that the associated identifier is valid unless explicitly indicated otherwise. In some examples, the wireless device 415 may output (e.g., transmit), to the network entity 405 and in response to an expiration of a timing validity timer of at least one identifier 420 of the one or more identifiers 420, a request to confirm the status information 425 of the at least one identifier 420. For example, based on a timing validity expiration for an associated identifier, the wireless device 415 may output a request to an LMF to confirm if the associated identifier and the corresponding network conditions or settings are still valid.

In some examples, the wireless device 415 may output (e.g., transmit), to the network entity 405, a request for the network entity 405 to change the status information 425 of a respective identifier 420 of the one or more identifiers 420 that correspond to the one or more network settings. For example, the wireless device 415 may conduct (e.g., execute or perform) a monitoring procedure for AI/ML positioning. Based on a monitoring outcome, the wireless device 415 may output an indicator to the network entity 405 (e.g., an LMF) that indicates a request or recommendation to change the validity of an associated identifier that corresponds to one or more network settings. In another example, the wireless device 415 may determine that an AI/ML positioning or sensing model is invalid and may determine that the invalidity is due to a change of one or more network settings. If the network entity 405 (e.g., a network node 105 or LMF) maintains the same associated identifier and considers the associated identifier valid, the wireless device 415 may request the network entity 405 to change the status information 425 (e.g., status or validity information) of the associated identifier.

In some cases, the wireless device 415 may output (e.g., transmit), to the network entity 405, a capability message indicating a capability of the wireless device 415 to obtain the status information 425 that corresponds to the one or more identifiers 420 associated with the one or more network settings. For example, the wireless device 415 may output, to the network entity 405, an indication that the wireless device 415 is capable of supporting receiving a validity indicator, validity status characteristics, validity timing characteristics, validity relation characteristics, or any combination thereof for an associated identifier. Additionally, or alternatively, the wireless device 415 may output, to the network entity 405, an indication that the wireless device 415 is capable of requesting the status information 425 that indicates the validity characteristics, timing characteristics, status characteristics, relation characteristics, or any combination thereof of an associated identifier. Additionally, or alternatively, via the capability message, the wireless device 415 may indicate that the wireless device 415 is capable of requesting a confirmation of the validity of an associated identifier, requesting for the validity of an associated identifier to be updated, or both.

In some approaches, status characteristics or timing characteristics may be related. For instance, status characteristics or timing validity characteristics may be related between associated identifiers. In some examples, the status information 425 of a first identifier 420 of the one or more identifiers 420 may be based on the status information 425 of a second identifier 420 of the one or more identifiers 420 based on a relation between the first identifier 420 and the second identifier 420. For example, if one associated identifier is linked to another associated identifier, both associated identifiers may have the same timing and validity status (e.g., the same status information 425). For instance, if the network entity 405 updates one associated identifier, the wireless device 415 may determine (e.g., predict or infer) a list of linked associated identifiers that have status and timing characteristics updated accordingly.

Additionally, or alternatively, based on the status information 425 corresponding to the one or more identifiers 420, the wireless device 415 may perform an operation to control the AI/ML-based positioning or sensing procedure. For example, the wireless device 415 may execute or perform a management or LCM action based on a validity status of an associated identifier. Moreover, the operation to control the AI/ML-based positioning or sensing procedure may include an activation of an AI/ML model, a selection of an AI/ML model, switching an AI/ML model, a deactivation of an AI/ML model, switching to a non-AI/ML-based positioning or sensing procedure, or any combination thereof based on the status information 425 corresponding to the one or more identifiers 420.

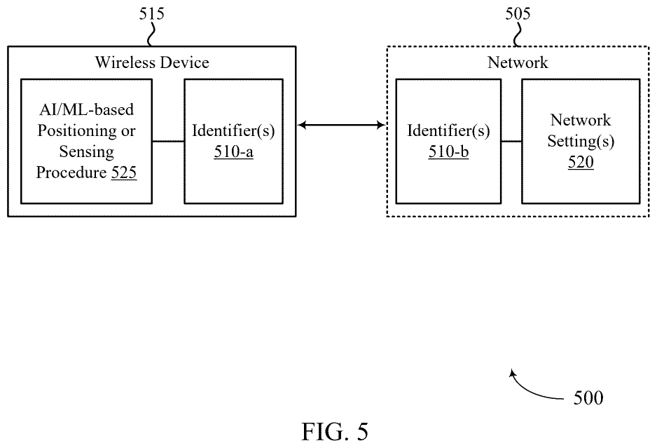

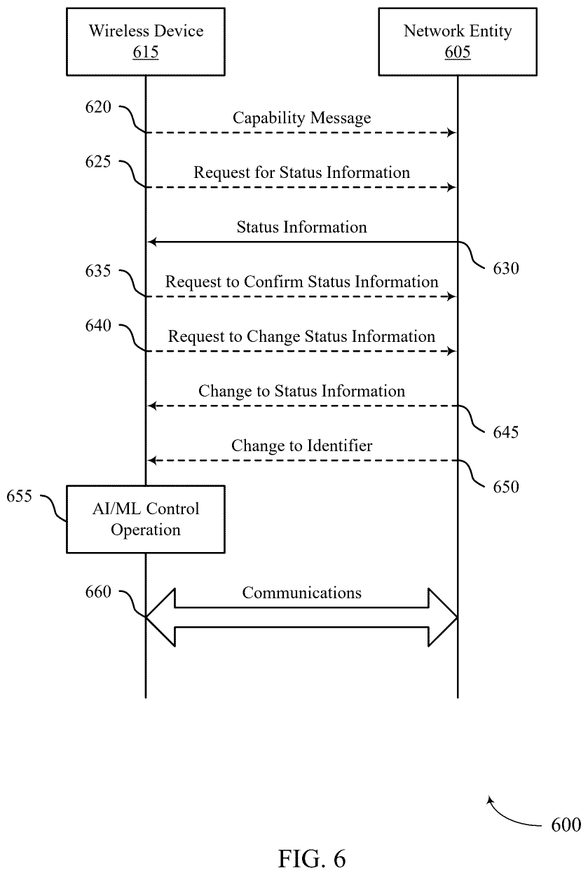

In accordance with some of the techniques of the present disclosure, the wireless device 415 may obtain (e.g., receive) the status information 425 for one or more identifiers 420 that correspond to one or more network settings. Utilizing the status information 425, the wireless device 415 may perform actions to control AI/ML-based positioning or sensing procedures to enhance the positioning performance, sensing performance, or both at the wireless device 415. For example, based on obtaining the status information 425, the wireless device 415 may be capable of selecting, activating, deactivating, or switching AI/ML models to ensure efficient, reliable, and accurate positioning and sensing predictions for the AI/ML-based positioning or sensing procedures. Further descriptions of the techniques of the present disclosure may be described elsewhere herein, such as with reference to FIGS. 5 and 6.

FIG. 5 shows an example of a wireless communications system 500 that supports status information for identifiers related to AI/ML in accordance with one or more aspects of the present disclosure. The wireless communications system 500 may implement aspects of or may be implemented by aspects of the wireless communications system 100, the wireless communications system 400, or both. For example, the wireless communications system 500 includes a wireless device 515, which may be an example of a UE 115, network node 105, RU 170, DU 165, or CU 160 described with reference to FIG. 1, a UE 115-a, gNB 255, RU 170-a, DU 165-a, CU 160-a, or ng-eNB 260 described with reference to FIG. 2, a UE 115-b, RU 170-b, DU 165-b, or CU 160-b described with reference to FIG. 3, or a wireless device 415 described with reference to FIG. 4. The wireless communications system 500 also includes a network 505, which may be an example of a network node 105, location server 185, RU 170, DU 165, or CU 160 described with reference to FIG. 1, an LMF 265, external device 230, SLP 235, AMF 210, SMF 220, UPF 215, gNB 255, RU 170-a, DU 165-a, CU 160-a, or ng-eNB 260 described with reference to FIG. 2, or an RU 170-b, DU 165-b, or CU 160-b described with reference to FIG. 3, a network entity 405 described with relation to FIG. 4, or a combination thereof.

As illustrated in FIG. 5, the network 505 (e.g., network entity) may include one or more identifiers 510-b, which may be associated with one or more network settings 520. The association(s) between the one or more identifiers 510-b and the one or more network settings 520 may be structured as described with reference to FIG. 4.

The wireless device 515 may include one or more identifiers 510-a. At least one of the one or more identifiers 510-a may correspond to (e.g., may match) at least one of the one or more identifiers 510-b. One or more of the identifiers 510-a may correspond to one or more AI/ML-based positioning or sensing procedures 525 (e.g., AI/ML model(s) or AI/ML function(s) for producing measurement information related to positioning). The correspondence between the one or more identifiers 510-a and the one or more AI/ML-based positioning or sensing procedures 525 may be structured as described with reference to FIG. 4.

In some aspects, as described elsewhere herein, the network 505 may change the values or ranges of one or more network settings 520 that are associated with the one or more identifiers 510-b. In some cases, the network 505 may not output an indication of changes to the one or more network settings 520 that may result in a decrease in reliability, accuracy, and efficiency of the AI/ML-based positioning or sensing procedures 525 at the wireless device 515. In accordance with some of the techniques of the present disclosure, to ensure reliable, accurate, or efficient AI/ML-based positioning or sensing procedures 525 at the wireless device 515, the network 505 may output (e.g., transmit) status information for the one or more identifiers 510-a. For example, the network 505 may indicate timing or validity characteristics for the one or more identifiers 510-a such that the wireless device 515 can control the AI/ML-based positioning or sensing procedures 525 relatively more efficiently.

In some cases, the network 505 may transmit the status information to the wireless device 515 along with the one or more identifiers 510. In some other casts, the wireless device 515 may request the status information from the network 505. For example, the wireless device 515 may detect a decrease in performance in the AI/ML-based positioning or sensing procedures 525 at the wireless device 515 and may determine that the decrease in performance is due to a change in network settings 520 at the network 505. In response, the wireless device 515 may request to obtain (e.g., receive) status information on the one or more identifiers 510-a. Additionally, or alternatively, the wireless device 515 may request for a change to the status information associated with the one or more identifiers 510-a. For example, based on detecting a decrease in performance of the AI/ML-based positioning or sensing procedures 525 at the wireless device 515 when a respective identifier 510-a is active, the wireless device 515 may request the network 505 to change the status or validity of the respective identifier 510-a. Thus, in accordance with some of the techniques of the present disclosure, the wireless device 515 may be capable of helping to ensure that the AI/ML-based positioning or sensing procedures 525 are reliable, efficient, or accurate based on utilizing the status information associated with identifiers 510 that correspond to one or more network settings 520. Further descriptions of the techniques of the present disclosure may be described elsewhere herein, such as with reference to FIG. 6.

FIG. 6 shows an example of a process flow 600 that supports status information for identifiers related to AI/ML in accordance with one or more aspects of the present disclosure. The process flow 600 may include a wireless device 615, which may be an example of a UE 115, the UE 115-a, the UE 115-b, the wireless device 415, or the wireless device 515, as described herein. The process flow 600 may also include a network entity 605, which may be an example of the location server 185, the LMF 265, the external device 230, the SLP 235, a network entity 405, or a network 505, as described herein. In some approaches, network entity 605 may communicate with the wireless device 615 via one or more network nodes (e.g., base station(s), TRP(s), CU(s), DU(s), or RU(s), among other examples).

In the following description of the process flow 600, the operations between the wireless device 615 and the network entity 605 may be performed in different orders or at different times. Some operations may be left out of the process flow 600, or other operations may be added. In some examples, some operations may be combined or performed in overlapping time periods. Although the wireless device 615 and the network entity 605 are shown performing the operations of the process flow 600, some aspects of some operations may also be performed by one or more other wireless devices.

At 620, in some examples, the wireless device 615 may output (e.g., transmit), to the network entity 605, a capability message indicating a capability of the wireless device 615 to obtain status information corresponding to one or more identifiers that are associated with one or more network settings.

At 625, in some cases, the wireless device 615 may output, to the network entity 605, a request for status information corresponding to the one or more identifiers that are associated with one or more network settings.

At 630, the wireless device 615 may obtain (e.g., receive), from the network entity 605, status information corresponding to one or more identifiers that are associated with one or more network settings. The one or more network settings may relate to communication of reference signaling for an AI/ML-based positioning or sensing procedure or measurement of reference signaling for an AI/ML-based positioning or sensing procedure. In some cases, the wireless device 615 may obtain the status information based on a request from the wireless device 415 (e.g., such as the request at 625), via a positioning protocol (e.g., LPP) message, or a combination thereof. Additionally, or alternatively, the wireless device 615 may obtain the status information based on the output of the capability message at 620.

In some examples, the wireless device 615 may obtain, from the network entity 605, one or more timing characteristics corresponding to the one or more identifiers that are associated with the one or more network settings and the status information may include the one or more timing characteristics. In some cases, the one or more timing characteristics of a respective identifier comprises an indication of a status timer, a status start time, a status stop time, a status start date, a status stop date, or any combination thereof. Additionally, or alternatively, the wireless device 615 may obtain, from the network entity 605, one or more status characteristics corresponding to the one or more identifiers that are associated with the one or more network settings and the status information may include the one or more status characteristics. In some cases, the one or more status characteristics may include a valid status, an invalid status, an active status, a pause status, an inactive status, an expired status, an aborted status, a canceled status, or any combination thereof.

In another example, the wireless device 415 may determine that the status information of a respective identifier of the one or more identifiers indicates that the respective identifier is valid based on a status characteristic of the respective identifier, a timing characteristic of the respective identifier, or an absence of an indication from the network entity 605 associated with the status information of the respective identifier. Additionally, or alternatively, the status information of a first identifier of the one or more identifiers may be based on the status information of a second identifier of the one or more identifiers based on a relation between the first identifier and the second identifier. In some examples, the status information may indicate the relation between the first identifier and the second identifier.

At 635, in some cases, the wireless device 615 may output (e.g., transmit), to the network entity 605, a request to confirm the status information corresponding to the one or more identifiers that are associated with the one or more network settings. In some approaches, the wireless device 615 may output, to the network entity 605 and in response to an expiration of a timing validity timer of at least one identifier of the one or more identifiers, a request to confirm the status information of the at least one identifier. At 640, the wireless device 615 may output, to the network entity 605, a request for the network entity 605 to change the status information of a respective identifier of the one or more identifiers corresponding to the one or more identifiers that are associated with the one or more network settings.

At 645, the wireless device 615 may obtain (e.g., receive), from the network entity 605, an indication of a change to the status information corresponding to the one or more identifiers that are associated with the one or more network settings. In some cases, the indication of the change to the status information may be an indication of a change from an active status, a pause status, an inactive status, a canceled status, an aborted status, or any combination thereof, to a different status. At 650, the wireless device 615 may obtain, from the network entity 605, an indication of a change to at least one identifier of the one or more identifiers that are associated with the one or more network settings. In some examples, the change to the at least one identifier may be an update to the at least one identifier, a replacement to the at least one identifier, or a combination thereof.

At 655, the wireless device 615 may perform an operation to control the AI/ML-based positioning or sensing procedure based on the status information corresponding to the one or more identifiers. In some cases, the operation to control the AI/ML-based positioning or sensing procedure may be based on the request at 635 from the wireless device 615 to confirm the status information. The operation to control the AI/ML-based positioning or sensing procedure may include an activation of an AI/ML model, a selection of an AI/ML model, switching an AI/ML model, a deactivation of an AI/ML model, switching to a non-AI/ML-based positioning or sensing procedure, or any combination thereof based on the status information corresponding to the one or more identifiers. At 660, the network entity 605 may communicate with the wireless device 615 based on the one or more network settings.

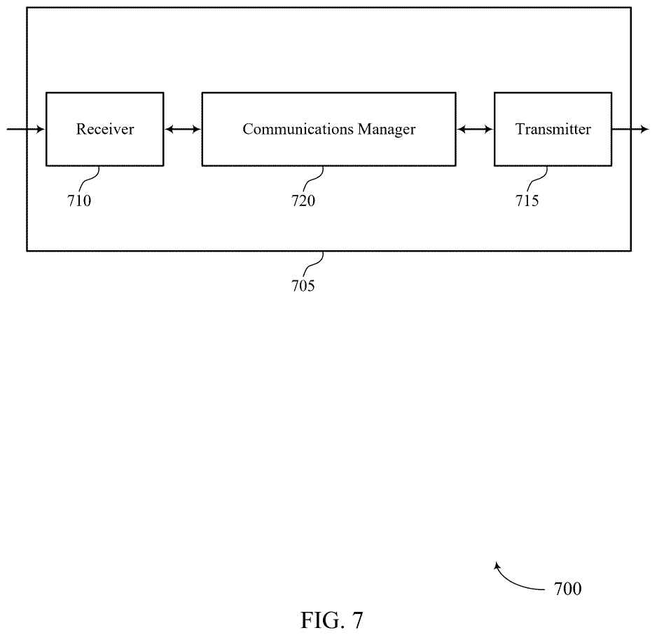

FIG. 7 shows a block diagram 700 of a device 705 that supports status information for identifiers related to AI/ML in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to status information for identifiers related to AI/ML). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to status information for identifiers related to AI/ML). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of status information for identifiers related to AI/ML as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The communications manager 720 is capable of, configured to, or operable to support a means for performing an operation to control the AI/ML-based positioning or sensing procedure based on the status information corresponding to the one or more identifiers.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for a wireless device to obtain status information for one or more identifiers to enhance the control and performance of AI/ML-based positioning or sensing procedures to support reduced processing, reduced power consumption, and more efficient utilization of communication resources.

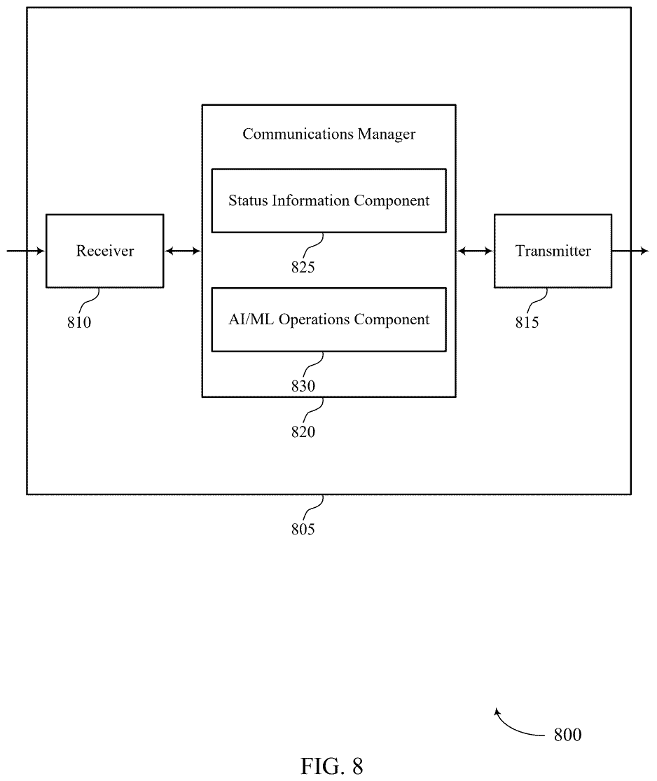

FIG. 8 shows a block diagram 800 of a device 805 that supports status information for identifiers related to AI/ML in accordance with one or more aspects of the present disclosure. The device 805 may be an example of aspects of a device 705 or a wireless device as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to status information for identifiers related to AI/ML). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to status information for identifiers related to AI/ML). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of status information for identifiers related to AI/ML as described herein. For example, the communications manager 820 may include a status information component 825 an AI/ML operations component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The status information component 825 is capable of, configured to, or operable to support a means for obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The AI/ML operations component 830 is capable of, configured to, or operable to support a means for performing an operation to control the AI/ML-based positioning or sensing procedure based on the status information corresponding to the one or more identifiers.

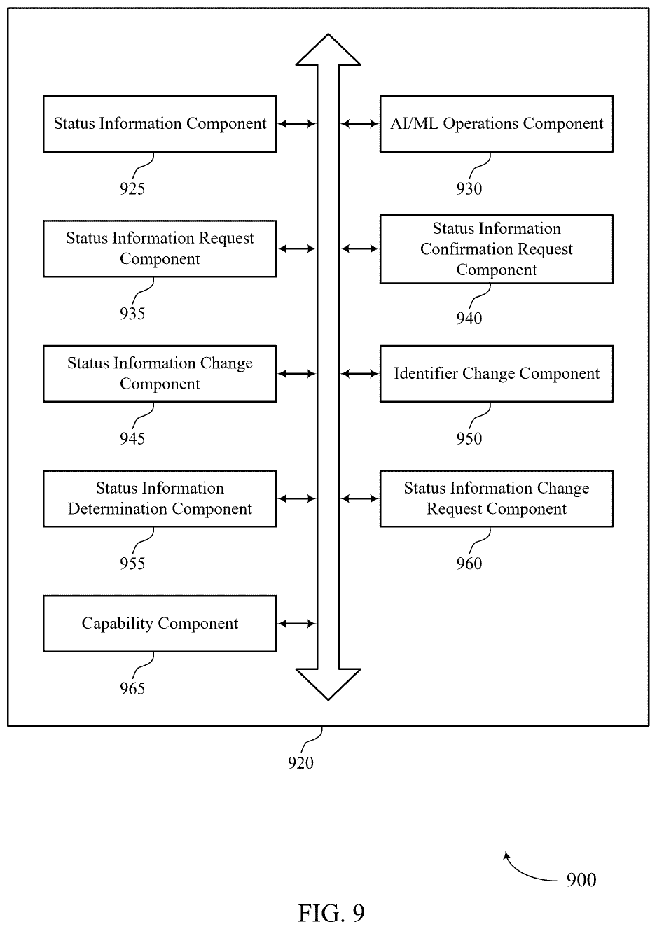

FIG. 9 shows a block diagram 900 of a communications manager 920 that supports status information for identifiers related to AI/ML in accordance with one or more aspects of the present disclosure. The communications manager 920 may be an example of aspects of a communications manager 720, a communications manager 820, or both, as described herein. The communications manager 920, or various components thereof, may be an example of means for performing various aspects of status information for identifiers related to AI/ML as described herein. For example, the communications manager 920 may include a status information component 925, an AI/ML operations component 930, a status information request component 935, a status information confirmation request component 940, a status information change component 945, an identifier change component 950, a status information determination component 955, a status information change request component 960, a capability component 965, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The status information component 925 is capable of, configured to, or operable to support a means for obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The AI/ML operations component 930 is capable of, configured to, or operable to support a means for performing an operation to control the AI/ML-based positioning or sensing procedure based on the status information corresponding to the one or more identifiers.

In some examples, the status information request component 935 is capable of, configured to, or operable to support a means for outputting, to the network entity, a request for the status information corresponding to the one or more identifiers that are associated with the one or more network settings, where the status information is obtained based on the request.

In some examples, the status information confirmation request component 940 is capable of, configured to, or operable to support a means for outputting, to the network entity, a request to confirm the status information corresponding to the one or more identifiers that are associated with the one or more network settings, where the operation to control the AI/ML-based positioning or sensing procedure is based on the request.

In some examples, to support obtaining the status information, the status information component 925 is capable of, configured to, or operable to support a means for obtaining, from the network entity, the status information based on a request from the wireless device, via a position protocol message, via a sensing protocol message, or a combination thereof.

In some examples, the status information change component 945 is capable of, configured to, or operable to support a means for obtaining, from the network entity, an indication of a change to the status information corresponding to the one or more identifiers that are associated with the one or more network settings.

In some examples, the indication of the change to the status information includes an indication of a change from an active status, a pause status, an inactive status, a canceled status, an aborted status, or any combination thereof, to a different status.

In some examples, the identifier change component 950 is capable of, configured to, or operable to support a means for obtaining, from the network entity, an indication of a change to at least one identifier of the one or more identifiers that are associated with the one or more network settings.

In some examples, the change to the at least one identifier includes an update to the at least one identifier, a replacement to the at least one identifier, or a combination thereof.

In some examples, to support obtaining the status information, the status information component 925 is capable of, configured to, or operable to support a means for obtaining, from the network entity, one or more timing characteristics corresponding to the one or more identifiers that are associated with the one or more network settings, where the status information includes the one or more timing characteristics.

In some examples, the one or more timing characteristics of a respective identifier includes an indication of a status timer, a status start time, a status stop time, a status start date, a status stop date, or any combination thereof.

In some examples, to support obtaining the status information, the status information component 925 is capable of, configured to, or operable to support a means for obtaining, from the network entity, one or more status characteristics corresponding to the one or more identifiers that are associated with the one or more network settings, where the status information includes the one or more status characteristics, and where the one or more status characteristics include a valid status, an invalid status, an active status, a pause status, an inactive status, an expired status, an aborted status, a canceled status, or any combination thereof.

In some examples, the status information confirmation request component 940 is capable of, configured to, or operable to support a means for outputting, to the network entity and in response to an expiration of a timing validity timer of at least one identifier of the one or more identifiers, a request to confirm the status information of the at least one identifier.

In some examples, the status information determination component 955 is capable of, configured to, or operable to support a means for determining that the status information of a respective identifier of the one or more identifiers indicates that the respective identifier is valid based on a status characteristic of the respective identifier, a timing characteristic of the respective identifier, or an absence of an indication from the network entity associated with the status information of the respective identifier.

In some examples, the status information change request component 960 is capable of, configured to, or operable to support a means for outputting, to the network entity, a request for the network entity to change the status information of a respective identifier of the one or more identifiers corresponding to the one or more identifiers that are associated with the one or more network settings.

In some examples, the capability component 965 is capable of, configured to, or operable to support a means for outputting, to the network entity, a capability message indicating a capability of the wireless device to obtain the status information corresponding to the one or more identifiers that are associated with the one or more network settings, where the status information is obtained based on output of the capability message.

In some examples, the operation to control the AI/ML-based positioning or sensing procedure includes an activation of an AI/ML model, a selection of an AI/ML model, switching an AI/ML model, a deactivation of an AI/ML model, switching to a non-AI/ML-based positioning or sensing procedure, or any combination thereof based on the status information corresponding to the one or more identifiers.

In some examples, the status information of a first identifier of the one or more identifiers is based on the status information of a second identifier of the one or more identifiers based on a relation between the first identifier and the second identifier.

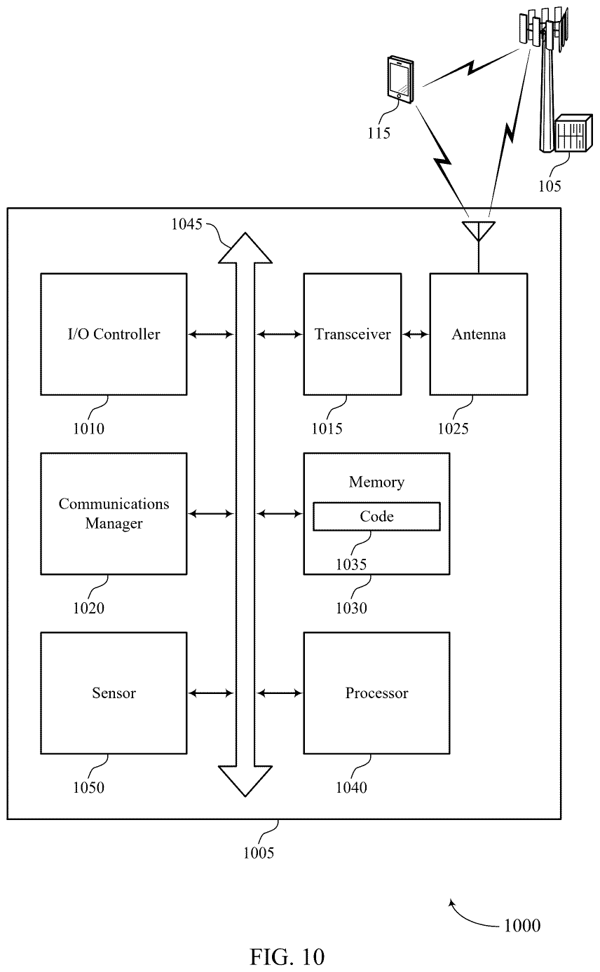

FIG. 10 shows a diagram of a system 1000 including a device 1005 that supports status information for identifiers related to AI/ML in accordance with one or more aspects of the present disclosure. The device 1005 may be an example of or include components of a device 705, a device 805, or a wireless device as described herein. The device 1005 may include components for bi-directional voice and data communications including components for transmitting and receiving communications, such as a communications manager 1020, an I/O controller, such as an I/O controller 1010, one or more transceivers 1015, one or more antennas 1025, at least one memory 1030, code 1035, and at least one processor 1040. The device 1005 may include one or more sensors 1050. These components may be in electronic communication or otherwise coupled (e.g., operatively, communicatively, functionally, electronically, electrically) via one or more buses (e.g., a bus 1045). The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver(s) 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The one or more transceivers 1015 may include one or more wireless wide area network (WWAN) transceivers, one or more short-range wireless transceivers, or one or more satellite transceivers. The WWAN transceiver(s) may communicate with (e.g., transmit one or more signals to, or receive one or more signals from) one or more wireless communication networks, such as an NR network, an LTE network, or a GSM network, among other examples. The WWAN transceiver(s) may be connected to one or more of the antenna(s) 1025 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1025 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), or ultra-wideband (UWB), among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVE® transceivers, NFC transceivers, UWB transceivers, vehicle-to-vehicle (V2V) transceivers, or vehicle-to-everything (V2X) transceivers, among other examples.

The satellite transceiver(s) may include one or more satellite signal receivers, or one or more satellite signal transmitters. In some cases, the device 1005 may be a terrestrial device that may communicate one or more satellites via the satellite transceiver(s). In other cases, device 1005 may be a satellite (or other non-terrestrial entity) that uses the satellite transceiver(s) to communicate with one or more terrestrial networks or other satellites.

The satellite signal receiver(s) may be connected to one or more of the antenna(s) 1025 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, Indian Regional Navigation Satellite System (NAVIC), or Quasi-Zenith Satellite System (QZSS) signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1040 may perform calculations to determine a location of the device 1005, the UE 115, the network node 105, or another device using measurements obtained from one or more satellite signals.

The one or more satellite signal transmitters may be connected to one or more of the antennas 1025 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The device 1005 may include one or more sensors 1050 coupled with the one or more processors 1040 for obtaining sensor data (e.g., image data, RF data, motion data, orientation data, or audio data, among other examples). For example, the one or more sensors 1050 may sense or detect movement or orientation information. In some aspects, the movement or orientation information may be independent from motion data derived from signals received by the one or more WWAN transceivers, the one or more short-range wireless transceivers, or the satellite signal interface. In some examples, the sensor(s) 1050 may include an accelerometer (e.g., a micro-electrical mechanical systems (MEMS) device), a gyroscope, a geomagnetic sensor (e.g., a compass), an altimeter (e.g., a barometric pressure altimeter), or any other type of movement detection sensor. Additionally, or alternatively, the one or more sensors 1050 may include an image sensor, camera, microphone, light detector, or pressure sensor, among other examples. In some aspects, the sensor(s) 1050 may include a plurality of different types of devices, and the device 1005 (e.g., sensor(s) 1050 or processor(s) 1040) may combine the outputs of the different types of devices to provide motion information. For example, the sensor(s) 1050 may use a combination of a multi-axis accelerometer sensors, orientation sensors, or image sensors to provide the ability to compute positions in two-dimensional (2D) or three-dimensional (3D) coordinate systems.

The at least one memory 1030 may include RAM and ROM. The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a BIOS which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting status information for identifiers related to AI/ML). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The communications manager 1020 is capable of, configured to, or operable to support a means for performing an operation to control the AI/ML-based positioning or sensing procedure based on the status information corresponding to the one or more identifiers.

By including or configuring the communications manager 1020 in accordance with examples as described herein, the device 1005 may support techniques for a wireless device to obtain status information for one or more identifiers to enhance the control and performance of AI/ML-based positioning or sensing procedures to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of status information for identifiers related to AI/ML as described herein, or the at least one processor 1040 and the at least one memory 1030 may be otherwise configured to, individually or collectively, perform or support such operations.

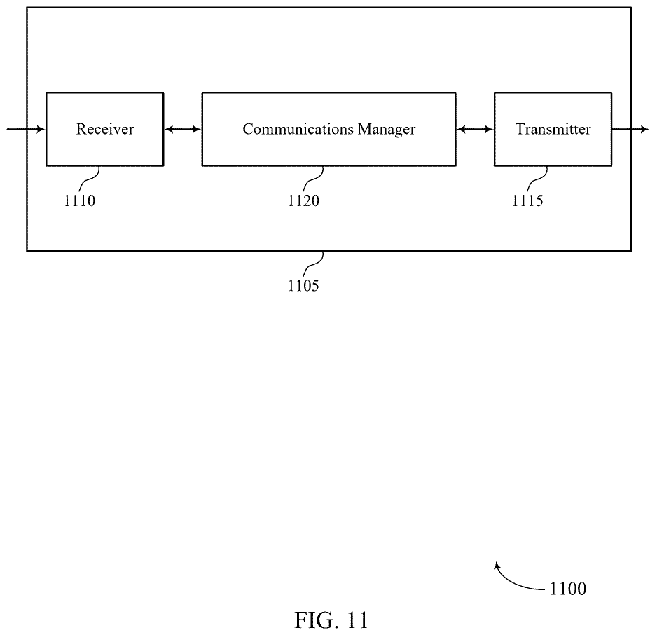

FIG. 11 shows a block diagram 1100 of a device 1105 that supports status information for identifiers related to AI/ML in accordance with one or more aspects of the present disclosure. The device 1105 may be an example of aspects of a network entity as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of status information for identifiers related to AI/ML as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The communications manager 1120 is capable of, configured to, or operable to support a means for communicating with the wireless device based on the one or more network settings.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for a wireless device to obtain status information for one or more identifiers to enhance the control and performance of AI/ML-based positioning or sensing procedures to support reduced processing, reduced power consumption, and more efficient utilization of communication resources.

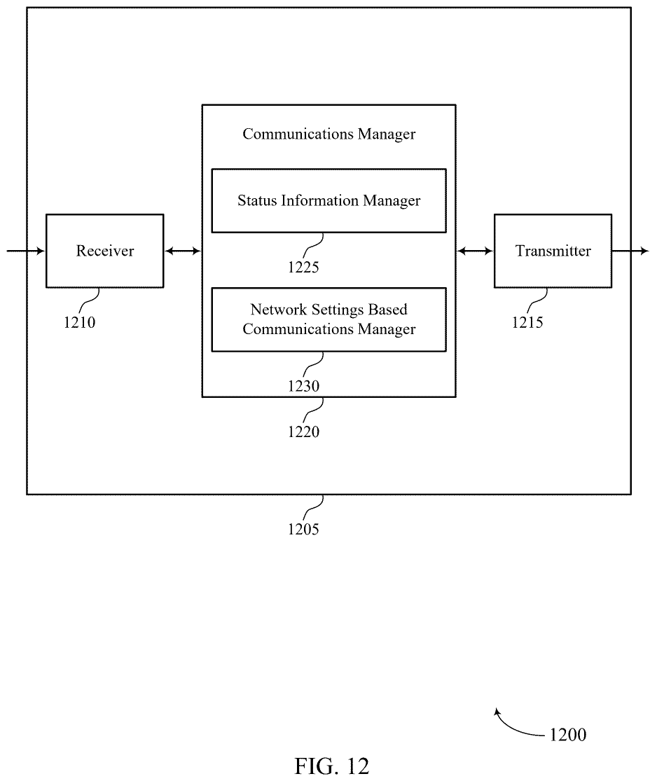

FIG. 12 shows a block diagram 1200 of a device 1205 that supports status information for identifiers related to AI/ML in accordance with one or more aspects of the present disclosure. The device 1205 may be an example of aspects of a device 1105 or a network entity as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of status information for identifiers related to AI/ML as described herein. For example, the communications manager 1220 may include a status information manager 1225 a network settings based communications manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The status information manager 1225 is capable of, configured to, or operable to support a means for outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The network settings based communications manager 1230 is capable of, configured to, or operable to support a means for communicating with the wireless device based on the one or more network settings.

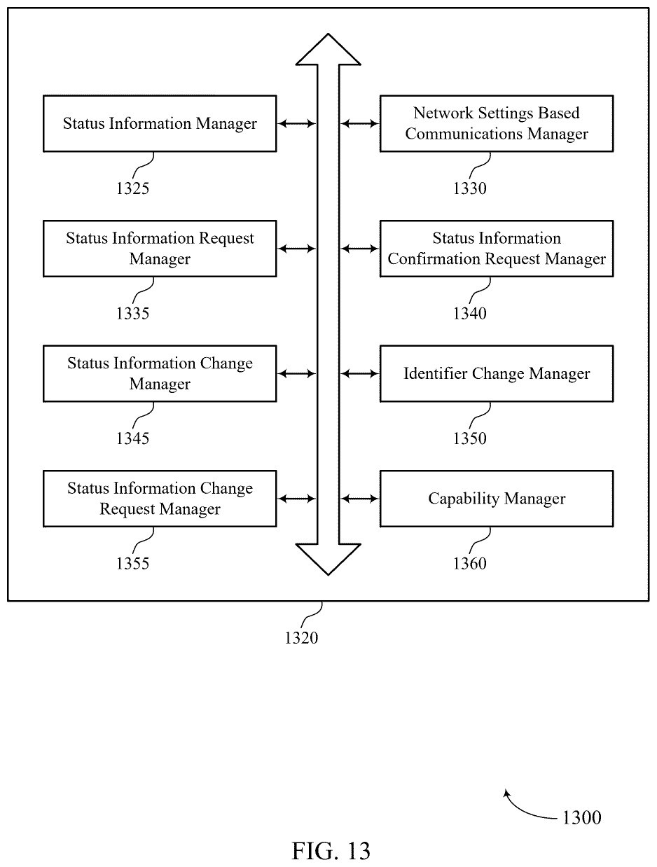

FIG. 13 shows a block diagram 1300 of a communications manager 1320 that supports status information for identifiers related to AI/ML in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of status information for identifiers related to AI/ML as described herein. For example, the communications manager 1320 may include a status information manager 1325, a network settings based communications manager 1330, a status information request manager 1335, a status information confirmation request manager 1340, a status information change manager 1345, an identifier change manager 1350, a status information change request manager 1355, a capability manager 1360, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity, between devices, components, or virtualized components associated with a network entity), or any combination thereof.

The communications manager 1320 may support wireless communications in accordance with examples as disclosed herein. The status information manager 1325 is capable of, configured to, or operable to support a means for outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The network settings based communications manager 1330 is capable of, configured to, or operable to support a means for communicating with the wireless device based on the one or more network settings.

In some examples, the status information request manager 1335 is capable of, configured to, or operable to support a means for obtaining, from the wireless device, a request for the status information corresponding to the one or more identifiers that are associated with the one or more network settings, where the status information is output based on the request.

In some examples, the status information confirmation request manager 1340 is capable of, configured to, or operable to support a means for obtaining, from the wireless device, a request to confirm the status information corresponding to the one or more identifiers that are associated with the one or more network settings.

In some examples, to support outputting the status information, the status information manager 1325 is capable of, configured to, or operable to support a means for outputting, to the wireless device, the status information based on a request from the wireless device, via a position protocol message, via a sensing protocol message, or a combination thereof.

In some examples, the status information change manager 1345 is capable of, configured to, or operable to support a means for outputting, to the wireless device, an indication of a change to the status information corresponding to the one or more identifiers that are associated with the one or more network settings.

In some examples, the indication of the change to the status information includes an indication of a change from an active status, a pause status, an inactive status, a canceled status, an aborted status, or any combination thereof, to a different status.

In some examples, the identifier change manager 1350 is capable of, configured to, or operable to support a means for outputting, to the wireless device, an indication of a change to at least one identifier of the one or more identifiers that are associated with the one or more network settings.

In some examples, the change to the at least one identifier includes an update to the at least one identifier, a replacement to the at least one identifier, or a combination thereof.

In some examples, to support outputting the status information, the status information manager 1325 is capable of, configured to, or operable to support a means for outputting, to the wireless device, one or more timing characteristics corresponding to the one or more identifiers that are associated with the one or more network settings, where the status information includes the one or more timing characteristics.

In some examples, the one or more timing characteristics of a respective identifier includes an indication of a status timer, a status start time, a status stop time, a status start date, a status stop date, or any combination thereof.

In some examples, to support outputting the status information, the status information manager 1325 is capable of, configured to, or operable to support a means for outputting, to the wireless device, one or more status characteristics corresponding to the one or more identifiers that are associated with the one or more network settings, where the status information includes the one or more status characteristics, and where the one or more status characteristics include a valid status, an invalid status, an active status, a pause status, an inactive status, an expired status, an aborted status, a canceled status, or any combination thereof.

In some examples, the status information confirmation request manager 1340 is capable of, configured to, or operable to support a means for obtaining, from the wireless device and in response to an expiration of a timing validity timer of at least one identifier of the one or more identifiers, a request to confirm the status information of the at least one identifier.

In some examples, the status information change request manager 1355 is capable of, configured to, or operable to support a means for obtaining, from the wireless device, a request for the network entity to change the status information of a respective identifier of the one or more identifiers corresponding to the one or more identifiers that are associated with the one or more network settings.

In some examples, the capability manager 1360 is capable of, configured to, or operable to support a means for obtaining, from the wireless device, a capability message indicating a capability of the wireless device to obtain the status information corresponding to the one or more identifiers that are associated with the one or more network settings, where output of the status information is based on obtaining the capability message.

In some examples, the status information of a first identifier of the one or more identifiers is based on the status information of a second identifier of the one or more identifiers based on a relation between the first identifier and the second identifier.

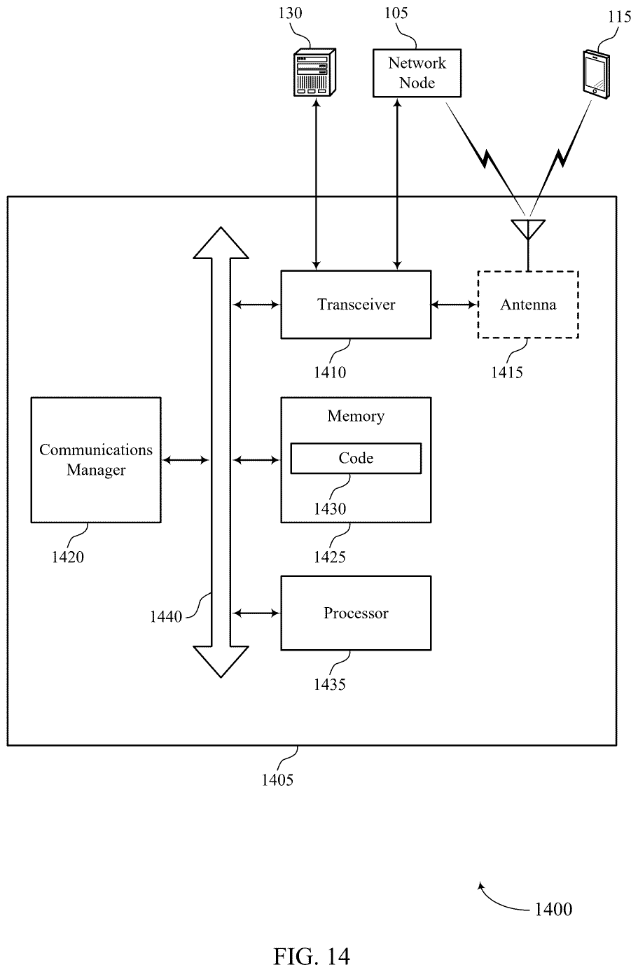

FIG. 14 shows a diagram of a system 1400 including a device 1405 that supports status information for identifiers related to AI/ML in accordance with one or more aspects of the present disclosure. The device 1405 may be an example of or include components of a device 1105, a device 1205, or a network entity 405 as described herein. The device 1405 may include components for bi-directional voice and data communications including components for transmitting and receiving communications, such as a communications manager 1420, one or more transceivers 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The one or more transceivers 1410 may include one or more WWAN transceivers, one or more short-range wireless transceivers, or one or more satellite transceivers. The WWAN transceiver(s) may communicate with (e.g., transmit one or more signals to, or receive one or more signals from) one or more wireless devices, such as the network node 105 or the UE 115, among other examples. The WWAN transceiver(s) may be connected to one or more of the antenna(s) 1415 for communicating with other devices, such as one or more UEs 115, network nodes 105, access points, base stations (e.g., eNBs, gNBs), or another device(s), via at least one RAT (e.g., NR, LTE, or GSM, among other examples) over a wireless communication medium (e.g., time or frequency resources of a frequency spectrum). The WWAN transceiver(s) may be configured for transmitting and encoding signals (e.g., messages, indications, or information, among other examples) or for receiving and decoding signals (e.g., messages, indications, information, or pilots, among other examples), in accordance with the RAT. For instance, the WWAN transceiver(s) may include one or more transmitters for transmitting and encoding signals, or one or more receivers for receiving and decoding signals.

The short-range wireless transceivers may be connected to one or more of the antenna(s) 1415 to communicate with (e.g., transmit one or more signals to, or receive one or more signals from) one or more network entities, such as one or more UEs 115, network nodes 105, access points, base stations, or another device(s), via at least one RAT (e.g., Wi-Fi, LTE Direct, BLUETOOTH®, ZIGBEE®, Z-WAVE®, PC5, DSRC, WAVE, NFC, or UWB, among other examples) over a wireless communication medium. The short-range wireless transceiver(s) may be configured for transmitting and encoding signals (e.g., messages, indications, or information, among other examples), or for receiving and decoding signals (e.g., messages, indications, information, or pilots, among other examples), in accordance with the RAT. For instance, the short-range wireless transceiver(s) may include one or more transmitters for transmitting and encoding signals, or one or more receivers for receiving and decoding signals. In some examples, the short-range wireless transceiver(s) may be one or more Wi-Fi transceivers, BLUETOOTH® transceivers, ZIGBEE® transceivers, Z-WAVER transceivers, NFC transceivers, UWB transceivers, V2V transceivers, or V2X transceivers, among other examples.

The satellite transceiver(s) may include one or more satellite signal receivers, or one or more satellite signal transmitters. In some cases, the device 1405 may be a terrestrial device that may communicate one or more satellites via the satellite transceiver(s). In other cases, device 1405 may be a satellite (or other non-terrestrial entity) that uses the satellite transceiver(s) to communicate with one or more terrestrial networks or other satellites.

The satellite signal receiver(s) may be connected to one or more of the antenna(s) 1415 for receiving or measuring satellite positioning or communication signals. In some examples, the satellite signal receiver(s) may include one or more satellite positioning system receivers, where the satellite positioning or communication signals may be GPS signals, GLONASS signals, Galileo signals, BeiDou signals, NAVIC, or QZSS signals, among other examples. In some examples, the satellite signal receiver(s) may include one or more NTN receivers, where the satellite positioning or communication signals may be communication signals (e.g., carrying control or user data) originating from a device or network. The satellite signal receiver(s) may include hardware or a combination of hardware and instructions for receiving and processing satellite positioning or communication signals. The satellite signal receiver(s) or the processor 1435 may perform calculations to determine a location of the device 1405, the UE 115, the network node 105, or another device using measurements obtained from one or more satellite signals.

The one or more satellite signal transmitters may be connected to one or more of the antennas 1415 for transmitting satellite positioning communication signals. In some examples, the satellite signal transmitter(s) may be satellite positioning system transmitters, and the satellite positioning or communication signals may be GPS signals, GLONASS® signals, Galileo signals, BeiDou signals, NAVIC, or QZSS signals, among other examples. In some examples, the satellite signal transmitter(s) include one or more NTN transmitters, and the satellite positioning or communication signals may be communication signals (e.g., carrying control or user data). The satellite signal transmitter(s) may comprise hardware or a combination of hardware and instructions for transmitting satellite positioning or communication signals.

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting status information for identifiers related to AI/ML). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network nodes 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network nodes 105.

The communications manager 1420 may support wireless communications in accordance with examples as disclosed herein. For example, the communications manager 1420 is capable of, configured to, or operable to support a means for outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The communications manager 1420 is capable of, configured to, or operable to support a means for communicating with the wireless device based on the one or more network settings.

By including or configuring the communications manager 1420 in accordance with examples as described herein, the device 1405 may support techniques for a wireless device to obtain status information for one or more identifiers to enhance the control and performance of AI/ML-based positioning or sensing procedures to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of status information for identifiers related to AI/ML as described herein, or the at least one processor 1435 and the at least one memory 1425 may be otherwise configured to, individually or collectively, perform or support such operations.

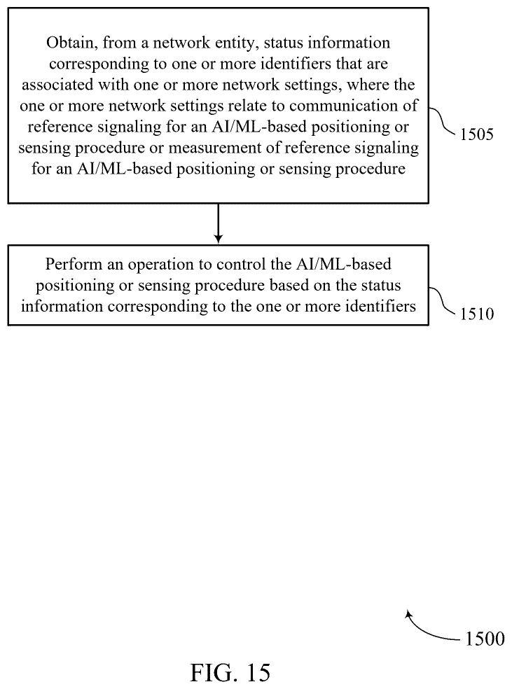

FIG. 15 shows a flowchart illustrating a method 1500 that supports status information for identifiers related to AI/ML in accordance with one or more aspects of the present disclosure. The operations of the method 1500 may be implemented by a wireless device or its components as described herein. For example, the operations of the method 1500 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1505, the method may include obtaining, from a network entity, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The operations of 1505 may be performed in accordance with examples as disclosed herein. In some examples, aspects of the operations of 1505 may be performed by a status information component 925 as described with reference to FIG. 9.

At 1510, the method may include performing an operation to control the AI/ML-based positioning or sensing procedure based on the status information corresponding to the one or more identifiers. The operations of 1510 may be performed in accordance with examples as disclosed herein. In some examples, aspects of the operations of 1510 may be performed by an AI/ML operations component 930 as described with reference to FIG. 9.

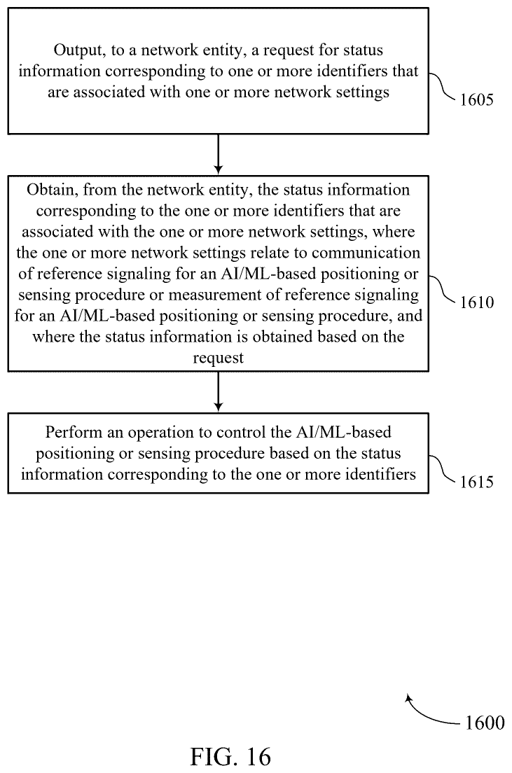

FIG. 16 shows a flowchart illustrating a method 1600 that supports status information for identifiers related to AI/ML in accordance with one or more aspects of the present disclosure. The operations of the method 1600 may be implemented by a wireless device or its components as described herein. For example, the operations of the method 1600 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1605, the method may include outputting, to a network entity, a request for status information corresponding to one or more identifiers that are associated with one or more network settings. The operations of 1605 may be performed in accordance with examples as disclosed herein. In some examples, aspects of the operations of 1605 may be performed by a status information request component 935 as described with reference to FIG. 9.

At 1610, the method may include obtaining, from the network entity, the status information corresponding to the one or more identifiers that are associated with the one or more network settings, where the one or more network settings relate to communication of reference signaling for an AI/ML-based positioning or sensing procedure or measurement of reference signaling for an AI/ML-based positioning or sensing procedure, and where the status information is obtained based on the request. The operations of 1610 may be performed in accordance with examples as disclosed herein. In some examples, aspects of the operations of 1610 may be performed by a status information component 925 as described with reference to FIG. 9.

At 1615, the method may include performing an operation to control the AI/ML-based positioning or sensing procedure based on the status information corresponding to the one or more identifiers. The operations of 1615 may be performed in accordance with examples as disclosed herein. In some examples, aspects of the operations of 1615 may be performed by an AI/ML operations component 930 as described with reference to FIG. 9.

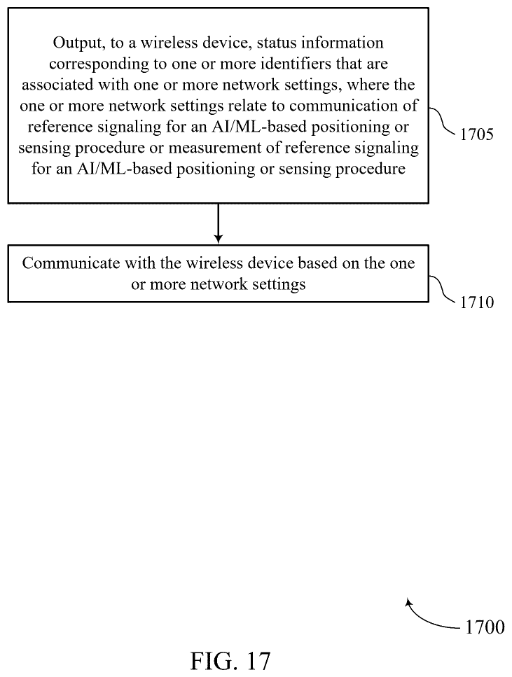

FIG. 17 shows a flowchart illustrating a method 1700 that supports status information for identifiers related to AI/ML in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a wireless device, status information corresponding to one or more identifiers that are associated with one or more network settings, where the one or more network settings relate to communication of reference signaling for an AI/ML-based positioning or sensing procedure or measurement of reference signaling for an AI/ML-based positioning or sensing procedure. The operations of 1705 may be performed in accordance with examples as disclosed herein. In some examples, aspects of the operations of 1705 may be performed by a status information manager 1325 as described with reference to FIG. 13.

At 1710, the method may include communicating with the wireless device based on the one or more network settings. The operations of 1710 may be performed in accordance with examples as disclosed herein. In some examples, aspects of the operations of 1710 may be performed by a network settings based communications manager 1330 as described with reference to FIG. 13.

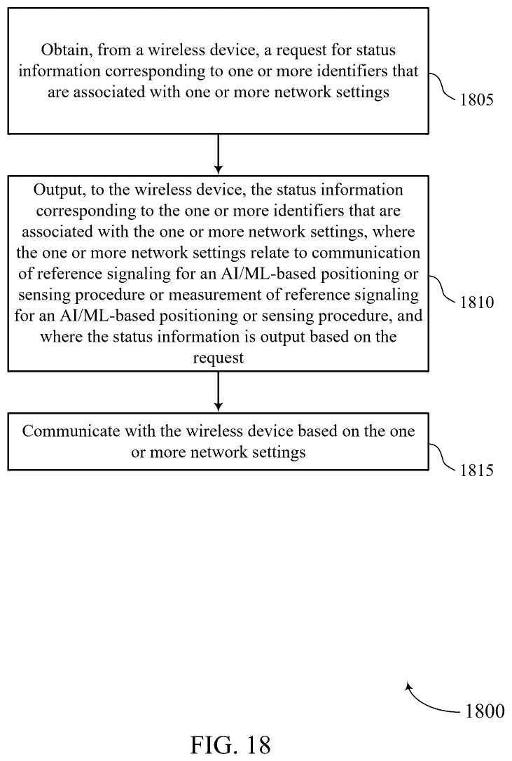

FIG. 18 shows a flowchart illustrating a method 1800 that supports status information for identifiers related to AI/ML in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include obtaining, from a wireless device, a request for status information corresponding to one or more identifiers that are associated with one or more network settings. The operations of 1805 may be performed in accordance with examples as disclosed herein. In some examples, aspects of the operations of 1805 may be performed by a status information request manager 1335 as described with reference to FIG. 13.

At 1810, the method may include outputting, to the wireless device, the status information corresponding to the one or more identifiers that are associated with the one or more network settings, where the one or more network settings relate to communication of reference signaling for an AI/ML-based positioning or sensing procedure or measurement of reference signaling for an AI/ML-based positioning or sensing procedure, and where the status information is output based on the request. The operations of 1810 may be performed in accordance with examples as disclosed herein. In some examples, aspects of the operations of 1810 may be performed by a status information manager 1325 as described with reference to FIG. 13.

At 1815, the method may include communicating with the wireless device based on the one or more network settings. The operations of 1815 may be performed in accordance with examples as disclosed herein. In some examples, aspects of the operations of 1815 may be performed by a network settings based communications manager 1330 as described with reference to FIG. 13.

FIG. 19 shows examples of wireless communications systems 1900 that supports status information for identifiers related to AI/ML in accordance with one or more aspects of the present disclosure. Various positioning techniques are illustrated in the context of the wireless communications systems 1900. Some examples of the positioning procedures described herein may be performed in accordance with one or more aspects of the positioning techniques. While TRPs and UEs are provided in the examples illustrated in FIG. 19, other devices (e.g., network entities, base stations, RRHs, RUs, APs, wireless devices, or stations, among other examples) may be similarly utilized in other examples. The examples of positioning techniques include downlink-based positioning techniques, uplink-based positioning techniques, and downlink-and-uplink-based positioning techniques.

Examples of OTDOA or DL-TDOA 1905 are illustrated in FIG. 19. One or more of the OTDOA or DL-TDOA 1905 positioning techniques may be included in a downlink-based positioning procedure. In OTDOA or DL-TDOA 1905 positioning techniques, a UE may measure a difference between TOAs of reference signals (e.g., PRSs) received from one or more pairs of TRPs (e.g., TRP2 and TRP3). In some approaches, a difference in TOAs may be referred to as an RSTD or a TDOA measurement. A positioning device (e.g., the UE, a location server, an LMF, an SLP, or another device) may utilize the differences in TOAs to determine (e.g., estimate) a location of the UE.

In some aspects, the UE may receive an identifier (ID) associated with a reference TRP (e.g., a serving base station) and one or more IDs associated with one or more non-reference TRPs in received data (e.g., assistance data). The UE may measure the difference of TOAs between the reference TRP and each of the non-reference TRPs to produce RSTDs or TDOAs. In some aspects, the UE may report an indication of the RSTDs or TDOAs to the positioning device (e.g., a location server, LMF, an SLP, or another device). Based on established locations of the base stations and the RSTD measurements, the positioning device (e.g., the UE for UE-based positioning or a location server for UE-assisted positioning) may estimate the UE's location.

An example of UL-TDOA 1910 is illustrated in FIG. 19. One or more of the UL-TDOA 1910 positioning techniques may be included in an uplink-based positioning procedure. UL-TDOA 1910 may have some similarities to DL-TDOA 1905. The UL-TDOA 1910 positioning techniques may be based on uplink reference signals (e.g., SRS) transmitted from the UE to multiple TRPs. For example, the UE transmits one or more uplink reference signals that are measured by a reference TRP (e.g., TRP3) and non-reference TRPs (e.g., TRP1 and TRP2). Each TRP then reports the reception time (which may be referred to as a relative time of arrival (RTOA)) of the reference signal(s) to a positioning device (e.g., a location server, LMF, SLP, or UE) that has information about the locations and relative timing of the TRPs. Based on the reception-to-reception (Rx-Rx) time differences between the reported RTOA of the reference TRP and the reported RTOA of each non-reference TRP, the locations of the TRPs, and the corresponding timing offsets, the positioning device may estimate the location of the UE using TDOA.

An example of DL-AOD 1915 is illustrated in FIG. 19. One or more of the DL-AOD 1915 positioning techniques may be included in a downlink-based positioning procedure. In DL-AOD 1915, a UE may obtain received signal strength measurements corresponding to multiple downlink transmit beams for one or more TRPs (e.g., TRP1 and TRP2). In some approaches, the UE reports the measurements to a positioning device. The positioning device may use the signal strength measurements of the multiple downlink transmit beams to determine the angle(s) (e.g., AOD1 and AOD2) between the UE and the transmitting TRP(s). The positioning device (e.g., location server, LMF, SLP, UE, or another device) may estimate the location of the UE based on the determined angle(s) and the established location(s) of the transmitting TRP(s).

An example of UL-AOA 1920 is illustrated in FIG. 19. One or more of the UL-AOA 1920 positioning techniques may be included in an uplink positioning procedure. In UL-AOA 1920, one or more TRPs (e.g., TRP1 and TRP2) measure the received signal strength of one or more uplink reference signals (e.g., SRSs) received from a UE on one or more uplink receive beams. In some aspects, the signal strength measurements may be reported to a positioning device. A positioning device (e.g., LFM, SLP, UE, or another device) may use the signal strength measurements and the angle(s) of the receive beam(s) to determine the angle(s) between the UE and the TRP(s). Based on the determined angle(s) and the established location(s) of the TRP(s), the positioning device may estimate the location of the UE.

Some positioning techniques or procedures may include a combination downlink-based and uplink-based positioning techniques. Examples of downlink-based and uplink-based positioning techniques may include E-CID positioning and mRTT positioning (which may be referred to as “multi-RTT” or “multi-cell RTT” when multiple cells are utilized).

In multi-RTT, a first device (e.g., a TRP or UE) may transmit a first RTT-related signal (e.g., a PRS or SRS) to a second device (e.g., the UE or TRP). The second device may transmit a second RTT-related signal (e.g., an SRS or PRS) back to the first device. Each device may measure a time difference between the TOA of the received RTT-related signal and the transmission time of the transmitted RTT-related signal. The time difference may be referred to as a reception-to-transmission (Rx-Tx) time difference. In some aspects, the Rx-Tx time difference measurement may be obtained or adjusted to include (e.g., include only) a time difference between nearest slot boundaries for the received and transmitted signals. The first device or the second device may send the corresponding Rx-Tx time difference measurements to a positioning device (e.g., a location server, LMF, SLP, UE, or other device), which may calculate a round trip propagation time (or RTT) between the two device based on the two Rx-Tx time difference measurements (e.g., as a sum of the two Rx-Tx time difference measurements). Additionally, or alternatively, one device may send a corresponding Rx-Tx time difference measurement to the other device, which may calculate the RTT. The distance between the two devices may be determined from the RTT and a signal speed (e.g., the speed of light).

An example of multi-cell RTT 1925 is illustrated in FIG. 19. One or more of the multi-RTT or multi-cell RTT techniques described may be included in an uplink-based or downlink-based positioning procedure. In multi-cell RTT 1925, a first device (e.g., a UE or TRP) may perform an RTT positioning procedure with multiple second devices (e.g., multiple TRPs or UEs) to enable the location of the first device to be determined (e.g., using multilateration) based on distances to, and the established locations of, the second devices.

In some examples, RTT or multi-RTT techniques may be combined with one or more other positioning techniques (e.g., UL-AOA, DL-AOD, or other positioning techniques), to enhance location accuracy. Examples of combined DL-AOD and RTT 1930 positioning techniques are illustrated in FIG. 19.

E-CID positioning techniques may be based on radio resource management (RRM) measurements. In E-CID, a UE may obtain or report a serving cell ID, a timing advance (TA), identifiers of one or more detected neighbor TRPs, estimated timing of one or more detected neighbor TRPs, or a signal strength measurement of one or more detected neighbor TRPs. A positioning device (e.g., an LFM, SLP, UE, or another device) may utilize the serving cell ID, TA, identifiers, estimated timing, or signal strength measurements with one or more established locations of one or more TRPs to estimate the location of the UE.

In some approaches, a positioning device (e.g., location server, LMF, SLP, or another device) may provide assistance data to the UE. Assistance data is data to assist with one or more positioning operations (e.g., to detect one or more neighboring TRPs or to receive reference signaling). For instance, the assistance data may indicate IDs of the TRPs (e.g., IDs of one or more cells or TRPs corresponding to a network node) from which reference signals may be measured. In some examples, a positioning device may transmit assistance data or other information indicating one or more reference signal configuration parameters. The reference signal configuration parameter(s) may include or indicate a quantity of consecutive slots including PRS, a periodicity of consecutive slots including PRS, a muting sequence, a frequency hopping sequence, a reference signal identifier, a reference signal bandwidth, or one or more other parameters applicable to a positioning technique or procedure. Additionally, or alternatively, the assistance data may be sent from one or more TRPs (e.g., in periodically broadcasted overhead messages, a scheduled message, a unicast message, or a multicast message, among other examples). In some examples, a UE may be able to detect one or more neighboring TRPs (e.g., network entities) without the use of assistance data.

For OTDOA positioning techniques or DL-TDOA positioning techniques, the assistance data may indicate an expected RSTD value and an associated uncertainty or search window around the expected RSTD. For example, an expected RSTD value may have an associated uncertainty or search window with a range of ±500 microseconds (μs). In another example, when any of the resources used for the positioning measurement(s) are in frequency range 1 (FR1), an expected RSTD value may have an associated uncertainty or search window with a range of ±32 μs. In another example, when all of the resources used for the positioning measurement(s) are in frequency range 2 (FR2), an expected RSTD value may have an associated uncertainty or search window with a range of ±8 μs.

In some examples, a location may be referred to as a position estimate, location estimate, position, position fix, or fix, among other examples. A location may be geodetic and include coordinates (e.g., latitude, longitude, or altitude) or may be civic and include a street address, postal address, or another description of a location. In some aspects, a location may be defined relative to another location or may be defined in absolute terms (e.g., latitude, longitude, or altitude). A location may include an indication of error or uncertainty (e.g., by including an area or volume within which the location may be included with a specified or default level of confidence).

Various examples of sidelink positioning techniques are illustrated in FIG. 19. Sidelink positioning techniques may include positioning techniques that are based on sidelink communication (e.g., based exclusively on sidelink communication or based on sidelink communication jointly with other communication(s), such as Uu interface communication).

A first example of sidelink positioning 1935 is illustrated in FIG. 19. In the first example of sidelink positioning 1935, at least one peer UE with an established location may improve location estimation (e.g., Uu-based positioning, multi-cell RTT, DL-TDOA, or UL-TDOA, among other examples) for a target UE by providing an additional anchor (e.g., sidelink RTT (SL-RTT)).

A second example of sidelink positioning 1940 is illustrated in FIG. 19. In the second example of sidelink positioning 1940, different types (e.g., categories, classes, or capabilities) of UEs may be utilized. For example, first UEs and a second UE may be utilized. Relative to the second UE, the first UEs may have one or more increased capabilities, such as one or more additional sensors, a faster processor, greater memory capacity, one or more additional antenna elements, a higher transmit power capability, access to one or more additional frequency bands, or any combination thereof. In some aspects, the second UE may be a reduced capacity or “RedCap” UE. The second UE may be assisted by the first UEs to determine the location of the second UE. For instance, sidelink-based positioning or ranging procedures may be performed with the first UEs, which may enhance the location accuracy of the second UE.

A third example of sidelink positioning 1945 is illustrated in FIG. 19. The third example of sidelink positioning 1945 may be performed via one or more sidelink connections (e.g., via sidelink connections exclusively or jointly with one or more Uu-based connections). In the third example of sidelink positioning 1945, the UEs may perform peer-to-peer (P2P) positioning or ranging. Sidelink positioning may be helpful for out-of-coverage or public safety scenarios. For instance, the UEs may be out of coverage of a network and may determine a location or a relative distance and a relative position among the UEs using sidelink positioning techniques. In some examples, sidelink positioning may be performed by UEs in public safety scenarios (e.g., for police, firefighters, search-and-rescue, or paramedics, among other examples).

A fourth example of sidelink positioning 1950 is illustrated in FIG. 19. The fourth example of sidelink positioning 1950 may be performed via one or more sidelink connections (e.g., via sidelink connections exclusively or jointly with one or more Uu-based connections). In the fourth example of sidelink positioning 1950, one or more of the UEs may determine a location or a relative distance and a relative position using sidelink positioning techniques, such as SL-RTT. For instance, one or more of the UEs may be out of coverage of a network and may determine a location or a relative distance and a relative position among the UEs using sidelink positioning techniques.

An example of relay positioning 1955 is illustrated in FIG. 19. In the example of relay positioning 1955, a relay UE (e.g., with an established location) may participate in the location estimation of a remote UE (without performing uplink reference signal transmission over the Uu interface, for instance). For example, the relay UE may receive a downlink PRS from a TRP and may relay an SL-PRS to the remote UE. In some cases, the remote UE may also receive another downlink PRS from the TRP. A positioning device (e.g., location server, LMF, SLP, UE, or other device) may utilize a downlink PRS measurement and an SL-PRS measurement with the established location of the relay UE to estimate the location of the remote UE.

An example of joint positioning 1960 is illustrated in FIG. 19. In the example of joint positioning 1960, multiple peer UEs (without established locations, for instance) may be located. In some approaches, multiple peer UEs may be jointly located in NLOS conditions by utilizing one or more constraints from one or more peer (e.g., neighboring or nearby) UEs. As illustrated in FIG. 19, RTT or TDOA techniques may be performed between TRP1 and each of the peer UEs, may be performed between TRP2 and each of the peer UEs, and may be performed between the peer UEs. In some examples, one or more of the peer UEs may report measurements from the RTT or TDOA technique(s) to a positioning device. The positioning device (e.g., location server, LMF, SLP, UE, or other device) may utilize the measurements from the RTT or TDOA technique(s) to estimate the locations of the peer UEs.

Some aspects of the techniques described herein may be performed in conjunction with one or more of the positioning techniques described with reference to FIG. 19. For instance, some of the techniques may be utilized for a wireless devices to obtain status information for identifiers associated with one or more network settings. Further, the wireless device may then perform operations to control AI/ML-based positioning or sensing procedures to improve model training, inference or predictions, performance monitoring, or data collection.

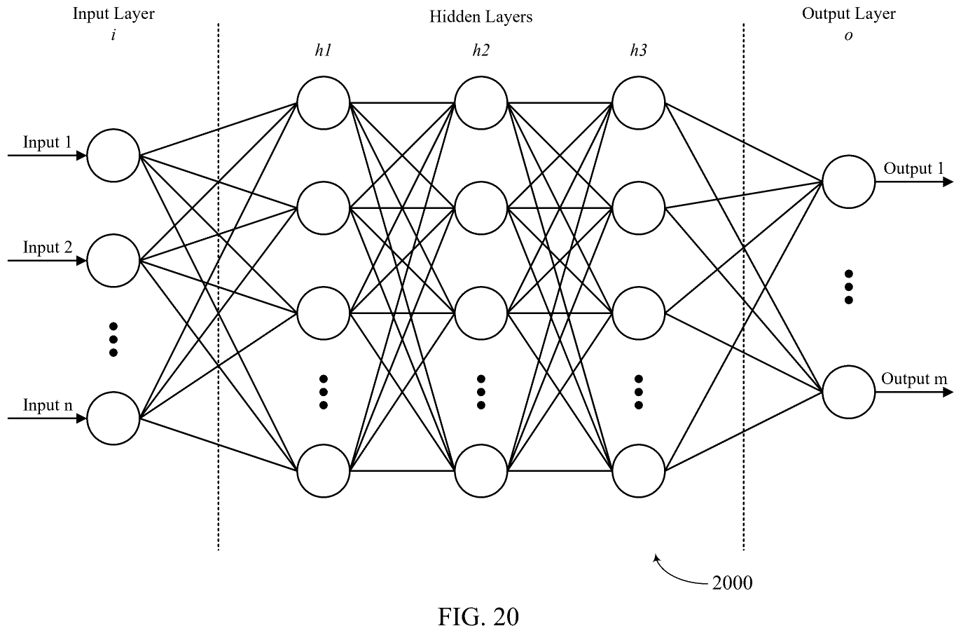

FIG. 20 shows an example of a node diagram 2000 that supports status information for identifiers related to AI/ML in accordance with one or more aspects of the present disclosure. AI models are programmatic or algorithmic structures that simulate intelligent behavior. Machine learning models may be examples of AI models. Machine learning models are programmatic or algorithmic structures that may be trained to infer or predict an output based on an input. For example, a machine learning model may be trained using training input data and ground truth data.

Machine learning models may be categorized as unsupervised or supervised. Unsupervised learning may be utilized to draw inferences and find patterns from input data without references to labeled outcomes. Two examples of unsupervised learning models include clustering and dimensionality reduction. Clustering is an unsupervised technique that involves the grouping, or clustering, of data points. Clustering techniques may include k-means clustering, hierarchical clustering, mean shift clustering, and density-based clustering. Dimensionality reduction may be a procedure for reducing a quantity of random variables under consideration by obtaining a set of principal variables. Dimensionality reduction may reduce the dimension of a feature set or reduce a quantity of features). Some dimensionality reduction techniques may be categorized as feature elimination or feature extraction. One example of dimensionality reduction may be referred to as principal component analysis (PCA). PCA may involve projecting higher dimensional data (e.g., three dimensions) to a lower-dimensional space (e.g., two dimensions), which may result in a lower dimension of data (e.g., two dimensions instead of three dimensions) while maintaining one or more variables in the model.

Supervised learning involves learning a function that maps an input to an output based on associated inputs and outputs. For instance, supervised learning may be utilized to draw inferences and find patterns from input data based on labeled data (e.g., training input data with associated ground truth data). A supervised model may sub-categorized as a regression or classification model. Regression models may provide continuous outputs. One example of a regression model is a linear regression, which may determine a line that fits (e.g., best fits) input data. Extensions of linear regression include multiple linear regression (e.g., finding a plane of best fit) and polynomial regression (e.g., finding a curve of best fit).

In classification models, the output may be discrete. One example of a classification model is logistic regression. Logistic regression may be similar to linear regression, but may be used to model a probability for a finite quantity of outcomes. For example, a logistic regression may be utilized such that the output values may be between 0 and 1. Another example of a classification model is a support vector machine. For two classes of data, for example, a support vector machine may determine a hyperplane or a boundary between the two classes of data that maximizes a margin between the two classes. For instance, many planes may separate two classes, while one plane may maximize the margin or distance between the classes. Another example of a classification model is Naïve Bayes, which is based on Bayes Theorem.

Other examples of classification models include decision tree models, random forest models, and neural network models, where an output may be discrete. In a decision tree model, a tree structure is defined with multiple nodes. Decisions may be used to move from a root node at the top of the decision tree to a leaf node (e.g., a node without a child node) at the bottom of the decision tree. A higher quantity of nodes in the decision tree model may correlate with higher decision accuracy.

Random forest models may utilize ensemble learning techniques that build from decision tree models. Random forests involve creating multiple decision trees using bootstrapped datasets of the original data and randomly selecting a subset of variables at each tier of the decision tree. The model may select the mode of all of the predictions of each decision tree. By relying on a “majority wins” model, the risk of error from an individual tree may be reduced.

Another example of a machine learning model is a neural network (NN). A neural network may be a network of functional nodes. Neural networks may utilize one or more input variables to traverse the nodes and generate one or more output variables. For example, a neural network may utilize an input vector to generate an output vector.

The AI model illustrated in FIG. 20 is an example of a neural network. The neural network includes an input layer i that receives n (one or more) inputs (illustrated as “Input 1,” “Input 2,” and “Input n”), one or more hidden layers (illustrated as hidden layers “h1,” “h2,” and “h3”) for processing the inputs from the input layer, and an output layer o that provides m (one or more) outputs (labeled “Output 1” and “Output m”). While examples of quantities of inputs n, hidden layers h, and outputs m are illustrated in FIG. 20, same or different quantities of inputs, hidden layers, or outputs may be utilized in other examples. In some approaches, the hidden layers h may include linear function(s) or activation function(s) that the nodes (illustrated as circles) of each successive hidden layer process from the nodes of the previous hidden layer.

In some aspects, the AI model illustrated in FIG. 20 or another AI model may be trained in accordance with one or more training techniques. In some examples of the training techniques described herein, one or more AI models (e.g., implemented by one or more devices) may be trained based on training input data (e.g., measurements of reference signals to or from various UEs) and ground truth data (e.g., locations of the various UEs), thereby enabling later determination of an output (e.g., an inferred or prediction location or measurement) when an AI model is executed with runtime input data (e.g., from other UEs).

Ground truth data may be data representing a target output associated with training input data. Ground truth data may be generated or observed (e.g., empirical) data. In some examples, ground truth data may indicate one or more observed locations (e.g., coordinates or addresses, among other examples) corresponding to training input data. Examples of training input data may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CIR data, PDP data, DP data, CQI data, CSI data, decoding failure rate, or retransmission request rate, among other examples), AOA data, AOD data, TDOA data, RTT data, TA data, sensor data (e.g., image data, RF data, motion data, orientation data, or audio data, among other examples), or identifier data (e.g., cell ID data or service set identifier (SSID) data, among other examples), among other examples.

In some examples, ground truth data may indicate one or more measurements or values (e.g., AOA measurements, AOD measurements, TDOA measurements, RTT measurements, LOS angle(s), or other values) corresponding to training input data. Examples of training input data may include reference signal data (e.g., measurements of a PRS, SRS, reference signal of an SSB, CSI-RS, DMRS, or TRS, among other examples), signal data (e.g., signal strength data, RSRP data, RSSI data, RSRQ data, SINR data, or SNR data, among other examples), channel data (e.g., CIR data, PDP data, DP data, CQI data, CSI data, decoding failure rate, or retransmission request rate, among other examples), TA data, sensor data (e.g., image data, RF data, motion data, orientation data, or audio data, among other examples), or identifier data (e.g., cell ID data or SSID data, among other examples), among other examples.

An AI model (e.g., the AI model illustrated in FIG. 20 or a machine learning model) may be trained by executing the AI model with the training data to produce an output, comparing the output with the ground truth data, and adjusting weights of the AI model to reduce a disparity between the output and the ground truth data. For example, one or more of the nodes or connections of the AI model may have an associated weight that may be adjusted to modify one or more of the outputs. In some approaches, a cost function may be utilized to compare the output with the ground truth data to indicate a cost (e.g., error or disparity). Adjustments to the weights that reduce the cost may be retained, advanced, or increased, while adjustments to the weights that increase the cost may be discarded, avoided, or decreased. Training procedures may be repeated or iterated to improve AI model performance.

Input data (e.g., runtime input data) may be provided to a trained AI model, which may infer or predict an output based on the input data. Some examples of AI models may be trained to infer or predict a location based on input data (e.g., reference signal data, signal data, channel data, AOA data, AOD data, TDOA data, RTT data, TA data, sensor data, or identifier data, among other examples). Some examples of AI models may be trained to infer or predict measurements or values (e.g., timing measurement(s), angle measurement(s), AOA measurement(s), AOD measurement(s), TDOA measurement(s), RTT measurement(s), LOS angle(s), or other values) based on input data.

Some examples of the techniques described herein may be performed in conjunction with one or more of the AI models described with reference to FIG. 20. For instance, an AI model may be trained or controlled based on an identifier as described with reference to FIG. 4. Further, in accordance with some of the techniques of present disclosure, a wireless device may obtain status information for identifiers that correspond to one or more network settings for AI/ML-based positioning or sensing procedures. Moreover, based on obtaining the status information in accordance with some of the techniques of the present disclosure, a wireless device may perform one or more operations to control or train (e.g., finetune) AI models for AI/ML-based positioning or sensing procedures.

FIG. 21A shows an example of a block diagram 2100-a that supports status information for identifiers related to AI/ML in accordance with one or more aspects of the present disclosure. In some examples of the techniques described herein, a positioning device (e.g., location server, LMF, SLP, UE, or other device) may utilize D-AI/ML positioning. In D-AI/ML positioning, one or more AI models 2110 (e.g., machine learning model(s) or D-AI/ML model(s)) may be trained to utilize input data 2105 to output (e.g., infer or predict) a location 2115 (e.g., a position estimate, coordinates, or an address of a UE). Examples of the input data 2105 may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CFR data, CIR data, PDP data, DP data, CQI data, CSI data, decoding failure rate, or retransmission request rate, among other examples), AOA data, AOD data, TDOA data, RTT data, TA data, RSTD data, difference of RSTDs (diff-RSTD) data, RTOA data, difference of RTOAs (diff-RTOA) data, sensor data (e.g., image data, RF data, motion data, orientation data, or audio data, among other examples), or identifier data (e.g., cell ID data or SSID data, among other examples), among other examples.

Some aspects of the techniques described herein may describe a wireless device obtaining status information for identifiers that correspond to one or more network settings for AI/ML-based positioning or sensing procedures to further control the AI/ML-based positioning or sensing procedures. In some examples, the status information may be used as input data 2105 to the AI model 2110 for predicting locations 2115 via AI/ML-based positioning procedures. Moreover, based on obtaining the status information and in accordance with some of the techniques of the present disclosure, a wireless device may perform one or more operations to control or train (e.g., finetune) the AI model 2110 for AI/ML-based positioning procedures.

FIG. 21B shows an example of a block diagram 2100-b that supports status information for identifiers related to AI/ML in accordance with one or more aspects of the present disclosure. In some examples of the techniques described herein, a positioning device (e.g., location server, LMF, SLP, UE, or other device) may utilize A-AI/ML (or indirect) positioning. In A-AI/ML, one or more AI models 2130 (e.g., machine learning model(s) or “A-AI/ML” model(s)) may be trained to utilize input data 2125 to output (e.g., infer or predict) one or more predicted measurements 2135. For instance, an AI/ML model may output a new measurement or an enhancement of a measurement (e.g., LOS/NLOS identification, timing of measurement, angle of measurement, or likelihood of measurement). The AI model(s) 2130 may be located at a wireless device or network entity (e.g., UE or network node). Examples of the input data 2125 may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CFR data, CIR data, PDP data, DP data, CQI data, CSI data, decoding failure rate, or retransmission request rate, among other examples), AOA data, AOD data, TDOA data, RTT data, TA data, RSTD data, diff-RSTD data, RTOA data, diff-RTOA data, sensor data (e.g., image data, RF data, motion data, orientation data, or audio data, among other examples), or identifier data (e.g., cell ID data or SSID data, among other examples), among other examples. Examples of the predicted measurements 2135 may include one or more intermediate positioning measurements, timing measurements, Rx-Tx time difference measurements (e.g., from the perspective of a wireless device or network node), RSTD measurements, RTOA measurements, angle measurements, AOA measurements, AOD measurements, TDOA measurements, RTT measurements, an LOS indicator, LOS angles, or other values.

In A-AI/ML, the input data 2125 or AI model(s) 2130 may be structured in accordance with one or more approaches. Different model input structures may have different implications regarding model output accuracy, generalization, robustness, or model complexity.

In some approaches, a same AI model 2130 may be utilized (e.g., separately utilized) for input data 2125 from multiple (e.g., P) TRPs, where a separate input may be utilized for input data 2125 from each respective TRP. For instance, a first CIR corresponding to a first TRP may be utilized as an input for the AI model 2130 to generate a first TOA corresponding to the first TRP, a second CIR corresponding to a second TRP may be utilized as an input for the AI model 2130 to generate a second TOA corresponding to the second TRP, and an Kth CIR corresponding to an Kth TRP may be utilized as an input for the AI model 2130 to generate an Kth TOA corresponding to the Kth TRP. The first TOA, the second TOA, and the Kth TOA may be examples of the predicted measurements 2135.

In some approaches, different AI models 2130 (e.g., K AI models) may be utilized for input data 2125 from multiple (e.g., K) TRPs, where a separate input may be utilized for input data 2125 from each respective TRP. For instance, a first CIR corresponding to a first TRP may be utilized as an input for a first AI model to generate a first TOA corresponding to the first TRP, a second CIR corresponding to a second TRP may be utilized as an input for a second AI model to generate a second TOA corresponding to the second TRP, and an Kth CIR corresponding to an Kth TRP may be utilized as an input for an Kth AI model to generate an Kth TOA corresponding to the Kth TRP. The first AI model, the second AI model, and the Kth AI model may be examples of the AI models 2130. The first TOA, the second TOA, and the Kth TOA may be examples of the predicted measurements 2135.

In some approaches, one AI model 2130 may be utilized (e.g., jointly or concurrently utilized) for input data 2125 from multiple (e.g., P) TRPs, where a separate input may be utilized for input data 2125 from each respective TRP. For instance, a first CIR corresponding to a first TRP, a second CIR corresponding to a second TRP, and an Kth CIR corresponding to an Kth TRP may be utilized as inputs for the AI model 2130 to generate a first TOA corresponding to the first TRP, a second TOA corresponding to the second TRP, and an Kth TOA corresponding to the Kth TRP. The first TOA, the second TOA, and the Kth TOA may be examples of the predicted measurements 2135.

The predicted measurement(s) 2135 may be provided to, or utilized by, a positioning device (e.g., location server, LMF, SLP, UE, or other device) to output a location 2145 (e.g., a position estimate, coordinates, or an address of a UE). For example, the positioning device may include a positioning component 2140. The positioning component may be, or may utilize, one or more other AI models (e.g., positioning model(s)) or non-AI models (trilateration with Chan's algorithm or a Kalman filter, among other examples) to determine the location 2145 (e.g., UE coordinates). In some examples, the AI model(s) 2130 and the positioning component 2140 may be implemented at the same device (e.g., location server, LMF, SLP, UE, or other device) or at different devices. For network-assisted positioning, for instance, a UE may apply the AI model(s) 2130 to generate the predicted measurement(s) 2135, which may be reported to a network entity (e.g., location server or LMF, among other examples). The network entity may apply the positioning component 2140 to generate the location 2145. For UE-based positioning, a device (e.g., a network node, location server, LMF, or another UE with a sidelink connection to the UE) may apply the AI model(s) 2130 to generate the predicted measurement(s) 2135, which may be reported to the UE, which may apply the positioning component 2140 to generate the location 2145.

In some examples of non-AI/ML-based positioning, a path finding procedure (e.g., LOS quadrature interpolation (LOSQuad), multiple signal classification (MUSIC), or matrix pencil (MP), among other examples), may utilize input data (e.g., reference signal data (e.g., PRS or SRS measurements) or channel data (e.g., CFR data, CIR data, PDP data, or DP data) to produce intermediate positioning measurements. Examples of the intermediate positioning measurements may include Rx-Tx time difference measurements (e.g., from the perspective of a wireless device or network node), RSTD measurements, RTOA measurements, an LOS indicator, or other values. The intermediate positioning measurements may be provided to a positioning engine, which may perform one or more procedures (e.g., trilateration with Chan's algorithm or a Kalman filter, among other examples) to determine a location (e.g., UE coordinates). Some non-AI/ML-based positioning procedures (e.g., RAT-dependent positioning procedures) may fail in NLOS conditions. One or more AI/ML-based positioning procedures may enhance positioning accuracy in NLOS conditions because the AI/ML model(s) may learn a channel multipath profile and the profile's mapping to location information.

Some aspects of the techniques described herein may describe a wireless device obtaining status information for identifiers that correspond to one or more network settings for AI/ML-based positioning or sensing procedures to further control the AI/ML-based positioning or sensing procedures. For example, the status information may be used as input data 2125 to the AI model 2130 for generating the predicted measurements 2135. Moreover, the status information may also aid the positioning component 2140 in predicting the locations 2145 via AI/ML-based positioning procedures. Moreover, based on obtaining the status information and in accordance with some of the techniques of the present disclosure, a wireless device may perform one or more operations to control or train (e.g., finetune) the AI model 2130 and the positioning component 2140 for AI/ML-based positioning procedures.

FIG. 22 shows examples of block diagrams 2200 that supports status information for identifiers related to AI/ML in accordance with one or more aspects of the present disclosure. A first use case 2205 (e.g., “Case 1”) may be an example of UE-based positioning, where the UE includes an AI model. In the first use case 2205, the AI model may be utilized for D-AI/ML positioning or A-AI/ML (e.g., UE-based positioning with UE-side A-AI/ML or D-AI/ML). For example, a network node may transmit a reference signal (e.g., PRS) to the UE. In a D-AI/ML positioning approach, the UE may execute the AI model based on measurements of the reference signal to determine a location. An indication of the location (e.g., UE coordinates) may be transmitted to the location server (e.g., LMF). In an A-AI/ML approach, the UE may execute the AI model based on measurements of the reference signal to determine one or more predicted (e.g., inferred) measurements (e.g., based on the PRS). The UE may utilize the predicted measurement(s) to determine the location using another AI model or a non-AI model. An indication of the location may be transmitted to the location server.

A second use case 2210 (e.g., “Case 2a”) may be an example of UE-assisted or location server-based positioning, where the UE includes an AI model. In the second use case 2210, the AI model may be utilized for AI/ML assisted positioning (e.g., UE-assisted positioning with UE-side A-AI/ML). For example, a network node may transmit a reference signal (e.g., PRS) to the UE. In the A-AI/ML approach, the UE may execute the AI model based on measurements of the reference signal to determine one or more predicted measurements (e.g., based on the PRS). For instance, the predicted measurement(s) may include PRS-based measurement(s) (e.g., an RSTD, LOS indicator, or UE Rx-Tx time difference, among other examples) as model output(s). An indication of the predicted measurement(s) may be transmitted to the location server (e.g., LMF). The location server may utilize the predicted measurement(s) to determine the location using an AI model or non-AI model.

A third use case 2215 (e.g., “Case 2b”) may be an example of UE-assisted or location server-based positioning, where the location server (e.g., LMF) includes an AI model (e.g., UE-assisted positioning with location server-side D-AI/ML). In the third use case 2215, the AI model may be utilized for D-AI/ML positioning. For example, a network node may transmit a reference signal (e.g., PRS) to the UE. The UE may measure the reference signal and transmit an indication of the measurement(s) to the location server. In a D-AI/ML positioning approach, the location server may execute the AI model based on the measurement(s) of the reference signal to determine a location. For instance, the measurement(s) may include one or more PRS-based measurements as model input (e.g., CIR, PDP, DP, RSTD, diff-RSTD, RSRP, or RSRPP, among other examples).

A fourth use case 2220 (e.g., “Case 3a”) may be an example of network node-assisted positioning, where the network node includes an AI model. In the fourth use case 2220, the AI model may be utilized for A-AI/ML (e.g., network node-assisted positioning with network node-side A-AI/ML). For example, a UE may transmit a reference signal (e.g., SRS) to the network node. The network node may measure the reference signal. In the A-AI/ML approach, the network node may execute the AI model based on a measurement(s) of the reference signal to determine one or more predicted measurements (e.g., based on the SRS). For instance, the predicted measurement(s) may include an SRS-based measurement as model output (e.g., an RTOA, LOS indicator, network node Rx-Tx time difference, among other examples). An indication of the predicted measurement(s) may be transmitted to the location server (e.g., LMF). The location server may utilize the predicted measurement(s) to determine the location using an AI model or a non-AI model.

A fifth use case 2225 (e.g., “Case 3b”) may be an example of network node-assisted positioning, where the location server (e.g., LMF) includes an AI model. In the fifth use case 2225, the AI model may be utilized for D-AI/ML positioning (e.g., network node-assisted positioning with location server-side D-AI/ML). For example, a UE may transmit a reference signal (e.g., SRS) to the network node. The network node may measure the reference signal (e.g., based on the SRS) and transmit an indication of the measurement(s) to the location server. For instance, the measurement(s) may include an SRS-based measurement as model input (e.g., CIR, PDP, DP, RTOA, RSTD, diff-RTOA, RSRP, or RSRPP, among other examples). In a D-AI/ML positioning approach, the location server may execute the AI model based on the measurement(s) of the reference signal to determine a location.

Some examples of the techniques described herein may utilize one or more AI/ML models. For instance, some of the techniques may be utilized for a wireless devices to obtain status information for identifiers associated with one or more network settings. Further, the wireless device may then perform operations to control AI/ML-based positioning or sensing procedures to improve model training, inference or predictions, performance monitoring, or data collection of UE-sided model training data for UE-sided or network-sided AI models.

Some examples of the techniques described herein may provide positioning accuracy enhancements for D-AI/ML positioning or A-AI/ML positioning. D-AI/ML use cases may include Case 1 (e.g., UE-based positioning with a UE-side AI model and D-AI/ML positioning), Case 2b (e.g., UE-assisted or location server-based positioning with an location server-side AI model and D-AI/ML positioning), Case 3b: NG-RAN node assisted positioning with an location server-side AI model and D-AI/ML positioning). A-AI/ML use cases may include Case 2a (e.g., UE-assisted or location server-based positioning with a UE-side AI model and A-AI/ML positioning) or Case 3a (e.g., NG-RAN node assisted positioning with a gNB-side AI model and A-AI/ML positioning.

Some examples of the techniques described herein may include measurement aspects, signaling, or one or more other mechanisms to facilitate one or more operations (e.g., LCM operations) related to positioning accuracy enhancements. Some aspects may include measurement signaling or approaches to help ensure correspondence or alignment between training and predicting or inferencing related to network-side conditions for performing prediction at a UE for positioning use cases. Some aspects may be utilized for model switching, model selection, model activation or deactivation, or any combination thereof.

One or more of the techniques described herein may be utilized for a wireless device to perform an operation to control the AI/ML-based positioning or sensing based on the status information of one or more identifiers associated with one or more network settings. The operation may be for model selection, model switching, model activation or deactivations, or any combination thereof for AI/ML models.

In some examples, a network entity (e.g., core network device, OAM device, or OTT device) may collect UE-sided model training data. In some approaches, an AI model may be communicated (e.g., transferred or delivered) between devices. In some aspects, one-sided models or two-sided models may be utilized. For example, a wireless device and network entity may interoperate. Performance monitoring or testing (e.g., static or non-static scenarios, propagation conditions for clustered delay line (CDL) or field data, among other examples) may be utilized in some approaches.

In some examples, offline or online AI model training may be utilized. Post-deployment validation may be performed to manage AI model changes or drift over time.

Some examples of the techniques described herein may be performed in conjunction with one or more of the use cases (e.g., the first use case 2205, the second use case 2210, the third use case 2215, the fourth use case 2220, or the fifth use case 2225) described with reference to FIG. 22. It should be noted that while examples of some use cases are illustrated in FIG. 22, other use cases in which a device (e.g., wireless device, network entity, UE, network node, location server, or LMF, among other examples) may receive a reference signal, measure a reference signal, report measurements, predict measurements, predict a location, or report a location may be implemented.

For AI/ML assisted positioning with UE-assisted positioning (Case 2a) or NG-RAN node-assisted positioning (Case 3a), a measurement report may include or indicate a model output to the location server. A measurement report may include information indicating TOA, path phase, RSTD, an LOS or NLOS indicator, or RSRPP. In some approaches, a measurement report may include probabilistic (e.g., soft) information or an increased resolution of RSTD. One or more AI model inference or predicted outputs may improve performance, such as timing estimation (where a report to the location server may be derived based on the AI model inference or predicted output or may be different from the model inference or predicted output, for instance), or an LOS or NLOS indicator. Assistance signaling (e.g., reference signal configuration information) may be utilized to facilitate model inferencing or predicting for a UE-side or network-side model(s).

For direct AI/ML positioning (e.g., Case 2b or Case 3b), one or more types of measurements may be utilized as model inference input, which may impact performance or associated signaling overhead. Some examples of measurements may include CIR, PDP, RSRP, RSRPP, or RSTD, among others. For A-AI/ML assisted positioning with UE-assisted (Case 2a) and NG-RAN node assisted positioning (Case 3a), one or more measurements may be signaled in a measurement report. For instance, a measurement report may be utilized to carry model output to an LMF. A measurement report may include data indicating a TOA, path phase, RSTD, LOS indicator or NLOS indicator, or RSRPP, among other examples. Some measurement reports may include soft information or relatively high resolution information of an RSTD. One or more types of model inference output may be utilized to provide performance improvements. Examples of model inference outputs may include a timing estimate (e.g., a report to an LMF may be derived based on, or may be different from, the model inference output), an LOS or NLOS indicator. In some approaches, assistance signaling (e.g., reference signal configurations) may be utilized with a procedure to facilitate model inference for a UE-side model or a network-side model.

For AI/ML assisted positioning (e.g., Case 3a), an LOS indicator, NLOS indicator, or timing information may be supported for reporting. If an LOS indicator or NLOS indicator is reported, the indicator can be reported as a soft indicator or a hard indicator. If timing information is reported, the timing information may be reported via UL RTOA or gNB Rx-Tx time difference. For AI/ML assisted positioning (e.g., Case 2a), an LOS indicator, NLOS indicator, or timing information may be supported for reporting. If the LOS indicator or NLOS indicator is reported, the indicator may be reported as a soft indicator or a hard indicator. If timing information is reported, the timing information may be reported via downlink RSTD or UE Rx-Tx time difference.

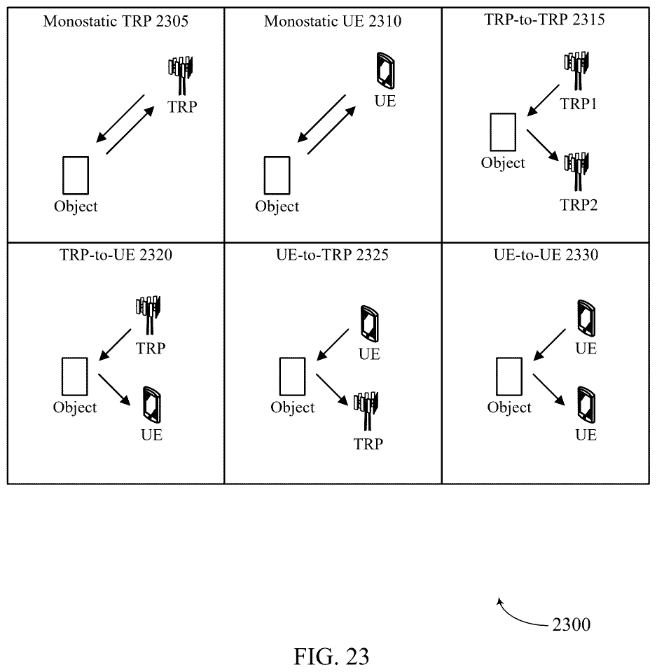

FIG. 23 shows examples of sensing models 2300 that supports status information for identifiers related to AI/ML in accordance with one or more aspects of the present disclosure. Various sensing modes are illustrated in the context of one or more devices (e.g., TRPs and UEs). While TRPs are illustrated in FIG. 23, a TRP may instead be a base station (e.g., gNB) in some examples. The objects illustrated in FIG. 23 may be devices (e.g., UEs, automated guided vehicles (AGVs), or vehicles, among other examples) or passive objects (e.g., roads, signs, barriers, or rocks, among other examples).

One or more sensing operations may be performed in accordance with one or more of the techniques described herein. Sensing operations may include monostatic sensing (e.g., radar-like sensing, where a sensing transmitter and a sensing receiver may be co-located in the same entity) or bistatic sensing (e.g., where a sensing receiver and sensing transmitter are located in different entities). Multi-static sensing may be performed in some examples, where multiple sensing transmitters or receivers may be utilized.

In some approaches, one or more reflections of a sensing signal sent from a sensing transmitter may be received by a sensing receiver and processed to determine one or more characteristics of the sensed object or an environment (e.g., location). In sensing operations, one or more sensing signal reflections may be received. The sensing signal reflections may be processed locally (e.g., in a device that received the sensing signal reflections) or may be communicated to another device for processing. For instance, a device may execute one or more AI/ML models to determine a position of the object based on the sensing signal reflections.

An example of monostatic TRP sensing 2305 is given in FIG. 23. For example, a TRP (e.g., gNB) may transmit a signal and receive a signal reflection from the object.

An example of monostatic UE sensing 2310 is given in FIG. 23. For example, a UE may transmit a signal and receive a signal reflection from the object.

An example of bistatic TRP-to-TRP sensing 2315 is given in FIG. 23. For example, a first TRP (e.g., a first gNB) may transmit a signal, and a second TRP may receive a signal reflection from the object.

An example of bistatic TRP-to-UE sensing 2320 is given in FIG. 23. For example, a TRP (e.g., a gNB) may transmit a signal, and a UE may receive a signal reflection from the object.

An example of bistatic UE-to-TRP sensing 2325 is given in FIG. 23. For example, a UE may transmit a signal, and a TRP may receive a signal reflection from the object.

An example of bistatic UE-to-UE sensing 2330 is given in FIG. 23. For example, a first UE may transmit a signal, and a second UE may receive a signal reflection from the object.

In some aspects, one or more of the AI/ML-based positioning or sensing procedures or communications (e.g., capability information, request information, indications, or meaning information, among other examples) described herein may be utilized for one or more sensing use cases. For instance, sensing may be performed to determine a position or motion of an object (e.g., a wireless device or other object). Examples of sensing use cases may include one or more of transportation, unmanned aerial vehicles (UAVs), smart cities, smart homes, smart factories, or health monitoring. For instance, a transportation use case may include intrusion detection on a highway, sensing assisted automotive maneuvering or navigation, smart parking, or other assistance, among other examples. A UAV use case may include UAV flight trajectory tracing or sensing for UAV intrusion detection, among other examples. A smart city use case may include rainfall monitoring, tourist spot traffic management, flooding awareness, weather forecasting, or public safety search and rescue, among other examples. A smart home use case may include intruder detection in a smart home, gesture recognition, or extended reality (XR) streaming, among other examples. A smart factory use case may include AGV detection and tracking in factories or inventory tracking, among other examples. A health monitoring use case may include monitoring vital signs and health related measures, sleep monitoring, or health monitoring, among other examples. Examples of sensing modes that may be employed in some examples of the techniques may be implemented in the wireless communications system described with reference to FIGS. 4 through 6.

In some examples, one or more of the AI/ML models described herein may correspond to one or more sensing key performance indicators (KPIs) (with equivalent A-AI/ML sensing or D-AI/ML sensing). Some examples of sensing KPIs may include an accuracy of positioning (e.g., horizontal or vertical), an accuracy of range or cross-range of target, an accuracy of AOA of a target (e.g., azimuth or elevation), an accuracy of velocity (e.g., horizontal or vertical), a sensing range or cross-range resolutions, a sensing velocity resolution, a sensing angle resolution, a sensing latency, a sensing refreshing rate, a receiver operating characteristics (ROC) (e.g., misdetection or false alarm probabilities), a confidence interval or level of sensing, or target discrimination.

Some examples of the techniques described herein may utilize one or more terms relating to sensing. Sensing data may include data derived from one or more radio signals impacted (e.g., reflected, refracted, diffracted) by an object or environment of interest for sensing purposes, and optionally processed. 5G Wireless sensing (5GS) may be a feature providing one or more capabilities to obtain information about characteristics of the environment or objects within the environment (e.g., shape, size, orientation, speed, location, distances or relative motion between objects, among other examples) using radio frequency signals. Non-3GPP sensing data may be data provided by non-3GPP sensors (e.g., video, LIDAR, sonar) about an object or environment of interest for sensing purposes. Sensing assistance information may be information that is provided to a wireless system from a third-party and may be used to support the derivation of a sensing result. Examples of sensing assistance information may include map information, area information, a UE ID attached to or in the proximity of the sensing target, UE position information, or UE velocity information, among other examples.

Sensing contextual information may be information that is exposed with the sensing results by a wireless system to a third-party which provides context to the conditions under which the sensing results were derived. Examples may include map information, area information, time of capture, UE location, or an identifier. This contextual information may be required in scenarios where the sensing result is to be combined with data from other sources outside the 5GS. A sensing group may be a set of sensing transmitters and sensing receivers whose location is known and whose sensing data can be collected synchronously. A sensing receiver may be an entity that receives a sensing signal which a sensing service may use in operation. A sensing receiver may be part of a RAN node or a UE. A sensing receiver may be located in the same or different entity as the sensing transmitter. A sensing result may be processed sensing data requested by a service consumer. Sensing signals may be transmissions on a radio interface that can be used for sensing purposes. Some approaches may refer to NR radio frequency signals which, in some cases.

A sensing transmitter may be an entity that sends out a sensing signal which the sensing service will use in its operation. A sensing transmitter may be part of a RAN node or a UE. A sensing transmitter may be located in the same or different entity as the sensing receiver. A target sensing service area may be a cartesian location area to be sensed by deriving characteristics of the environment or objects within the environment with a sensing service quality from the impacted (e.g., reflected, refracted, diffracted) radio signals. This may include indoor or outdoor environments.

RF sensing may extend positioning capabilities to one or more applications. Factors affecting sensing performance may include RCS, mobility, or clutter/scattering patterns. One or more channel modeling aspects may be utilized to support object detection or tracking. A modeling framework may be capable of detecting or tracking one or more objects and to enable them to be distinguished from unintended objects. Some examples of objects may include UAVs, humans (indoors or outdoors), automotive vehicles (at least outdoors), automated guided vehicles (e.g., in indoor factories), or objects creating hazards on roads/railways (e.g., with a minimum size dependent on frequency). In some examples, one or more frequencies from 0.5 to 52.6 GHz may be utilized, with scalability to 100 GHz.

For one or more use cases, sensing modes and frequencies, deployment scenarios may be identified corresponding to one or more use cases. Channel modeling may be utilized for sensing. One or more measurements may be utilized for modeling of sensing targets or a background environment, including, for example, radar cross-section (RCS), mobility, clutter/scattering patterns, or spatial reliability.

In some examples, a sensing data signal processing flow may be performed from Analog-to-Digital Converter (ADC) samples to progressively higher-level data representations. From low levels to high levels, the data types may include raw data, a range-angle-Doppler (RAD) tensor, a point cloud, or grid map. Learning-based frameworks may be utilized, which may support the encoding and decoding of different representation types, and additional quantization can be adopted to reduced data size. For integrated sensing and communication, for instance, one or more types of data representations may be utilized, which may include data quantization, range fast Fourier transform (FFT), Doppler FFT, angle FFT, RAD tensor, point cloud, voxel grids, neural network (NN)-based representations, or parametric objects. In some examples, an ADC signal may be utilized to obtain one or more of the types of representations. In some aspects, a deep learning framework or quantization may be applied for one or more (e.g., all) types of representations. One or more types of representations may be provided to an SnMF for one or more sensing operations.

One or more of the data representations are described as follows. Data quantization: at a relatively low (e.g., lowest) level, sampling and quantization of the sensing signal may be initial operations. To reduce the volume of data that needs to be processed, various techniques may be utilized. Some approaches, such as compressed sensing, may exploit the sparsity of the signal to acquire the signal at a lower sampling rate. Other approaches may use relatively low-bit quantization to reduce complexity and power consumption at the TRP. In particular, the power consumption of ADCs in hybrid architectures may grow exponentially to the quantity of quantization levels, thus elevating the significance of ADC quantization. In some cases, sampling may be performed with one bit per sample, significantly reducing the data volume to be transmitted by the TRP. Data quantization may be combined with other representations, such as RAD tensors or point clouds, among other examples. Data quantization may be used as the format of data to be exchanged in a case of signal-level fusion where the sensing data is sent directly to a fusion center without performing any further local processing.

RAD tensors: range-angle and range-Doppler maps may be data representations in radar signal processing. The maps may provide a structured way to visualize or analyze spatial or velocity information of detected targets. In the context of integrated sensing and communication, the maps may be useful for tasks like target detection, localization, and tracking.

Point clouds: point clouds may be versatile data representations that may be utilized in various sensing applications, including radar, LIDAR, or computer vision. In the context of integrated sensing and communication, point clouds may provide a spatial representation of multiple targets by capturing discrete points in a three-dimensional space. Each point in the cloud may contain information about the target's range, velocity, azimuth angle, or elevation angle.

Voxel grids: voxel grids may be another form of data representation where the 3D space is divided into a grid of volumetric pixels (voxels). Each voxel can store information such as occupancy, intensity, or other attributes. Voxel grids may be useful for representing an environment in autonomous driving and robotics applications. Voxel grids may provide a structured representation that may be processed by algorithms but can be memory intensive.

Deep Learning-Based Representations: advancements in deep learning may lead to the development of various data representations. For instance, radar data may be transformed into images or tensors that are fed into convolutional neural networks (CNNs) for tasks such as object detection or classification. The representations may leverage deep learning to extract high-level features from raw data, which may improve the accuracy or robustness of sensing systems. Variational auto-encoders (VAE) may be utilized, which may project input data into a distribution over the latent space. In particular, the following forms of deep learning representations may be utilized: embeddings, feature vectors (e.g., outputs of feature extraction layers), or layer weights.

Parametric object representations: by performing object segmentation over point clouds, scene information may be conveyed with relatively less data. This operation may involve: (i) employing clustering algorithms to separate the point cloud into groups that correspond to different environment objects; and (ii) unifying the points of each group to a compact representation, therefore unveiling the shape of each object. To describe shapes of 3D objects, multiple approaches may be taken, such as polygon representations (represented as the convex hulls of each point cloud group), wireframes (interconnected sets of edges), or general parametric shapes, where each shape is represented by the set of its geometric parameters (e.g., center and radius for 3D balls). While accurately representing real objects with geometrical shapes may present challenges, such representation may be utilized such that relatively few bytes of information may be transmitted to describe a scene.

Some examples of the techniques described herein may enable a wireless device to obtain status information that correspond to one or more identifiers, the one or more identifiers being associated with one or more network settings. As described herein, the one or more network settings may relate to communication of reference signaling for an AI/ML-based positioning or sensing procedure or measurement of reference signaling for an AI/ML-based positioning or sensing procedure. Moreover, the wireless device may perform an operation to control the AI/ML-based positioning or sensing procedure based on the status information of the one or more identifiers. Such operations may include model selection, model switching, model activation or deactivation, and the like to improved performance, accuracy, throughput, or latency of the sensing procedures, among other examples.

The following provides an overview of aspects of the present disclosure:

Aspect 1: A method for wireless communications by a wireless device, comprising: obtaining, from a network entity, status information corresponding to one or more identifiers that are associated with one or more network settings, wherein the one or more network settings relate to communication of reference signaling for an AI/ML-based positioning or sensing procedure or measurement of reference signaling for an AI/ML-based positioning or sensing procedure; and performing an operation to control the AI/ML-based positioning or sensing procedure based at least in part on the status information corresponding to the one or more identifiers.

Aspect 2: The method of aspect 1, further comprising: outputting, to the network entity, a request for the status information corresponding to the one or more identifiers that are associated with the one or more network settings, wherein the status information is obtained based at least in part on the request.

Aspect 3: The method of any of aspects 1 through 2, further comprising: outputting, to the network entity, a request to confirm the status information corresponding to the one or more identifiers that are associated with the one or more network settings, wherein the operation to control the AI/ML-based positioning or sensing procedure is based at least in part on the request.

Aspect 4: The method of any of aspects 1 through 3, wherein obtaining the status information comprises: obtaining, from the network entity, the status information based at least in part on a request from the wireless device, via a position protocol message, via a sensing protocol message, or a combination thereof.

Aspect 5: The method of any of aspects 1 through 4, further comprising: obtaining, from the network entity, an indication of a change to the status information corresponding to the one or more identifiers that are associated with the one or more network settings.

Aspect 6: The method of aspect 5, wherein the indication of the change to the status information comprises an indication of a change from an active status, a pause status, an inactive status, a canceled status, an aborted status, or any combination thereof, to a different status.

Aspect 7: The method of any of aspects 1 through 6, further comprising: obtaining, from the network entity, an indication of a change to at least one identifier of the one or more identifiers that are associated with the one or more network settings.

Aspect 8: The method of aspect 7, wherein the change to the at least one identifier comprises an update to the at least one identifier, a replacement to the at least one identifier, or a combination thereof.

Aspect 9: The method of any of aspects 1 through 8, wherein obtaining the status information comprises: obtaining, from the network entity, one or more timing characteristics corresponding to the one or more identifiers that are associated with the one or more network settings, wherein the status information comprises the one or more timing characteristics.

Aspect 10: The method of aspect 9, wherein the one or more timing characteristics of a respective identifier comprises an indication of a status timer, a status start time, a status stop time, a status start date, a status stop date, or any combination thereof.

Aspect 11: The method of any of aspects 1 through 10, wherein obtaining the status information comprises: obtaining, from the network entity, one or more status characteristics corresponding to the one or more identifiers that are associated with the one or more network settings, wherein the status information comprises the one or more status characteristics, and wherein the one or more status characteristics comprise a valid status, an invalid status, an active status, a pause status, an inactive status, an expired status, an aborted status, a canceled status, or any combination thereof.

Aspect 12: The method of any of aspects 1 through 11, further comprising: outputting, to the network entity and in response to an expiration of a timing validity timer of at least one identifier of the one or more identifiers, a request to confirm the status information of the at least one identifier.

Aspect 13: The method of any of aspects 1 through 12, further comprising: determining that the status information of a respective identifier of the one or more identifiers indicates that the respective identifier is valid based at least in part on a status characteristic of the respective identifier, a timing characteristic of the respective identifier, or an absence of an indication from the network entity associated with the status information of the respective identifier.

Aspect 14: The method of any of aspects 1 through 13, further comprising: outputting, to the network entity, a request for the network entity to change the status information of a respective identifier of the one or more identifiers corresponding to the one or more identifiers that are associated with the one or more network settings.

Aspect 15: The method of any of aspects 1 through 14, further comprising: outputting, to the network entity, a capability message indicating a capability of the wireless device to obtain the status information corresponding to the one or more identifiers that are associated with the one or more network settings, wherein the status information is obtained based at least in part on output of the capability message.

Aspect 16: The method of any of aspects 1 through 15, wherein the operation to control the AI/ML-based positioning or sensing procedure comprises an activation of an AI/ML model, a selection of an AI/ML model, switching an AI/ML model, a deactivation of an AI/ML model, switching to a non-AI/ML-based positioning or sensing procedure, or any combination thereof based at least in part on the status information corresponding to the one or more identifiers.

Aspect 17: The method of any of aspects 1 through 16, wherein the status information of a first identifier of the one or more identifiers is based at least in part on the status information of a second identifier of the one or more identifiers based at least in part on a relation between the first identifier and the second identifier.

Aspect 18: A method for wireless communications by a network entity, comprising: outputting, to a wireless device, status information corresponding to one or more identifiers that are associated with one or more network settings, wherein the one or more network settings relate to communication of reference signaling for an AI/ML-based positioning or sensing procedure or measurement of reference signaling for an AI/ML-based positioning or sensing procedure; and communicating with the wireless device based at least in part on the one or more network settings.

Aspect 19: The method of aspect 18, further comprising: obtaining, from the wireless device, a request for the status information corresponding to the one or more identifiers that are associated with the one or more network settings, wherein the status information is output based at least in part on the request.

Aspect 20: The method of any of aspects 18 through 19, further comprising: obtaining, from the wireless device, a request to confirm the status information corresponding to the one or more identifiers that are associated with the one or more network settings.

Aspect 21: The method of any of aspects 18 through 20, wherein outputting the status information comprises: outputting, to the wireless device, the status information based at least in part on a request from the wireless device, via a position protocol message, via a sensing protocol message, or a combination thereof.

Aspect 22: The method of any of aspects 18 through 21, further comprising: outputting, to the wireless device, an indication of a change to the status information corresponding to the one or more identifiers that are associated with the one or more network settings.

Aspect 23: The method of aspect 22, wherein the indication of the change to the status information comprises an indication of a change from an active status, a pause status, an inactive status, a canceled status, an aborted status, or any combination thereof, to a different status.

Aspect 24: The method of any of aspects 18 through 23, further comprising: outputting, to the wireless device, an indication of a change to at least one identifier of the one or more identifiers that are associated with the one or more network settings.

Aspect 25: The method of aspect 24, wherein the change to the at least one identifier comprises an update to the at least one identifier, a replacement to the at least one identifier, or a combination thereof.

Aspect 26: The method of any of aspects 18 through 25, wherein outputting the status information comprises: outputting, to the wireless device, one or more timing characteristics corresponding to the one or more identifiers that are associated with the one or more network settings, wherein the status information comprises the one or more timing characteristics.

Aspect 27: The method of aspect 26, wherein the one or more timing characteristics of a respective identifier comprises an indication of a status timer, a status start time, a status stop time, a status start date, a status stop date, or any combination thereof.

Aspect 28: The method of any of aspects 18 through 27, wherein outputting the status information comprises: outputting, to the wireless device, one or more status characteristics corresponding to the one or more identifiers that are associated with the one or more network settings, wherein the status information comprises the one or more status characteristics, and wherein the one or more status characteristics comprise a valid status, an invalid status, an active status, a pause status, an inactive status, an expired status, an aborted status, a canceled status, or any combination thereof.

Aspect 29: The method of any of aspects 18 through 28, further comprising: obtaining, from the wireless device and in response to an expiration of a timing validity timer of at least one identifier of the one or more identifiers, a request to confirm the status information of the at least one identifier.

Aspect 30: The method of any of aspects 18 through 29, further comprising: obtaining, from the wireless device, a request for the network entity to change the status information of a respective identifier of the one or more identifiers corresponding to the one or more identifiers that are associated with the one or more network settings.

Aspect 31: The method of any of aspects 18 through 30, further comprising: obtaining, from the wireless device, a capability message indicating a capability of the wireless device to obtain the status information corresponding to the one or more identifiers that are associated with the one or more network settings, wherein output of the status information is based at least in part on obtaining the capability message.

Aspect 32: The method of any of aspects 18 through 31, wherein the status information of a first identifier of the one or more identifiers is based at least in part on the status information of a second identifier of the one or more identifiers based at least in part on a relation between the first identifier and the second identifier.

Aspect 33: A wireless device for wireless communications, comprising one or more memories storing processor-executable code, and one or more processors coupled with the one or more memories and individually or collectively operable to execute the code to cause the wireless device to perform a method of any of aspects 1 through 17.

Aspect 34: A wireless device for wireless communications, comprising at least one means for performing a method of any of aspects 1 through 17.

Aspect 35: A non-transitory computer-readable medium storing code for wireless communications, the code comprising instructions executable by one or more processors to perform a method of any of aspects 1 through 17.

Aspect 36: A network entity for wireless communications, comprising one or more memories storing processor-executable code, and one or more processors coupled with the one or more memories and individually or collectively operable to execute the code to cause the network entity to perform a method of any of aspects 18 through 32.

Aspect 37: A network entity for wireless communications, comprising at least one means for performing a method of any of aspects 18 through 32.

Aspect 38: A non-transitory computer-readable medium storing code for wireless communications, the code comprising instructions executable by one or more processors to perform a method of any of aspects 18 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
obtain, from a network entity, status information corresponding to one or more identifiers that are associated with one or more network settings, wherein the one or more network settings relate to communication of reference signaling for an artificial intelligence or machine learning (AI/ML)-based positioning or sensing procedure or measurement of reference signaling for an AI/ML-based positioning or sensing procedure; and
perform an operation to control the AI/ML-based positioning or sensing procedure based at least in part on the status information corresponding to the one or more identifiers.

2. The wireless device of claim 1, wherein the one or more processors are individually or collectively further operable to execute the code to cause the wireless device to:
output, to the network entity, a request for the status information corresponding to the one or more identifiers that are associated with the one or more network settings, wherein the status information is obtained based at least in part on the request.

3. The wireless device of claim 1, wherein the one or more processors are individually or collectively further operable to execute the code to cause the wireless device to:
output, to the network entity, a request to confirm the status information corresponding to the one or more identifiers that are associated with the one or more network settings, wherein the operation to control the AI/ML-based positioning or sensing procedure is based at least in part on the request.

4. The wireless device of claim 1, wherein, to obtain the status information, the one or more processors are individually or collectively operable to execute the code to cause the wireless device to:
obtain, from the network entity, the status information based at least in part on a request from the wireless device, via a position protocol message, via a sensing protocol message, or a combination thereof.

5. The wireless device of claim 1, wherein the one or more processors are individually or collectively further operable to execute the code to cause the wireless device to:
obtain, from the network entity, an indication of a change to the status information corresponding to the one or more identifiers that are associated with the one or more network settings.

6. The wireless device of claim 5, wherein the indication of the change to the status information comprises an indication of a change from an active status, a pause status, an inactive status, a canceled status, an aborted status, or any combination thereof, to a different status.

7. The wireless device of claim 1, wherein the one or more processors are individually or collectively further operable to execute the code to cause the wireless device to:
obtain, from the network entity, an indication of a change to at least one identifier of the one or more identifiers that are associated with the one or more network settings.

8. The wireless device of claim 7, wherein the change to the at least one identifier comprises an update to the at least one identifier, a replacement to the at least one identifier, or a combination thereof.

9. The wireless device of claim 1, wherein, to obtain the status information, the one or more processors are individually or collectively operable to execute the code to cause the wireless device to:
obtain, from the network entity, one or more timing characteristics corresponding to the one or more identifiers that are associated with the one or more network settings, wherein the status information comprises the one or more timing characteristics.

10. The wireless device of claim 9, wherein the one or more timing characteristics of a respective identifier comprises an indication of a status timer, a status start time, a status stop time, a status start date, a status stop date, or any combination thereof.

11. The wireless device of claim 1, wherein, to obtain the status information, the one or more processors are individually or collectively operable to execute the code to cause the wireless device to:
obtain, from the network entity, one or more status characteristics corresponding to the one or more identifiers that are associated with the one or more network settings, wherein the status information comprises the one or more status characteristics, and wherein the one or more status characteristics comprise a valid status, an invalid status, an active status, a pause status, an inactive status, an expired status, an aborted status, a canceled status, or any combination thereof.

12. The wireless device of claim 1, wherein the one or more processors are individually or collectively further operable to execute the code to cause the wireless device to:
output, to the network entity and in response to an expiration of a timing validity timer of at least one identifier of the one or more identifiers, a request to confirm the status information of the at least one identifier.

13. The wireless device of claim 1, wherein the one or more processors are individually or collectively further operable to execute the code to cause the wireless device to:
determine that the status information of a respective identifier of the one or more identifiers indicates that the respective identifier is valid based at least in part on a status characteristic of the respective identifier, a timing characteristic of the respective identifier, or an absence of an indication from the network entity associated with the status information of the respective identifier.

14. The wireless device of claim 1, wherein the one or more processors are individually or collectively further operable to execute the code to cause the wireless device to:
output, to the network entity, a request for the network entity to change the status information of a respective identifier of the one or more identifiers corresponding to the one or more identifiers that are associated with the one or more network settings.

15. The wireless device of claim 1, wherein the one or more processors are individually or collectively further operable to execute the code to cause the wireless device to:
output, to the network entity, a capability message indicating a capability of the wireless device to obtain the status information corresponding to the one or more identifiers that are associated with the one or more network settings, wherein the status information is obtained based at least in part on output of the capability message.

16. The wireless device of claim 1, wherein the operation to control the AI/ML-based positioning or sensing procedure comprises an activation of an AI/ML model, a selection of an AI/ML model, switching an AI/ML model, a deactivation of an AI/ML model, switching to a non-AI/ML-based positioning or sensing procedure, or any combination thereof based at least in part on the status information corresponding to the one or more identifiers.

17. The wireless device of claim 1, wherein the status information of a first identifier of the one or more identifiers is based at least in part on the status information of a second identifier of the one or more identifiers based at least in part on a relation between the first identifier and the second identifier.

18. A network entity, comprising:
one or more memories storing processor-executable code; and
one or more processors coupled with the one or more memories and individually or collectively operable to execute the code to cause the network entity to:
output, to a wireless device, status information corresponding to one or more identifiers that are associated with one or more network settings, wherein the one or more network settings relate to communication of reference signaling for an artificial intelligence or machine learning (AI/ML)-based positioning or sensing procedure or measurement of reference signaling for an AI/ML-based positioning or sensing procedure; and
communicate with the wireless device based at least in part on the one or more network settings.

19. The network entity of claim 18, wherein the one or more processors are individually or collectively further operable to execute the code to cause the network entity to:
obtain, from the wireless device, a request for the status information corresponding to the one or more identifiers that are associated with the one or more network settings, wherein the status information is output based at least in part on the request.

20. The network entity of claim 18, wherein the one or more processors are individually or collectively further operable to execute the code to cause the network entity to:
obtain, from the wireless device, a request to confirm the status information corresponding to the one or more identifiers that are associated with the one or more network settings.

21. The network entity of claim 18, wherein, to output the status information, the one or more processors are individually or collectively operable to execute the code to cause the network entity to:
output, to the wireless device, the status information based at least in part on a request from the wireless device, via a position protocol message, via a sensing protocol message, or a combination thereof.

22. The network entity of claim 18, wherein the one or more processors are individually or collectively further operable to execute the code to cause the network entity to:
output, to the wireless device, an indication of a change to the status information corresponding to the one or more identifiers that are associated with the one or more network settings.

23. The network entity of claim 18, wherein the one or more processors are individually or collectively further operable to execute the code to cause the network entity to:
output, to the wireless device, an indication of a change to at least one identifier of the one or more identifiers that are associated with the one or more network settings.

24. The network entity of claim 18, wherein, to output the status information, the one or more processors are individually or collectively operable to execute the code to cause the network entity to:
output, to the wireless device, one or more timing characteristics corresponding to the one or more identifiers that are associated with the one or more network settings, wherein the status information comprises the one or more timing characteristics.

25. The network entity of claim 18, wherein, to output the status information, the one or more processors are individually or collectively operable to execute the code to cause the network entity to:
output, to the wireless device, one or more status characteristics corresponding to the one or more identifiers that are associated with the one or more network settings, wherein the status information comprises the one or more status characteristics, and wherein the one or more status characteristics comprise a valid status, an invalid status, an active status, a pause status, an inactive status, an expired status, an aborted status, a canceled status, or any combination thereof.

26. The network entity of claim 18, wherein the one or more processors are individually or collectively further operable to execute the code to cause the network entity to:
obtain, from the wireless device and in response to an expiration of a timing validity timer of at least one identifier of the one or more identifiers, a request to confirm the status information of the at least one identifier.

27. The network entity of claim 18, wherein the one or more processors are individually or collectively further operable to execute the code to cause the network entity to:
obtain, from the wireless device, a request for the network entity to change the status information of a respective identifier of the one or more identifiers corresponding to the one or more identifiers that are associated with the one or more network settings.

28. The network entity of claim 18, wherein the one or more processors are individually or collectively further operable to execute the code to cause the network entity to:
obtain, from the wireless device, a capability message indicating a capability of the wireless device to obtain the status information corresponding to the one or more identifiers that are associated with the one or more network settings, wherein output of the status information is based at least in part on obtaining the capability message.

29. A method for wireless communications by a wireless device, comprising:
obtaining, from a network entity, status information corresponding to one or more identifiers that are associated with one or more network settings, wherein the one or more network settings relate to communication of reference signaling for an artificial intelligence or machine learning (AI/ML)-based positioning or sensing procedure or measurement of reference signaling for an AI/ML-based positioning or sensing procedure; and
performing an operation to control the AI/ML-based positioning or sensing procedure based at least in part on the status information corresponding to the one or more identifiers.

30. A method for wireless communications by a network entity, comprising:
outputting, to a wireless device, status information corresponding to one or more identifiers that are associated with one or more network settings, wherein the one or more network settings relate to communication of reference signaling for an artificial intelligence or machine learning (AI/ML)-based positioning or sensing procedure or measurement of reference signaling for an AI/ML-based positioning or sensing procedure; and
communicating with the wireless device based at least in part on the one or more network settings.
